(19) United States
(12) Patent Application Publication
(10) Pub. No.: US 2005/0065851 A1
(43) Pub. Date: Mar. 24, 2005

(54) System, method and computer program product for supplying to and collecting information from individuals

(76) Inventors: Jeffrey M. Aronoff, Los Gatos, CA (US); Frederick D. Forsman, Campbell, CA (US); Bradley J. Fuller, Palo Alto, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/942,933

(22) Filed: Sep. 17, 2004

Related U.S. Application Data
(60) Provisional application No. 60/504,554, filed on Sep. 22, 2003.

(51) Int. Cl. G06F 17/60

(52) U.S. Cl. 705/15

(57) ABSTRACT

Described herein are systems, methods, computer program products, and combinations and sub-combinations thereof, for enabling content and services to be displayed on mobile devices (as well as other types of data processing devices), and for users of mobile devices to interact with such content and services while collecting information to improve both the user's experience and the operation of a business.

### CROSS-REFERENCE TO RELATED APPLICATIONS

This application claims priority to U.S. provisional application Ser. No. 60/504,554 filed Sep. 22, 2003, which is incorporated herein by reference in its entirety.

### BACKGROUND OF THE INVENTION

1. Field of the Invention

The present invention relates generally to user communications, and more particularly relates to technology for using interactive applications and data collection while using on-site mobile devices (or, more generally, data processing devices).

2. Related Art

A variety of mobile devices (such as personal data assistants or PDAs and battery operated wireless touch screen devices or web tablets) exist. Such mobile devices include ones based on the Palm Operating environment, Windows CE operating environment and the Linux operating environment.

A variety of software applications for those mobile devices also exist.

What does not exist prior to the invention are software applications for enabling content and services (as well as other objects) to be displayed on mobile devices, and for users of mobile devices to interact with such content and services while collecting information to improve both the user's experience and the operation of a business.

An attempt at automating the restaurant from the customer's perspective is disclosed by U.S. patent application Ser. No. 10/037,681 to Toth, filed Oct. 24, 2001, published as U.S. patent application Publication No. US 2003/0078793 on Apr. 24, 2003 (hereinafter referred to as “Toth”).

One difference between the present invention and the invention described in Toth is that the present application deals with optimizing the business of the restaurant whereas Toth focused on the customer's communication and entertainment experience.

Toth focused on the customer viewing a (static) menu, placing their order without waiter assistance, providing communication and entertainment and paying their bill. In contrast to Toth, the present invention discloses an entire layer of new capabilities including but not limited to (in the restaurant example):
dynamic, real time menus to help reduce food waste and provide more optimized sales,
detailed real-time information on the operation of the restaurant, its customers, and employees,
a three tiered system that provides for a centralized clearinghouse for the exchange of data between the restaurant, third party providers, and multi-site restaurant chains. For example the present invention provides multi-restaurant chains the ability to automatically distribute, collect and compare information across multiple sites,
dynamic routing of customer requests to appropriate staff,
configurable wait-staff request buttons,
management opt-out of classes of content,
support of consolidation of various affinity programs,
authoring system provides multi-level templates for easy creation, customization and real-time modification of menu contents,
data collection and viewing of individual menu page views,
provides comparison of data collected to other similar businesses or best practices,
the system can be configured to signal employees for a variety of events,
the system can be used to provide training to employees,
the guest can modify their view of the menu, based on their own requirements, such as but not limited to dietary requirements (sorted by calories, etc.),
a more reliable and secure system provided by using learning mode, auto-shutdown feature, snooping and verifying checksum, diagnostics, HTTP push, hardware driver generating HTTP events and device control via MIME type handlers,
the present invention provides a new advertising venue and the advertisements can be delivered and measured by demographics,
provides special purpose devices that also allow the wait staff to perform any guest actions,
provides standard mobile devices to become special purpose devices,
provides for a smart charging/display station,
provides ability to publish any menu to a web-site,
provides a guest history and guest rating capability,
the present invention is as easy to use as a paper menu and requires no guest training or virtual server.

Toth does not teach or suggest at least these features of the present invention, each of which is described in detail herein.

### SUMMARY OF THE INVENTION

Briefly stated, the invention includes systems, methods, computer program products, and combinations and sub-combinations thereof, for enabling content and services to be displayed on mobile devices (as well as other types of data processing devices), and for users of mobile devices to interact with such content and services while collecting information to improve both the user's experience and the operation of a business.

These and additional features and advantages of the present invention will become more apparent from the detailed description set forth below when taken in conjunction with the drawings in which like reference characters generally identify corresponding elements throughout.

### BRIEF DESCRIPTION OF THE FIGURES

The accompanying drawings, which are incorporated herein and form part of the specification, illustrate embodiments of the present invention and, together with the description, further serve to explain the principles of embodiments of the invention.

FIG. 1A is a block diagram of the invention according to an embodiment of the invention.

FIGS. 1B-1D are alternate block diagrams of the invention according to embodiments of the invention.

FIG. 1E is a block diagram depicting usage of an implementation of the invention in a restaurant.

FIG. 2 is a block diagram of an example device useful for implementing items from FIGS. 1A-1D.

FIG. 2A is a block diagram used to illustrate how the system can periodically check on the status of the mobile devices according to an embodiment of the invention.

FIG. 2B is a block diagram used to illustrate how the on-site server can initiate hardware control of the mobile devices according to an embodiment of the invention.

FIG. 2C is a block diagram used to illustrate how the power-on self-test of the mobile devices can be performed according to an embodiment of the invention.

FIG. 2D is a block diagram used to illustrate how the on-site server can update software components of the mobile devices according to an embodiment of the invention.

FIG. 3 is a block diagram of an example on-site server useful for implementing items from FIGS. 1A and 1C.

FIG. 3A is a block diagram of an example content server useful for implementing items from FIG. 3.

FIG. 3B is a block diagram of an example authoring system useful for implementing items from FIG. 3.

FIG. 3C is a block diagram of an example configuration manager useful for implementing items from FIG. 3.

FIG. 3D is a block diagram of an example device manager useful for implementing items from FIG. 3.

FIG. 3E is a block diagram of an example report manager useful for implementing items from FIG. 3.

FIG. 3F is a block diagram of an example system manager useful for implementing items from FIG. 3.

FIG. 3G is a block diagram used to illustrate how the communication between the on-site server and information center can be logged according to an embodiment of the invention from FIG. 3.

FIG. 4 is a block diagram used to illustrate how the information center can be used according to an embodiment of the invention.

FIG. 4A is a block diagram of an example information center useful for implementing items from FIG. 4.

FIG. 4B is a block diagram of an example system status database useful for implementing items from FIG. 4A.

FIG. 4C is a block diagram of an example usage database useful for implementing items from FIG. 4A.

FIG. 4D is a block diagram of an example software database useful for implementing items from FIG. 4A.

FIG. 4E is a block diagram of an example menu database useful for implementing items from FIG. 4A.

FIG. 4F is a block diagram of an example content database useful for implementing items from FIG. 4A.

FIG. 4G is a block diagram of an example backup and restore useful for implementing items from FIG. 4A.

FIGS. 5A-5E collectively depict an example of how the invention operates from a customer's point of view in the context of a restaurant example.

FIG. 6 illustrates an example of how the invention operates from the wait-staff's point of view in the restaurant example of FIGS. 5A-5E.

FIG. 7 is an example flowchart illustrating how the invention is installed and configured.

FIG. 8 illustrates example management functionality provided by the invention in the restaurant example of FIGS. 5A-5E.

FIGS. 9A-9C is an example flowchart illustrating how the user interacts with the invention to call for service in the restaurant example below.

FIGS. 10A-10B is an example flowchart illustrating how the user interacts with the invention to place their order in the restaurant example below.

FIG. 11 is an example flowchart illustrating how the user interacts with the invention to check on their order status in the restaurant example below.

FIGS. 12A-12D is an example flowchart illustrating how the user interacts with the invention to pay their bill in the restaurant example below.

FIGS. 13A-13G is an example flowchart illustrating how the user interacts with the invention to purchase goods and services in the restaurant example below.

FIGS. 14A-14F is an example flowchart illustrating how the user interacts with the invention to check on their loyalty rewards program account in the restaurant example below.

FIGS. 15A-15D is an example flowchart illustrating how the user interacts with the invention to view content and services.

FIGS. 16A-16D is an example flowchart illustrating how the wait-staff interact with the invention.

FIGS. 17A-17C is an example flowchart illustrating how an embodiment of the invention can display time and/or location-based content on the mobile devices.

FIG. 18 is an example flowchart illustrating how support personnel use an embodiment of the invention to proactively intervene based on an event generated from one of the mobile devices.

FIGS. 19A-19D is an example flowchart illustrating how the information center of an embodiment of the invention can update software components on the on-site server and/or on the mobile devices.

FIGS. 20A-20B is an example flowchart illustrating how the operator interacts with the authoring system of an embodiment of the invention and can generate menus based on templates.

FIGS. 21A-21B is an example flowchart illustrating how the price and availability of menu items changes dynamically in an embodiment of the invention.

FIGS. 22A-22B is an example flowchart illustrating how the on-site server and the mobile device check for connections to their respective hosts in an embodiment of the invention.

FIGS. 23A-23B is an example flowchart which illustrates the manner in which mobile devices and the on-site server are associated with one another in an embodiment of the invention.

FIGS. 24A-24I are example screenshots from the user's mobile device which illustrate the manner in which the user is presented content and services, how they are informed of actions, shown the menu and previous meals and how they can customize the menu in an embodiment of the invention.

It should be understood that these figures depict embodiments of the present invention.

Variations of these embodiments will be apparent to persons skilled in the relevant art(s) based on the teachings contained herein. For example, the flow charts contained in these figures depict particular operational flows. However, the functions and steps contained in these flow charts can be performed in other sequences and/or combinations, and functions and steps can be added and/or deleted, as will be apparent to persons skilled in the relevant art(s) based on the teachings contained herein.

### DETAILED DESCRIPTION OF THE PREFERRED EMBODIMENTS

Table of Contents

| 1. | Overview of Embodiments of the Present | |
|---|---|---|
| | Invention | |
| | 1.1 | Restaurant Example |
| 2. | Example Structure of Embodiments of the Present | |
| | Invention | |
| | 2.1 | Information Center |
| | 2.2 | On-Site Server |
| | 2.3 | Mobile Device |
| 3. | Features and Capabilities of the Present Invention | |
| 4. | Operation of the Present Invention | |
| | 4.1 | Setup and Installation |
| | 4.2 | Operator Operations |
| | 4.3 | User Operations |
| | 4.4 | Wait-staff Operations |
| | 4.5 | System Implementation |

| | |
|---|---|
| 5. | Applications of the Present Invention |

1. Overview of Embodiments of the Present Invention

Embodiments of the present invention are briefly described in this section.

Briefly stated the invention comprises a system to display content and services on mobile devices (as well as other types of wired or wireless data processing devices). While the invention is often described herein as working with mobile devices, it should be understood that such reference is for illustrative purposes only, and not limiting. The invention includes technology for using applications on mobile devices that interact with content and services provided by an on-site server. Consequently, the invention embodies software and methods for administering that server that manages the variables relevant to a mobile device/server environment.

The content and services are delivered by an on-site server(s) (other implementations may use an off-site server(s) or require no server).

The invention also includes a centralized information center that provides consolidated data collection and an interface to general Internet content (other implementations may require no information center).

The invention also includes mobile devices to display content and services and to operate in conjunction with the web, Internet or intranet via a connection mechanism.

In this description each of the on-site server, information center and mobile devices are called a “layer”.

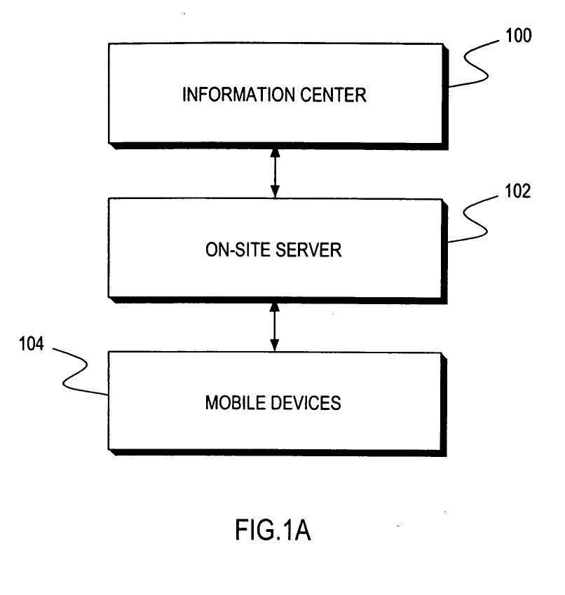

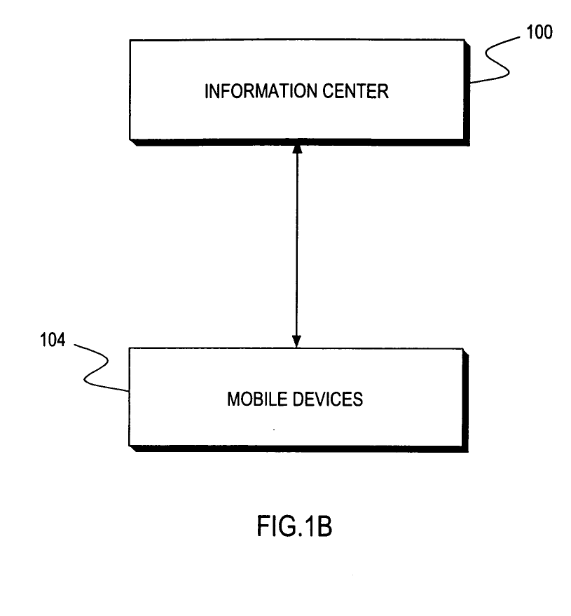

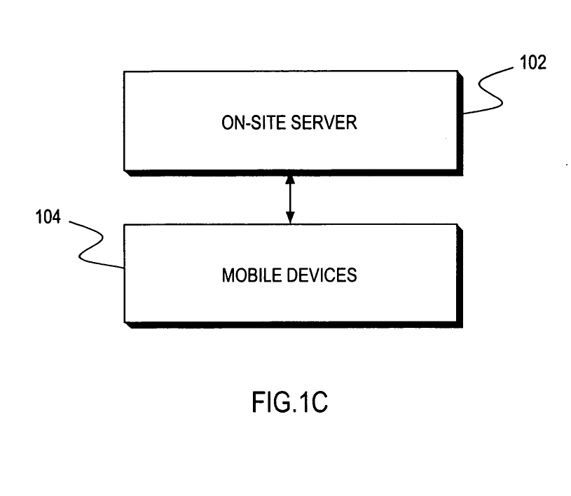

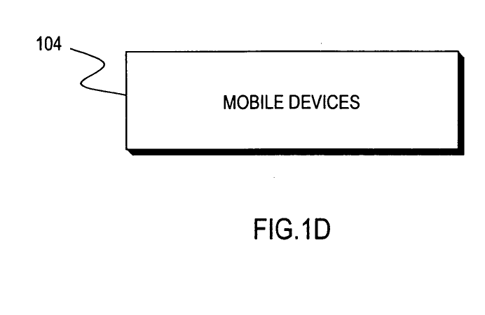

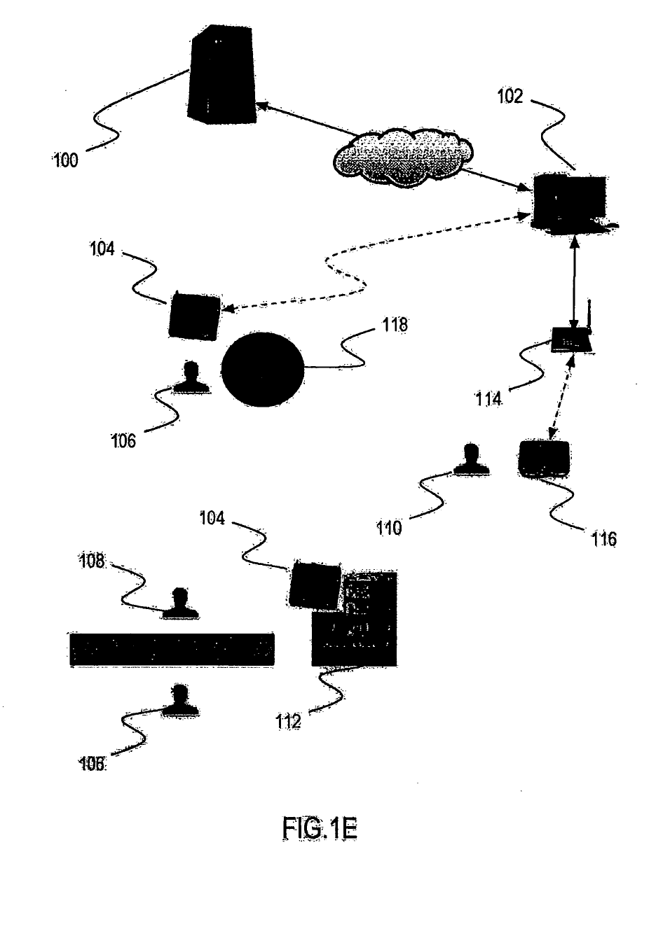

FIG. 1A depicts an example implementation using three layers of the present invention: an information center 100, an on-site server 102, and a plurality of mobile devices 104.

Mobile devices 104 include but are not limited to:
Web Pad-style computers
Personal computers
Portable personal computers
Handheld computers
Personal Data Assistants (PDAs)
Cellular phones
Internet-enabled phones
Pagers
TVs
DVD players
Audio devices
Video devices
Car Audio devices
Recorders
Text-to-Speech devices
Bar-code scanners
Net appliances
Mini-browsers

The invention includes an information center 100 (a remote server) that collects and consolidates system status, and usage information; it manages version control and delivery of software to the other layers, for example, the on-site server 102 and the devices 104; and it delivers content and menus. The information center 100 interfaces to a variety of internal and external sources from which content and information is exchanged.

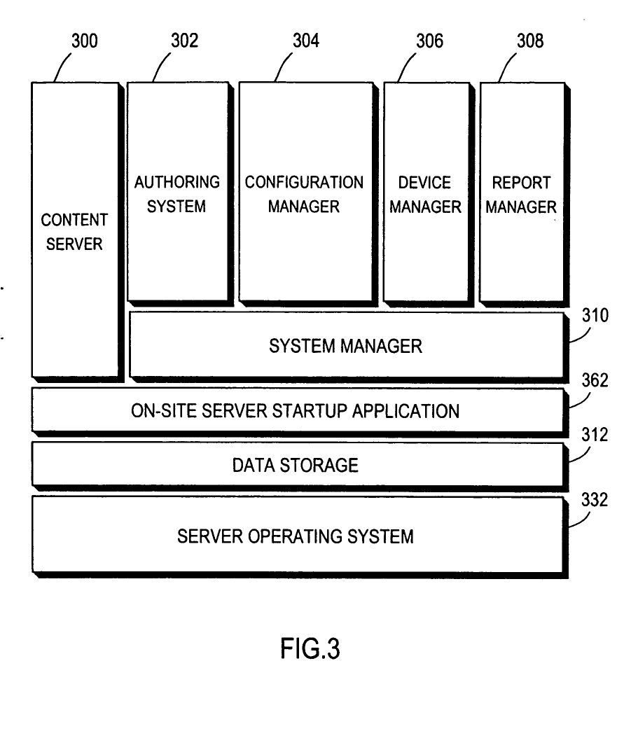

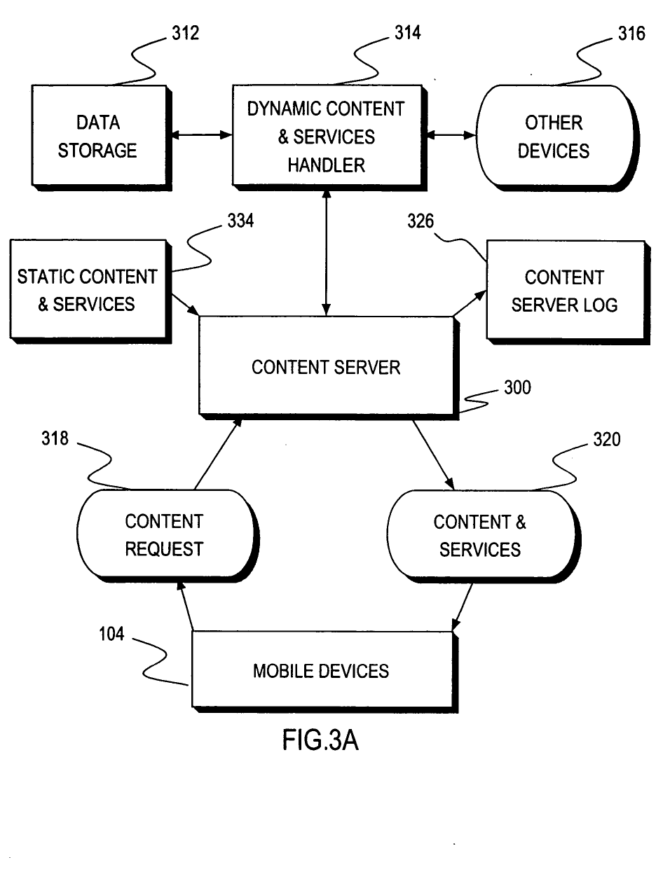

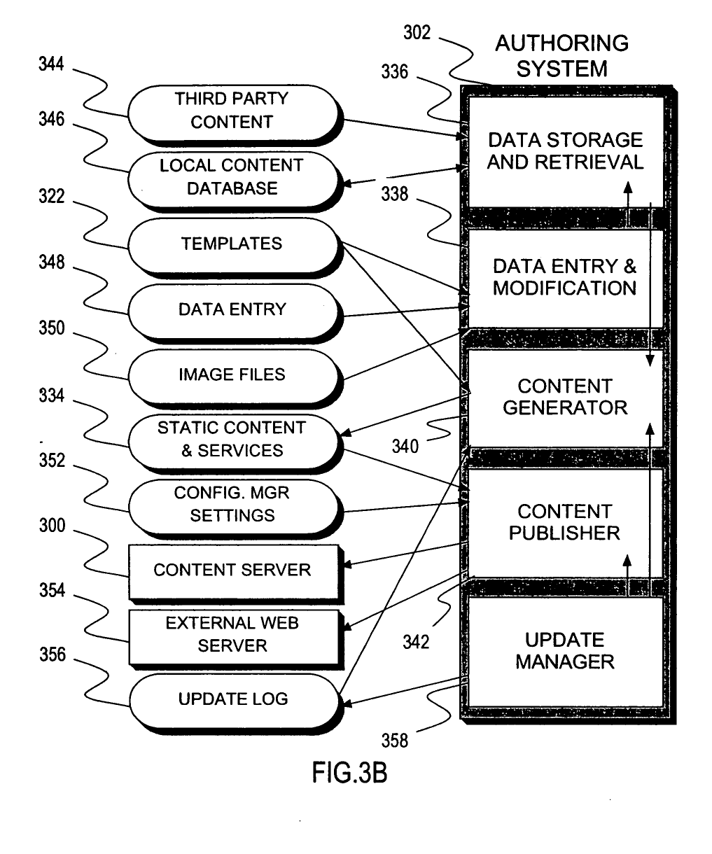

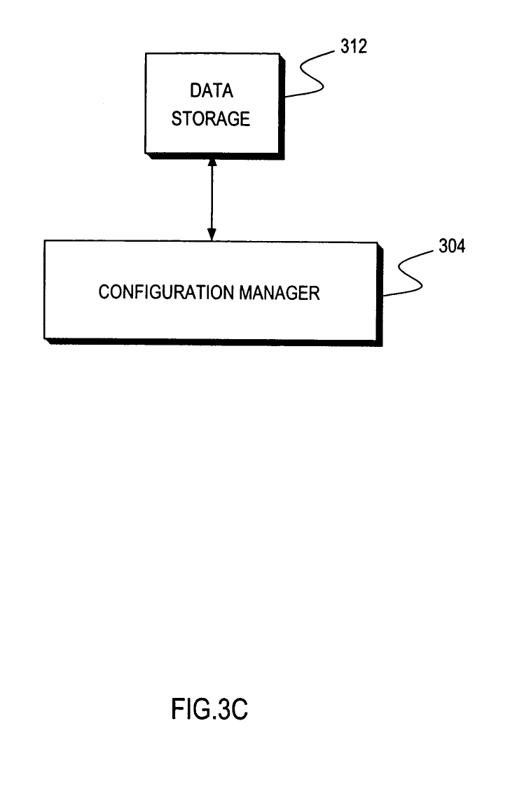

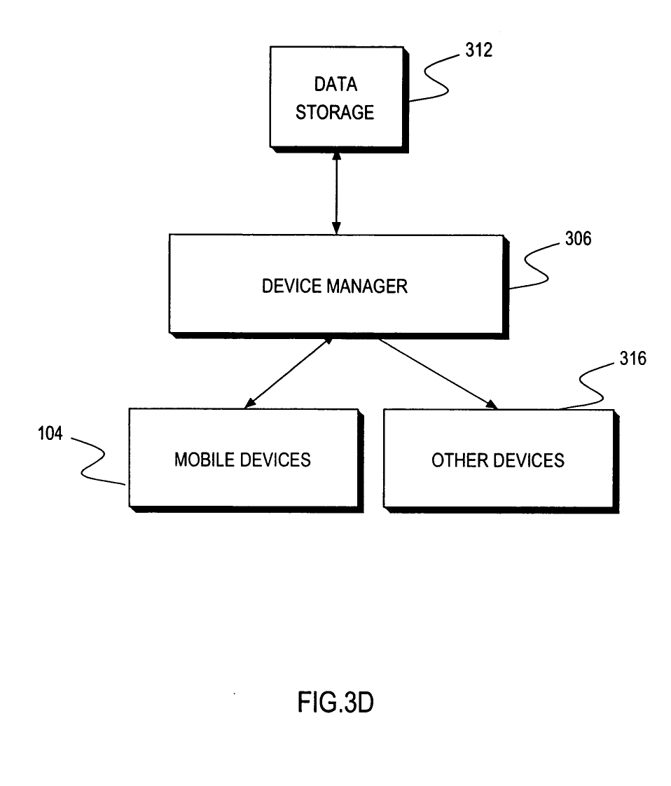

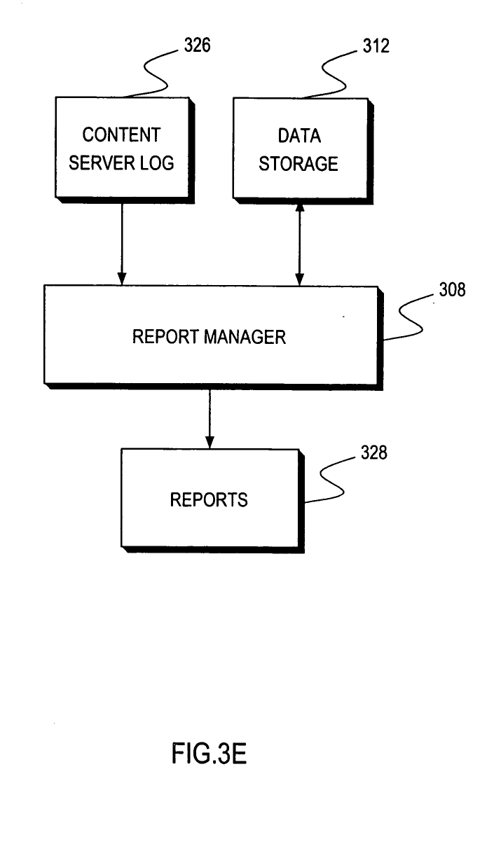

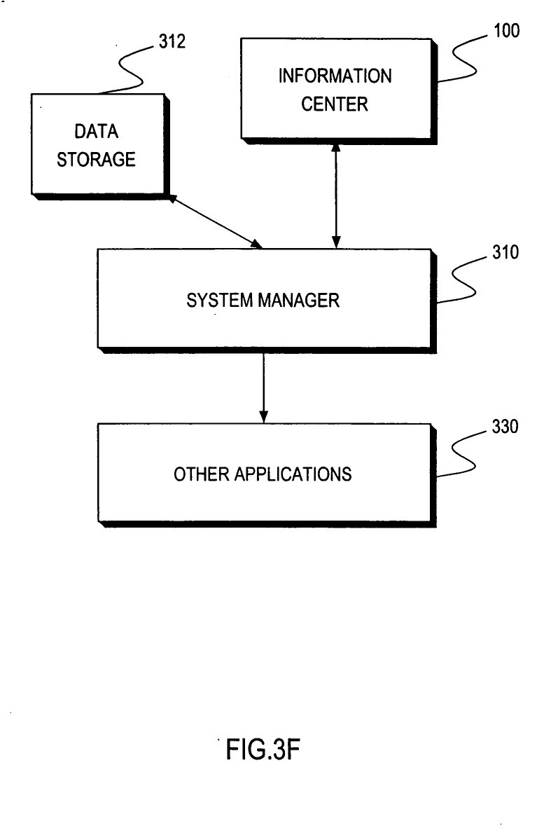

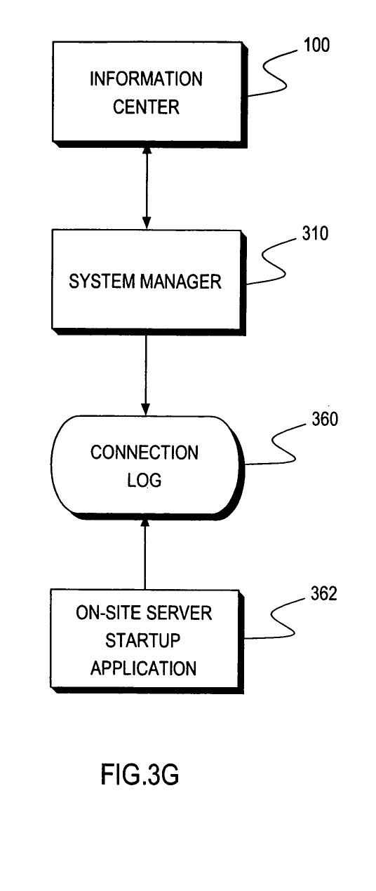

The invention includes an on-site server 102 that acts as the primary information server to the mobile devices 104. FIGS. 3A-3G are block diagrams of example on-site server(s) 102 useful for implementing items from FIGS. 1A and 1C

The on-site server 102 contains a content server 300 that delivers content to the mobile devices 104.

The on-site server 102 contains an authoring system 302 that allows content to be customized by the operator. The “operator” is the owner of a business where the invention is located or someone designated by them to manage the use of the invention in the business.

The on-site server 102 contains a configuration manager 304 that allows the operator to control various aspects of the invention's operation.

The on-site server 102 contains a device manager 306 that controls access between the on-site server 102 and mobile devices 104.

The on-site server 102 contains a report manager 308 that creates reports to provide information on the operation of the invention.

The on-site server 102 contains a system manager 310 that interfaces with the information center 100 and controls the various pieces of the on-site server 102.

The invention enables mobile devices 104 that display content and services obtained from the on-site server 102.

The example implementation shown in FIG. 1A is provided for illustrative purposes only. The invention is not limited to this example. For example, other implementations of the invention may not have all three layers shown in FIG. 1A.

FIG. 1B depicts an implementation of the invention in which the on-site server 102 is not present. In this case the mobile devices 104 may not be wireless and may be connected to the information center 100 via the Internet or any other communication means, such as a direct connection. The functionality provided by the on-site server 102 may be performed by the information center 100 via (for example) an ASP (application service provider) model.

FIG. 1C depicts an implementation of the invention in which the information center 100 is not present. The on-site server 102 may perform the functionality provided in other implementations by the information center 100.

FIG. 1D depicts an implementation of the invention in which both the information center 100 and the on-site server 102 are not present. One implementation of this would have the content pre-loaded on the mobile devices 104 and minimal or no centralized data collection would occur.

The content and services are customizable by the content provider, the operator and/or the user. This content includes but is not limited to:
HTML
JavaScript™
Java™
Channels
ActiveX
PDF
Multimedia images (JPEG, GIF, PNG, TIF, vector graphics, etc.)
Audio Files (AIFF, MP3, etc.)
Video (AVI, QuickTime™, etc.)
Streaming Content: Video/Data/Voice/Audio
Binary files
XML
Applications
Data Objects
Documents
Anything that can be delivered by a “browser”

Some of the content is developed by an authoring system 302. The authoring system 302 is a software program to allow people with minimal or non-existent computer experience to create content.

The invention can be implemented using data processing devices, such as computers, PDAs, cell phones, etc. The invention is directed to such devices operating as described herein. The invention is also directed to the methods described herein. The invention is also directed to systems comprising data processing devices operating as described herein, as well as combinations and sub-combinations of same. Further, the invention is directed to computer program products comprising computer readable media having control logic (software) that, when executed, cause data processing devices to operate as described herein. Such computer readable media includes any technology, including but not limited to any medium in which control logic can be stored or transferred, including magnetic media, optical media, electromagnetic signals, etc.

1.1 Restaurant Example

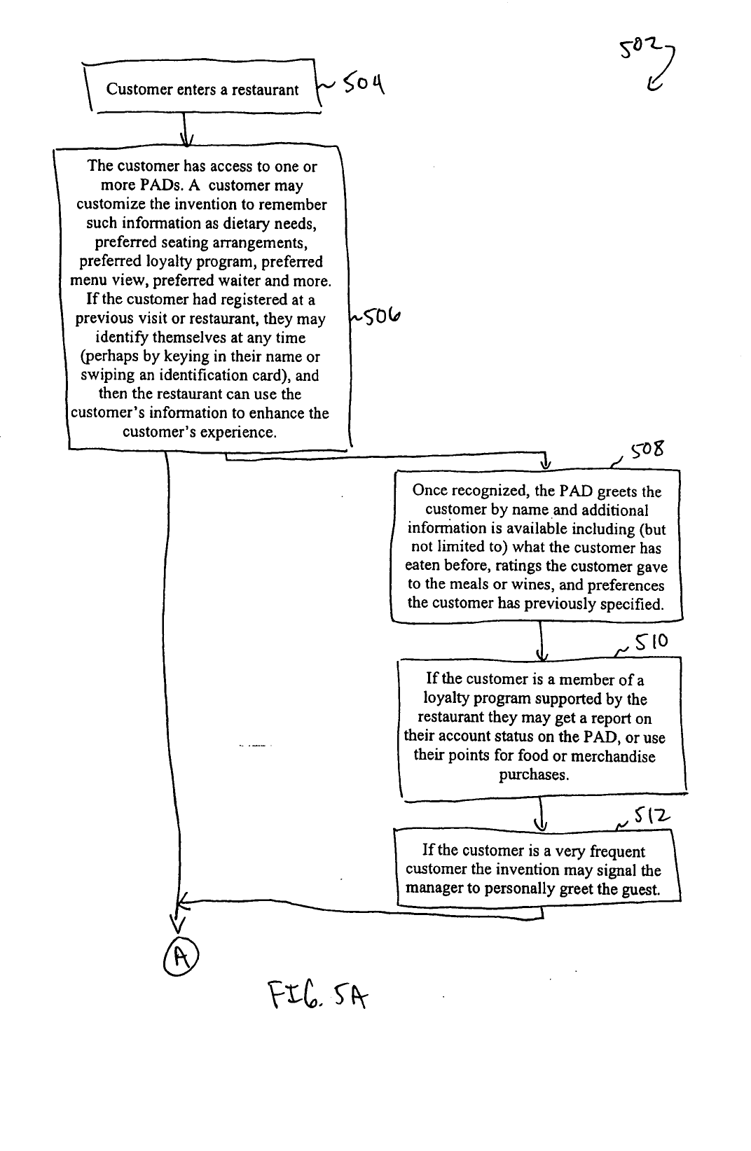

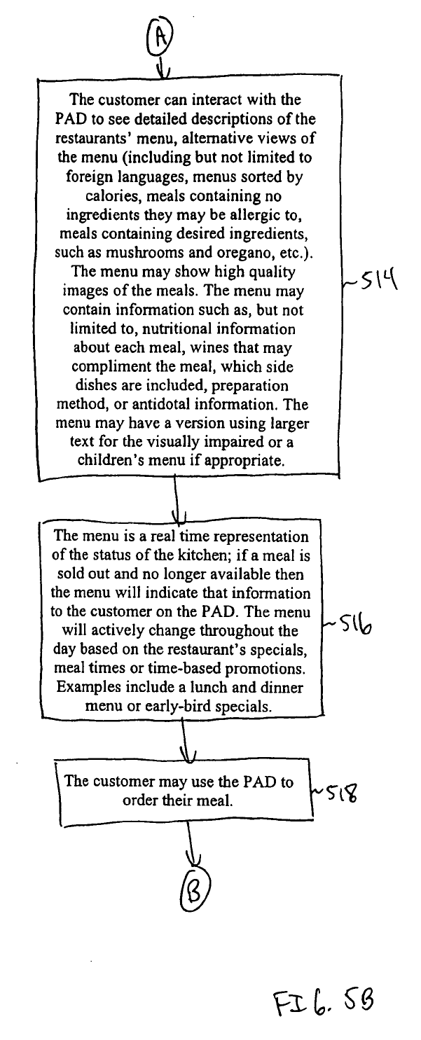

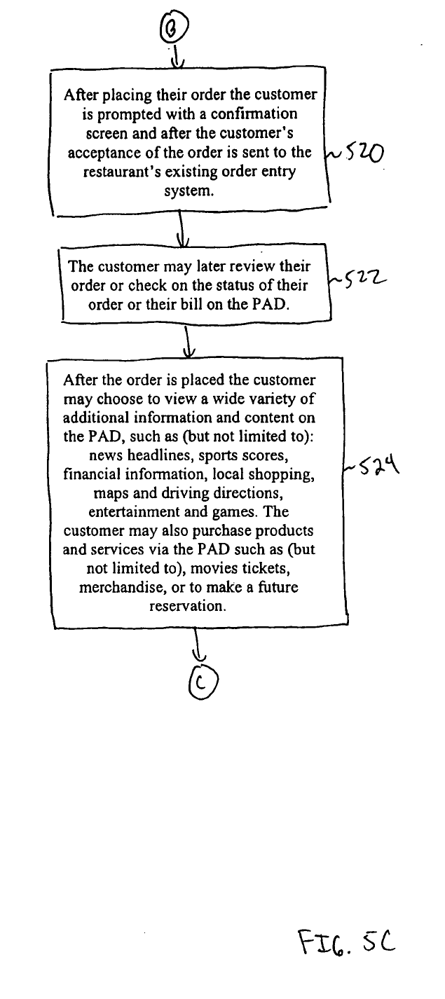

The invention shall initially be described by way of an example, which is depicted in a flowchart 502 shown in FIGS. 5A-5E. In particular, FIGS. 5A-5E collectively illustrate the operation of the invention from a customer's point of view. The following is described in the context of a restaurant, where the customer (also called the user or guest in the following) is a diner in the restaurant. However, this restaurant application is provided for illustrative purposes only, and is not limiting. Note, also, that FIGS. 5A-5E illustrate a single thread of operation. This example thread is provided for illustrative purposes only, and is not limiting. The invention's functionality and user interface is powerful and varied and, as such, the operability of the invention is far greater than that shown in FIGS. 5A-5E. For example, the steps shown in FIGS. 5A-5E can be performed in substantially any order, and most if not all of the steps shown in FIGS. 5A-5E are optional. The threads taken by different customers (or the same customer on different visits) will reflect the different dining experiences of the customers.

Turning first to FIG. 5A, consider a scenario where a user enters a restaurant (step 504); the hostess brings the user(s) to their table and hands each user a personal assistance device (PAD) (step 506). The PAD can be implemented using any data processing device, including but not limited to a desk top computer, a personal data assistance (PDA), a telephone, a lap top computer, etc. The PAD is in communication with one or more servers via any communication means or medium, including wired or wireless communication networks or connections. In the following discussion, the PAD is implemented using a wireless mobile device 104 with a touch screen, although it should be understood that this example is used for illustrative purposes only, and is not limiting. The hostess informs the user(s) that the mobile device 104 is their menu in addition to containing other content and services and that they can use the mobile device 104 to call the wait-staff or the restaurant manager.

The user interface provided by the mobile device 104 is as recognizable, intuitive, and as easy to use as a printed menu. The user can interact with the mobile device 104 with no additional training. If the user has difficulty at any time there is an intuitive, system wide help facility that provides context sensitive on-screen tips.

A user may customize the invention to remember such information as dietary needs, preferred seating arrangements, preferred loyalty rewards program, preferred menu view, preferred waiter, a history of past meals, ratings of wine or food and more. If the user had registered at a previous visit or restaurant, they may also give their card to the hostess when first being greeted, or swipe it through a device themselves (or identify themselves in some other fashion) and the hostess may address them by name and use any preferences they have supplied to seat them.

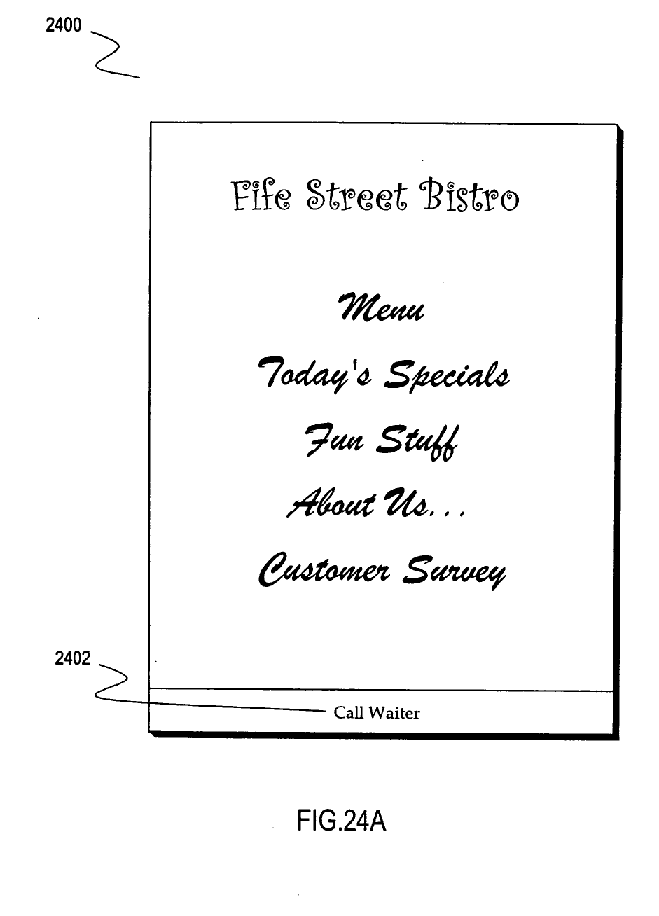

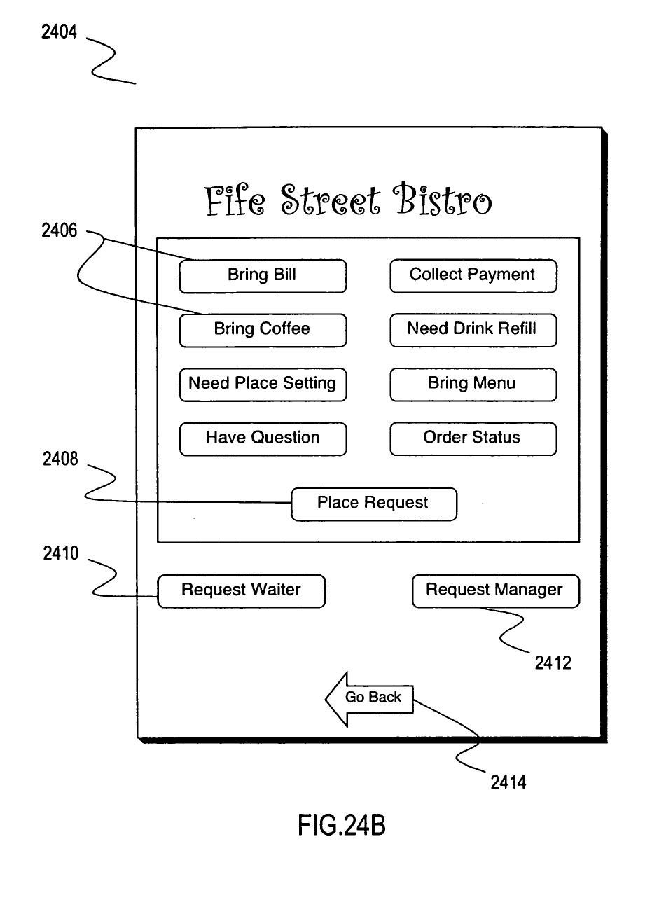

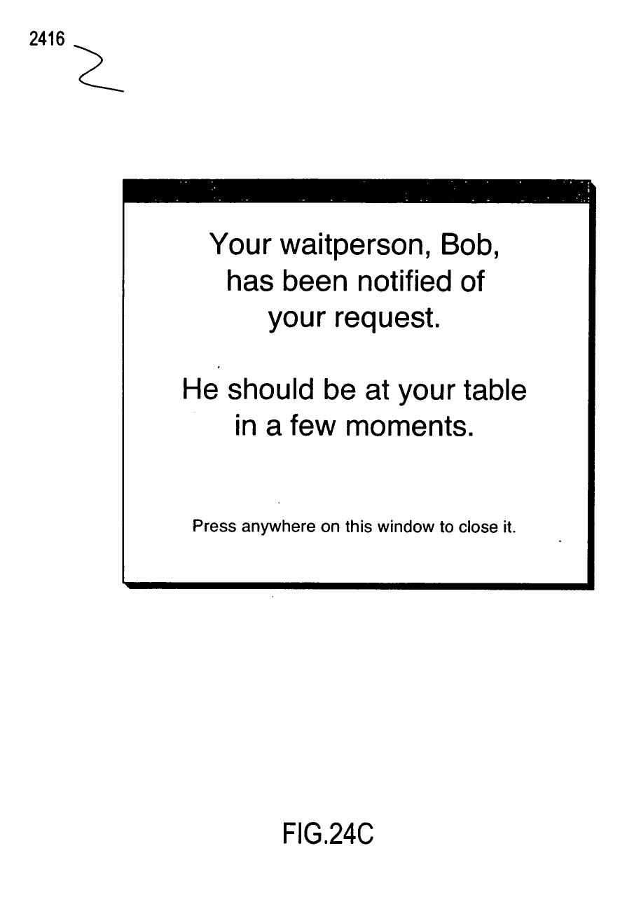

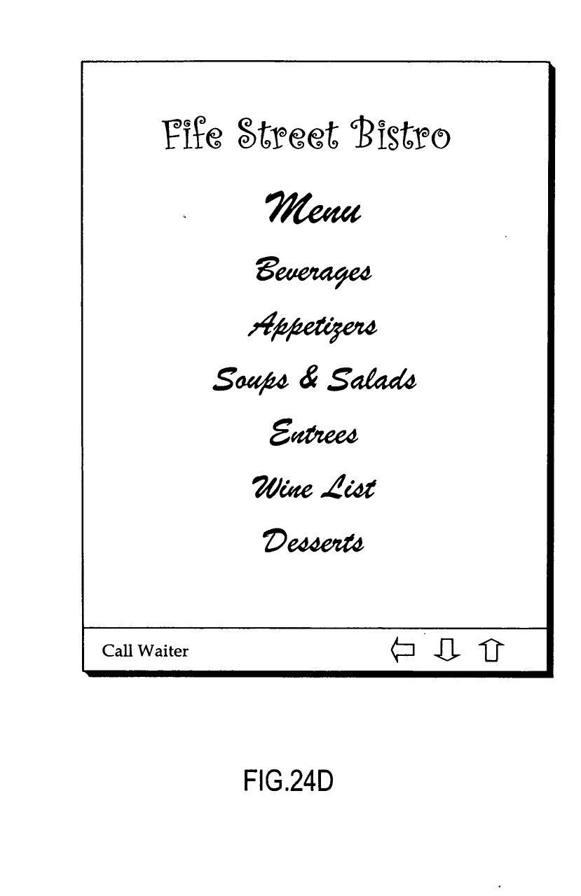

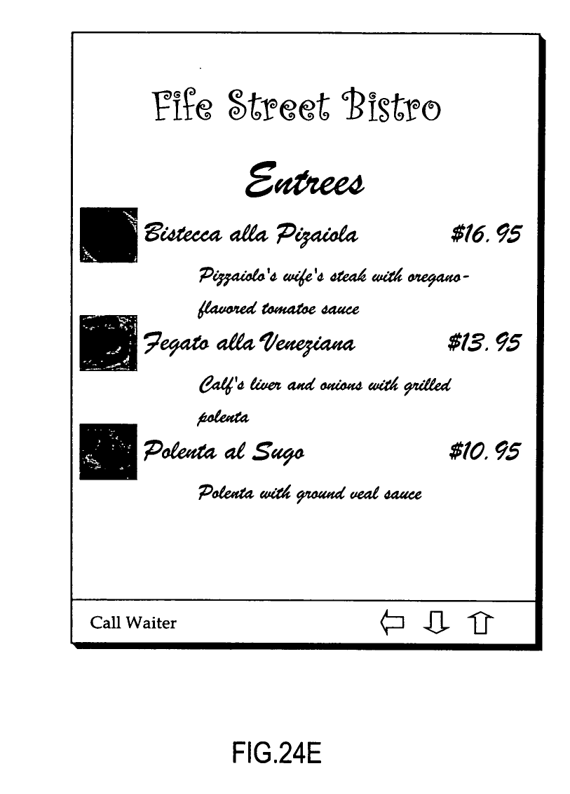

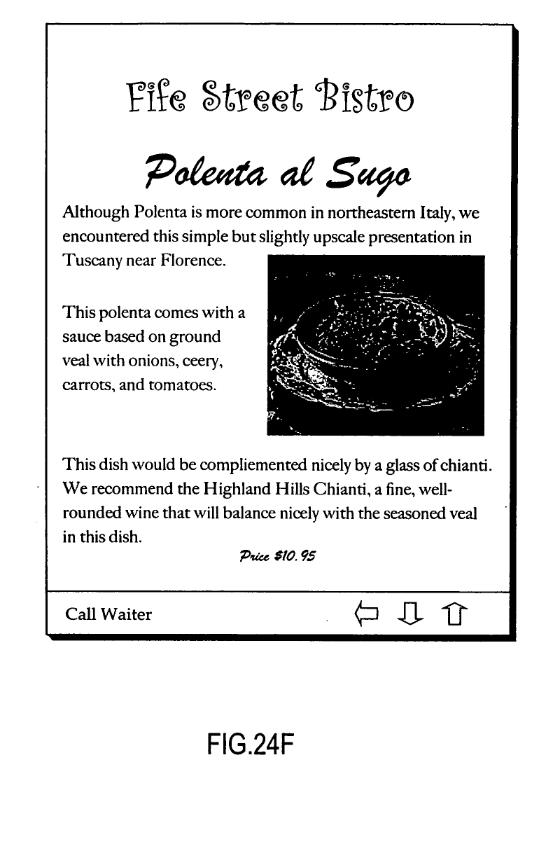

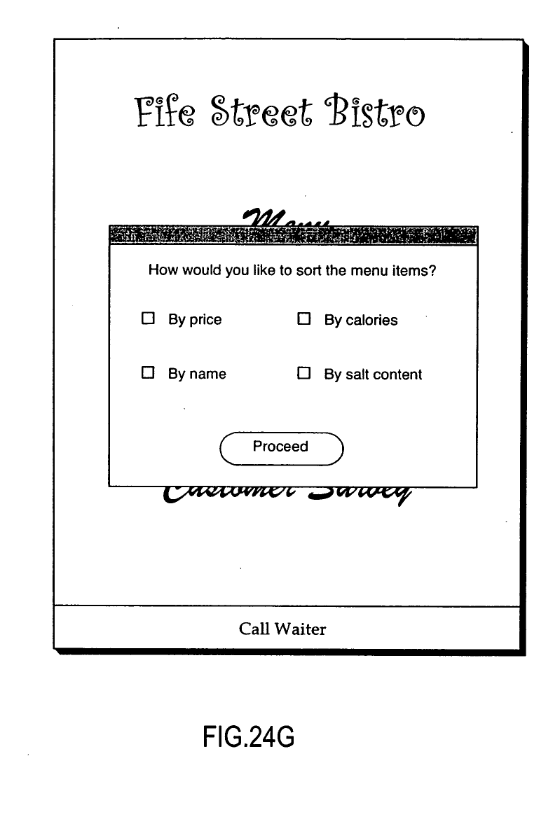

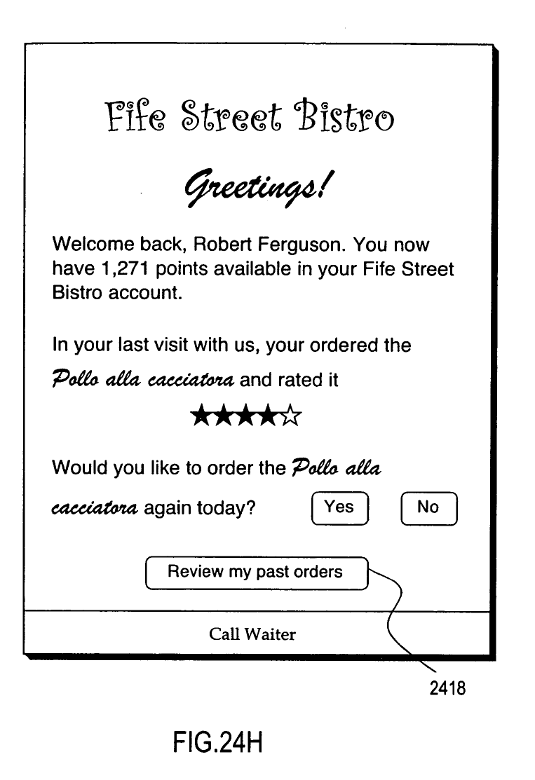

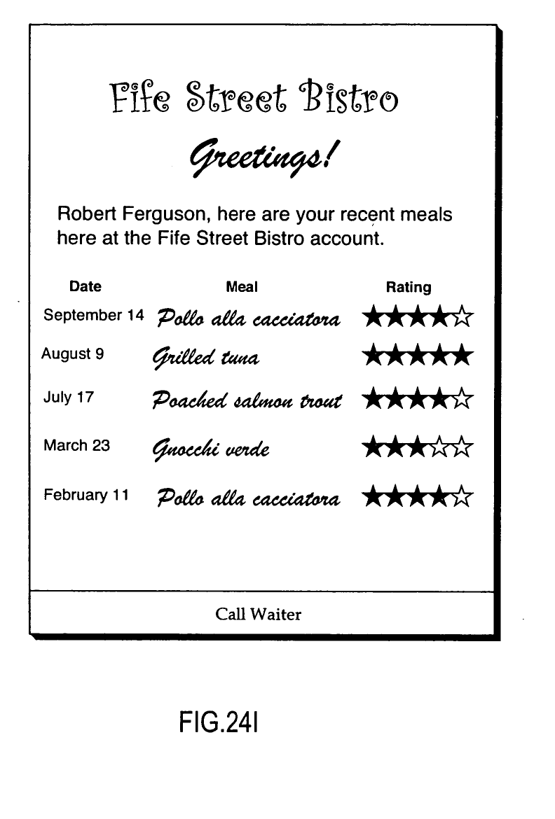

If the user has previously registered using a magnetic card (or another method) while visiting this or another restaurant using the invention, then the user can swipe that card through the mobile device 104 (or identify themselves in some other fashion) and the invention recognizes the user. Once recognized, then in step 508, the invention via the PAD greets the user by name and additional information is available including (but not limited to) what the user has eaten before, ratings the user gave to the meals or wines, and preferences the user has previously specified, an example is depicted in FIG. 24H. As represented by step 510, if the user is a member of a loyalty rewards program supported by the restaurant they may get a report on their account status, or use their points for food or merchandise purchases. As represented by step 512, if the user is a very frequent customer the invention may signal the restaurant manager to personally greet the guest.

Referring now to FIG. 5B, the user can interact with the mobile device 104 to see detailed descriptions of the restaurants' menu, alternative views of the menu (including but not limited to foreign languages, menus sorted by calories, meals containing no ingredients they may be allergic to, meals containing desired ingredients, such as mushrooms and oregano, etc.), an example is depicted in FIG. 24G. The menu may show high quality images of the meals. The menu may contain information such as, but not limited to, nutritional information about each meal, wines that may compliment the meal, which side dishes are included, preparation method, or antidotal information. The menu may have a version using larger text for the visually impaired or a children's menu if appropriate.

These can be seen in FIGS. 24D, 24E, and 24F. FIG. 24D depicts a high-level view of the menu. The user can select a segment of the menu, for example “Entrees”. At that point they can see the items contained in that segment of the menu, as depicted in FIG. 24E. The user can then choose a particular menu item, and see details on that item, including an image of the dish, as is shown in FIG. 24F.

The menu is a dynamic, real time representation of the status of the kitchen; if a meal is sold out and no longer available then the menu indicates that information to the user. The menu actively changes throughout the day based on the restaurant's specials, meal times or time-based promotions. Examples include a lunch and dinner menu or early-bird specials. This is represented by step 516.

In step 518, the user may use the mobile device 104 to order their meal. Referring to FIG. 5C, in step 520, after placing their order the user is prompted with a confirmation screen and after the user's acceptance of the order is sent to the restaurant's existing order entry system. In step 522, the user may later review their order or check on the status of their order or their bill.

As represented by step 524, after the order is placed the user may choose to view a wide variety of additional information and content such as (but not limited to): news headlines, sports scores, financial information, local shopping, maps and driving directions, entertainment and games. The user may also purchase products and services via the mobile device 104 such as (but not limited to), movies tickets, merchandise, or to make a future reservation.

Referring to FIG. 5D, in step 526, if at any time during their restaurant visit the user has a question or a request they may press the “Call Waiter” button. Buttons in this invention may be physical button or touch sensitive areas on the mobile device's 104 display. The “Call Waiter” button can also be seen as 2402 in FIG. 24A. When the “Call Waiter” button 2402 has been pressed, the user is presented with a list of the most common requests and the user may select as many requests as they want, and then they press the “send request” button. Referring to FIG. 24B, the request buttons can be seen as 2406. The user has the option of selecting as many request buttons 2406 as they wish, and press then Place Request button 2408. In addition, the user has the option of requesting a particular person, such as the waiter or manager, via the buttons 2410 and 2412. A signal is sent to the particular waiter, or bus person, or manger to attend to the request. The wait-staff, restaurant manager and hostess have a wireless paging device 116 capable of indicating the nature of the request and the requesting table, and thus they can go directly to the table with the solution. Once the request has been sent to the appropriate person, the user is presented with a screen, depicted in FIG. 24C, informing them that their request has been received and will be attended to shortly.

In step 528, if the user does not interact with the mobile device 104 for a configurable amount of time it goes into a mode of showing various images. This could be in the form of a slide show. These may be images such as (but not limited to) promotional (showing images of the next course), images that match the decor of the restaurant, art, local points of interest, or advertising.

In step 530, the restaurant may also provide promotional information such as (but not limited to), catering, banquet facilities, merchandise, restaurant history, recipes, reviews and rewards.

Referring to FIG. 5E, in step 532, the mobile device 104 includes a survey where the user may indicate their satisfaction with various aspects of their dining experience. If the user is particularly dissatisfied with their experience the invention may signal the restaurant manager to visit the table and attempt to rectify the situation. The mobile device 104 may have suggested additions to the menu that the user may indicate which they prefer.

In step 534, at the end of the meal the user may pay for their meal by swiping a credit card through the mobile device 104. The mobile device 104 assists in tip calculation. After the credit card is authorized the wait-staff brings the receipt, any tickets or merchandise purchased, driving directions or coupons the user has requested. If the user is a member of a loyalty rewards program the points for the meal or merchandise just purchased are added to their account.

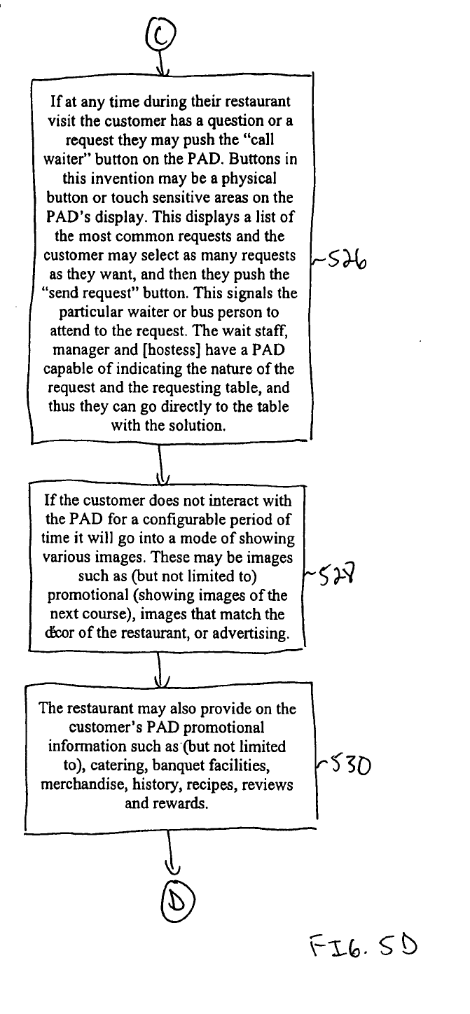

The just-described FIGS. 5A-5E depict the operation of the invention from a user's point of view. FIG. 6 illustrates a flowchart 602 that depicts the operation of the invention from the wait-staff's point of view. It is noted again that the operation shown in these figures are provided for example purposes only. The invention is not limited to these particular operational examples.

In step 604, when the wait-staff arrives for work they use the mobile devices 104 to learn about the menu and specials of the day, thus saving the restaurant manager time.

In step 606, when a user enters the restaurant, the hostess asks if the user is a member of a loyalty rewards program. If the user is a member of a related loyalty rewards program they present their card to the hostess who then swipes it through the hostess paging device 116. At this time the hostess can greet the user by name and has additional information to assist in the seating process. If the user is a frequent guest the restaurant manager may have configured the invention to provide a special alert on a paging device 116 of his choosing.

In step 608, the hostess may hand a mobile device 104 to the user to take to the bar, after associating the user name with that device. At the bar the user can use the invention to peruse the drink or food menu. The mobile device 104 signals the user when their table is ready.

In step 610, the hostess associates the particular mobile device 104 with the table as they bring the guest(s) to their table. Each of the wait-staff is given a paging device 116 when they start their shift and they are assigned specific tables. The paging device 116 could be a 2-way alphanumeric pager with vibrate mode, or a portable phone with text capability, or even a mobile device 104.

In step 612, once the mobile device 104 of the user is associated to the table, it can display the name(s) of the wait-staff assigned to the table and the users may signal the wait-staff for service. When the users requests service the invention looks up the waitperson assigned to the table and signals the paging device 116 assigned to that waitperson.

As represented by step 614, the invention automatically signals the wait-staff when new guests are seated at one of their assigned tables. The wait-staff may view any special dietary or other preferences of the guest's before visiting the table.

As represented by step 616, the invention supports users ordering directly from the mobile device 104. As each user completes their order a signal is sent to their waitperson. If the users have difficulty or questions during the ordering process they may use the mobile device 104 to signal their wait-staff. After the last user at the table has ordered the wait-staff may view the complete order at a central display and if there are no problems they approve the order. The invention then sends the order to the kitchen either directly or via an order entry system. The wait-staff may return to the table to retrieve any unneeded mobile devices 104, leaving at least one for the table.

As represented by step 618, there may be a mobile (or fixed) device in the kitchen that allows the kitchen staff to signal the wait-staff that the meals for a table are ready or that a menu item is unavailable.

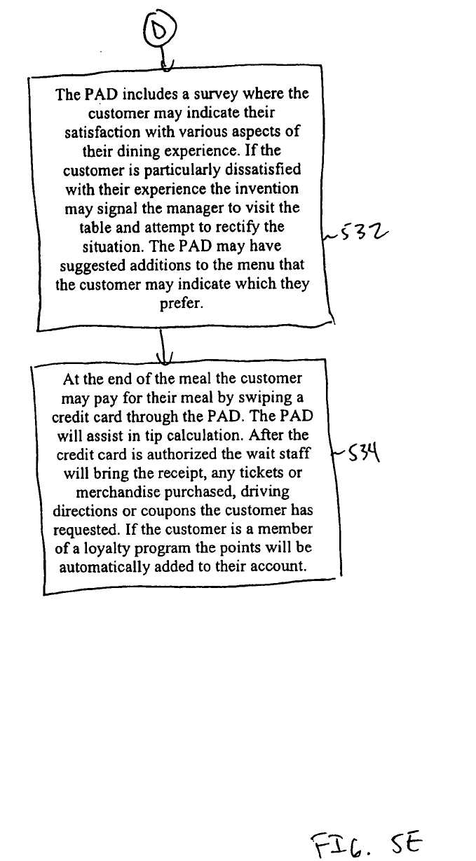

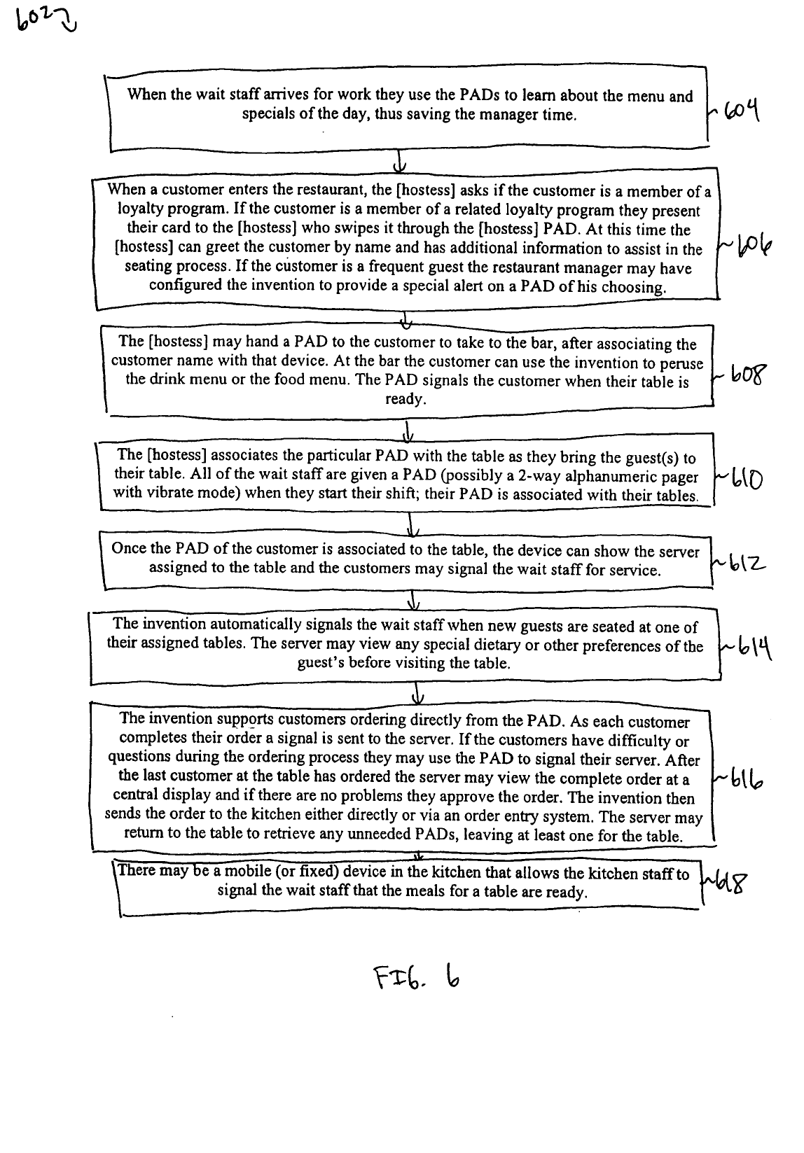

FIG. 7 presents an example flowchart 702 illustrating how the system is installed and configured.

As represented by step 704, when the invention was first installed the restaurant manger was given a license for a fixed number of mobile devices 104. At that time or subsequent to that time each mobile device 104 is associated to the on-site server 102. Attaching the mobile device 104 to the on-site server 102 does this association process. The mobile device 104 and on-site server 102 exchange information that allows them to communicate with each other. This prevents other wireless devices from interfering with the operation of the invention.

As represented by step 706, the restaurant manager and chef use the authoring system 302 of the invention to design and layout the menu. The authoring system 302 supports (but is not limited to) a database of previous menus, previous meals and various pictures of those meals, a graphical user interface to aid in laying out and organizing the menu, import images, time based pricing control, two levels of customizable menu templates, the ability to view and test the menu, the ability to send a menu to a web site or to a particular mobile device 104, and HTML and JavaScript (and other) verifiers to ensure any customizations are correct. The user interface and data entry of the authoring system 302 is derived from the chosen templates. The operator of the authoring system 302 may also send entire menus to a support organization to resolve any design and layout difficulties.

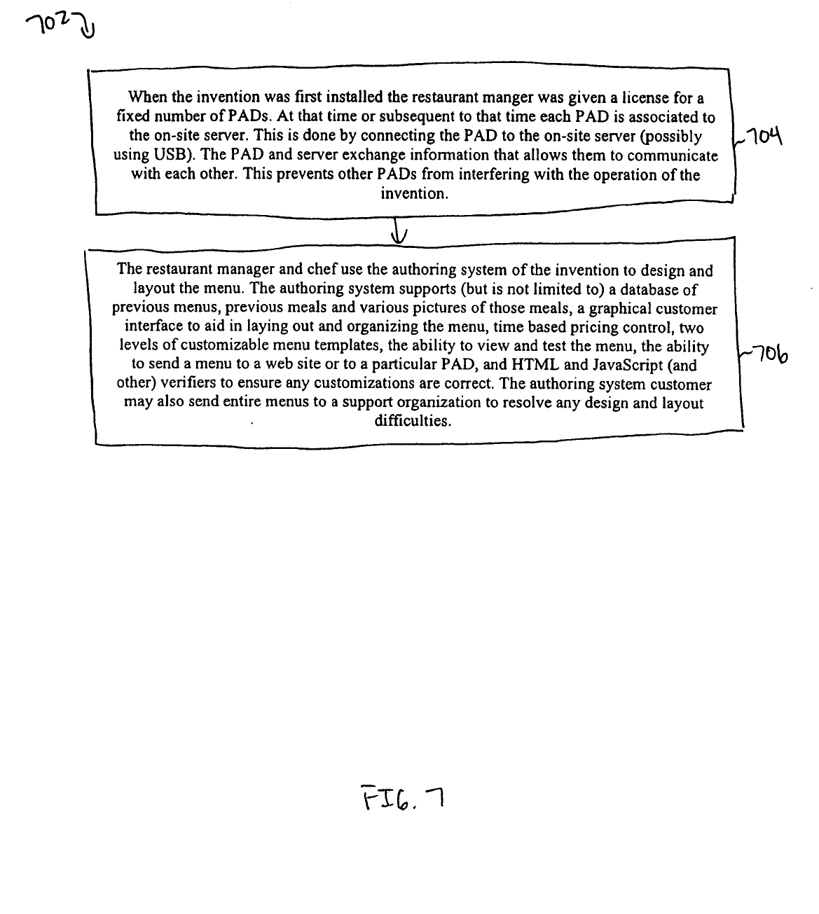

FIG. 8 illustrates a flowchart 802 that depicts functions available to management.

As represented by step 804, the restaurant manager and hostess may each have available a paging device 116 capable of viewing the status of tables in the restaurant. They can view information such as (but not limited to), how many guests are at each table, the wait-staff assigned to each table, the progress of the meal at each table, in some cases the names of the guests, their dining frequency and other individual preferences.

As represented by step 806, the restaurant manager may view a variety of reports that show the real time status of his operation, customers and employees. Some of these reports include but are not limited to: survey results (possibly sorted by wait-staff), wait-staff response times, waiter and table loading, a count of pages viewed, correlation of meals ordered with meals viewed, system hardware status, frequent guest activity and table turn times. The restaurant manager may also view reports that show the status of things outside his operation, including but not limited to: other loyalty information, advertising and merchandising revenues, billing information, and comparisons of this restaurant with other similar restaurants.

FIG. 1E is a block diagram that depicts an example of an implementation of the invention being utilized in a restaurant.

When the user 106 enters the restaurant, the hostess 108 greets them;
the hostess 108 takes a mobile device 104 from the charging station 112, and escorts the user 106 to the table 118. Note that if there are multiple people in the party, the hostess 108 may take multiple mobile devices 104 from the charging station 112. Once at the table 118, the hostess 108 gives the mobile device(s) 104 to the user(s) 106, explaining that the mobile device 104 is their menu, and can be used to summon the wait-staff, or to find out other information of interest.

Once the user 106 is at the table 118 and is using the mobile device 104, the mobile device 104 communicates with the on-site server 102, which may in turn communicate with the information center 100 to retrieve information or perform services that the user 106 has requested.

The user 106 can use the mobile device 104 to summon the wait-staff 110. When such a request is made, the mobile device 104 signals the on-site server 102, which then communicates with the pager interface 114. The pager interface formats and sends a message to the paging device 116, which is being carried by the wait-staff 110. The wait-staff receives the message, acts upon it, and clears the message from the paging device 116. The paging device 116 then communicates with the pager interface 114, which in turn communicates with the on-site server 102, which stores the resolution of the service request for later consolidation and reporting.

2. Example Structure of Embodiments of the Present Invention

FIG. 1A is a block diagram of an embodiment of the present invention, it depicts an implementation using all three layers of the invention: information center 100, the on-site server 102, and mobile devices 104. The invention enables an information center 100 that collects system status and usage information; it manages version control and delivery of software to the other layers, and it delivers content. The information center 100 interfaces to a variety of internal and external sources from which content and information is exchanged.

The information exchanged between the information center 100 and the on-site server 102 takes place over the Internet or some other widely understood communications media. Other implementations could use proprietary communications media.

The information exchanged between the on-site server 102 and the mobile devices 104 takes place either wirelessly, or wired, using some widely understood communications media. Other implementations could use proprietary communications media. The communications protocols between the on-site server 102 and the mobile devices 104 ensure that communications only takes place when both ends of the communication channel have been mutually identified. Other embodiments of the invention may not require this mutual identification.

2.1 Information Center

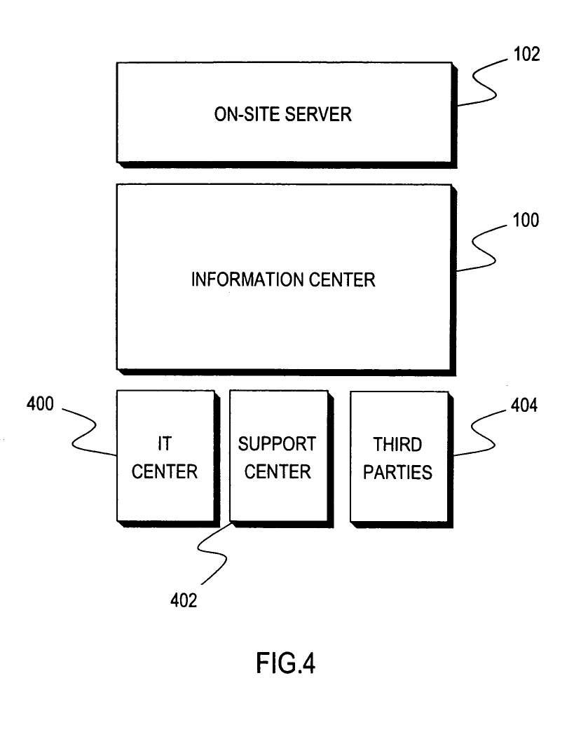

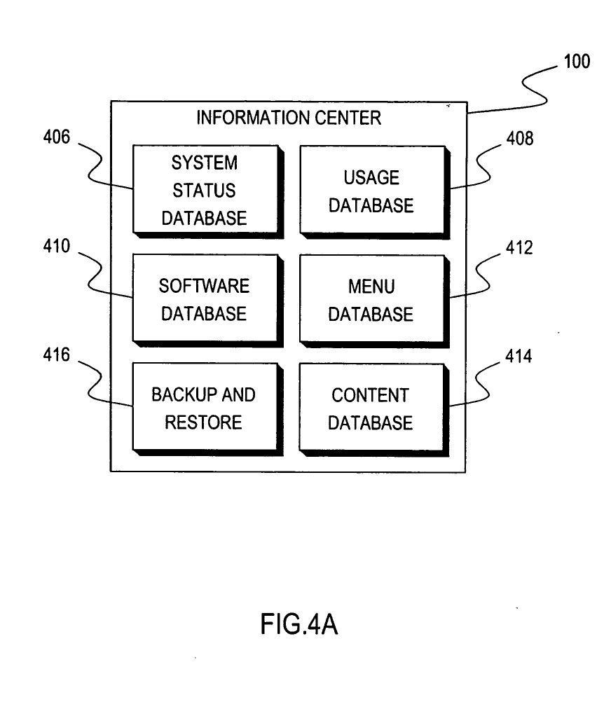

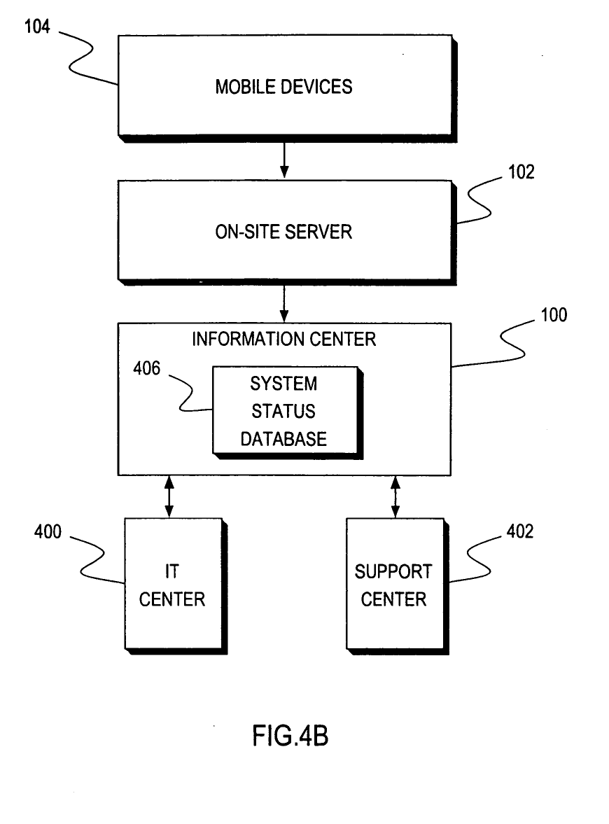

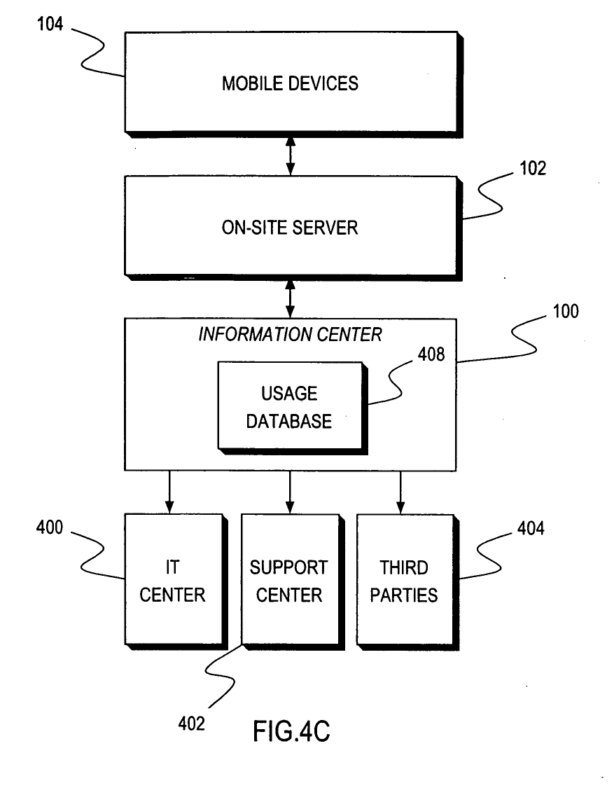

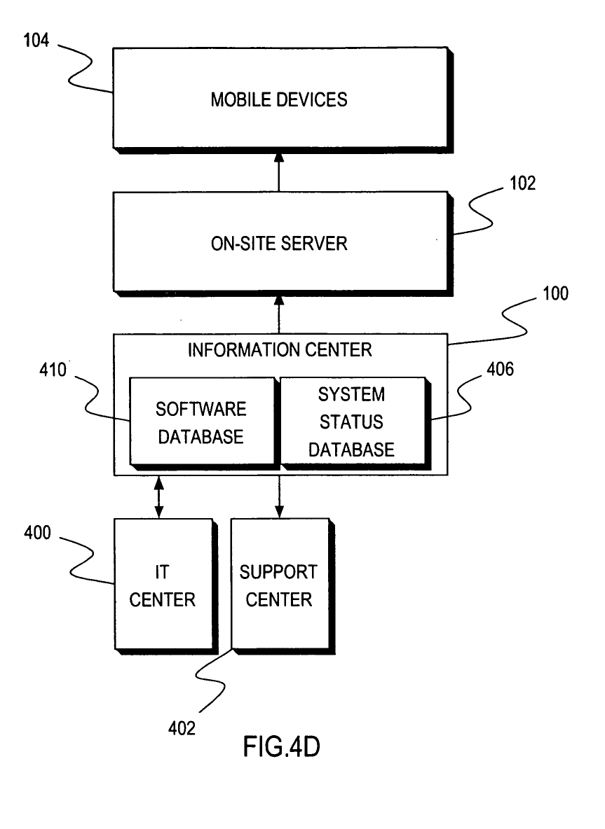

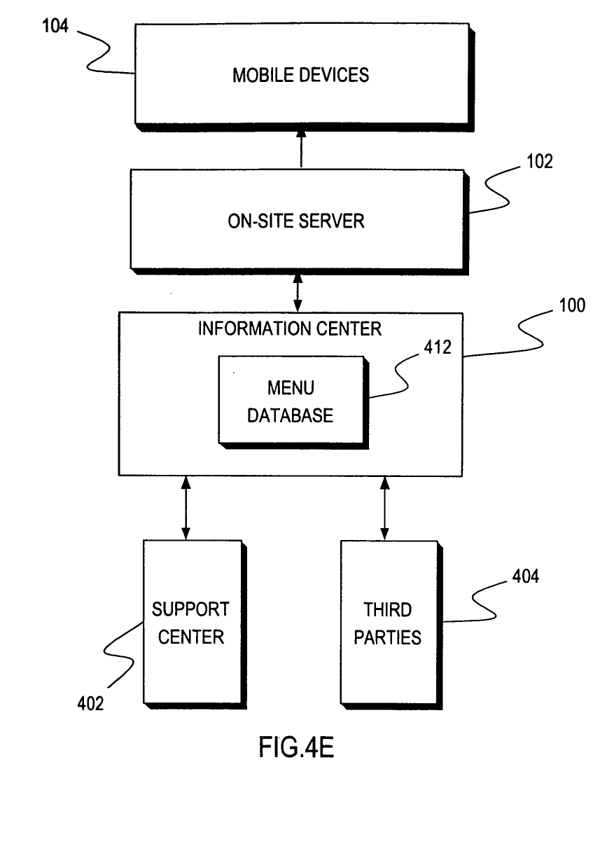

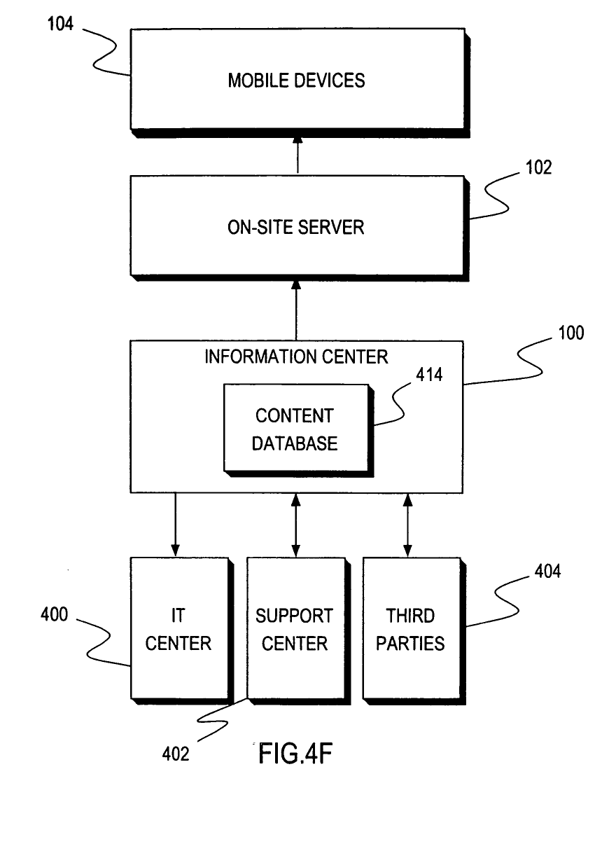

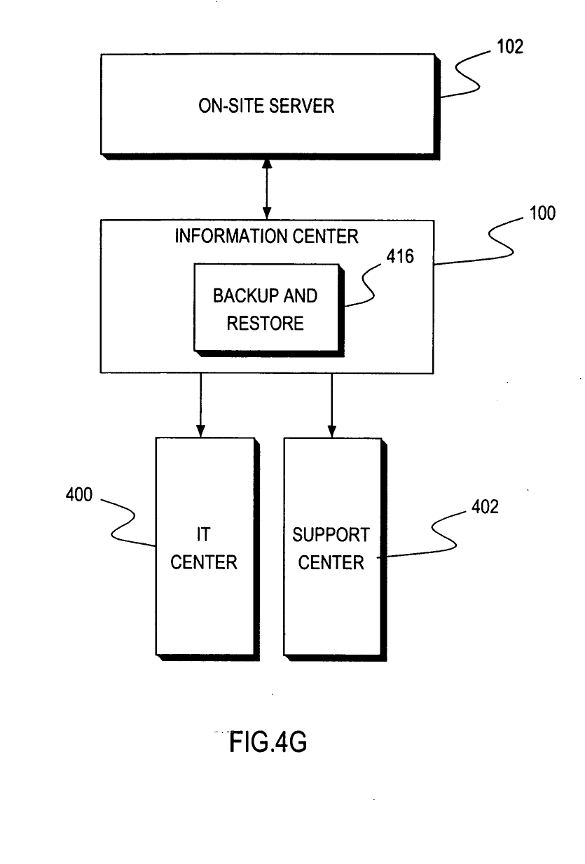

FIG. 4 is a block diagram of an embodiment of the information center 100.

FIG. 4A is a block diagram that depicts the types of databases the information center 100 utilizes (other implementations may have more or fewer databases).

FIG. 4B is a block diagram that depicts an example of an implementation of the system status database 406 in an embodiment of the invention.

As each of the mobile devices 104 powers up it performs a diagnostic self-test and sends these results to the on-site server 102. The on-site server 102 evaluates this information and if a problem it detected then it sends that information to the information center 100. The information center 100 stores that information in the system status database 406, and it sends that information as needed to the IT center 400 and the support center 402.

Periodically, the on-site server 102 performs its own diagnostics and sends these to the information center 100. Periodically, the on-site server 102 sends all diagnostic information to the information center 100. The information center 100 stores all information sent in the system status database 406, and sends that information as needed to the IT center 400 and the support center 402.

In some cases the IT center 400 and the support center 402 send information to the information center 100 to be stored in the status database 406.

FIG. 4C is a block diagram that depicts an example of an implementation of the usage database 408 in an embodiment of the invention.

As each of the mobile devices 104 views content and uses services delivered by the on-site server 102 that information is stored on the on-site server 102 and periodically sent to the information center 100. The information center 100 stores that information in the usage database 408, and it sends that information as needed to the IT center 400, the support center 402, and third parties 404.

In some cases the information center 100 sends information to the on-site server 102 based on information in the usage database 408.

FIG. 4D is a block diagram that depicts an example of an implementation of the software database 410 in an embodiment of the invention.

The IT center 400 submits all versions of software to the information center 100 where each is stored in the software database 410. The IT center 400 sends at least three kinds of software; software that is designed to run on the information center 100, on the on-site server 102, and on the mobile devices 104. The support center 402 can also download any version of the software from the information center 100. The information center 100 sends software versions for both the on-site server 102 and the mobile devices 104 to the on-site server 102. The on-site server 102 sends the appropriate software to the mobile devices 104.

Sending the software to a particular layer may not actually install that software; the actual installation of the software may be deferred until some configurable time frame.

An alternate implementation allows the on-site server 102 to initiate the request for software versions to the information center 100. In this case the information center 100 compares information from the system status database 406 with the software database 410 to determine which software versions to send.

FIG. 4E is a block diagram that depicts an example of an implementation of the menu database 412 in an embodiment of the invention.

Menus are lists of content and services provided by the operator. The menu database 412 stored at the information center 100 provides a secure, version-controlled repository of menus for each on-site server 104 location. In the case of a business with multiple locations the corporate office, a third party 404, may want to distribute a menu to all of its locations or different menus to selected locations. These menus are sent to the information center 100 where they are stored in the menu database 412 and then delivered to the appropriate on-site server(s) 102. The menus delivered to the on-site server(s) 102 are then further processed for display on the mobile devices 104.

The support center 402 can also download any version of the menus from the information center 100 for use in solving customer support issues. If needed the support center 402 can also upload menus to information center 100 where they are used in the same fashion as those from a third party 404.

FIG. 4F is a block diagram that depicts an example of an implementation of the content database 414 in an embodiment of the invention.

Content is all the information and services provided to the operator for display on the mobile devices 104 that is not contained in the menus. The content database 414 provides a secure, version-controlled repository of content for each location. In the case of a business with multiple locations the corporate office (for example a restaurant chain) or other third party 404, may want to distribute content to all of its locations or different content to selected locations. This content is sent to the information center 100 where it is stored in the content database 414 and then delivered to the appropriate on-site server(s) 102. The content delivered to the on-site server(s) 102 is then further processed for display on the mobile devices 104.

In some cases the IT center 400 downloads content from the information center 100.

The support center 402 can also download any version of the content from the information center 100 for use in solving customer support issues. If needed the support center 402 can also upload content to information center 100 where they are used in the same fashion as those from a third party 404.

FIG. 4G is a block diagram that depicts an example of an implementation of the backup and restore database 416 operations in an embodiment of the invention.

The operator may choose to have a duplicate of critical data from their on-site server(s) 102 stored in the backup and restore database 416 on the information center 100. The business may also choose to restore a copy of their critical data from the backup and restore database 416 on the information center 100 to their on-site server 102.

The IT center 400 monitors the size of the backup and restore database 416 usage from the information center 100.

The support center 402 can also download any version of the backup and restore database 416 from the information center 100 for use in solving critical customer support issues.

2.2 On-Site Server

FIG. 3 is a block diagram of an embodiment of the on-site server 102. Note that an implementation of the data storage 312 could be in the form of a database, native file structure or other data store.

FIG. 3A is a block diagram that depicts an example of an implementation of the content server 300 in an embodiment of the invention.

The mobile devices 104 make content request(s) 318 to the content server 300. In most cases, the content server 300 returns static content and services 334. However in some cases, the content server 300 passes the request to a dynamic content and services handler 314. The dynamic content and services handler 314 can extract data from data storage 312, from the information center 100 or third parties 404, and can interact with other devices 316 before returning content and services to the content server 300. Examples of other devices 316 may include mobile paging devices, cell phones, or interfaces to a point of sale system (POS). In all cases the content server 300 logs the request in content server log 326 and returns the content and services 320 to the mobile devices 104.

An implementation of an embodiment of the content server 300 is a web server. In this case the content request(s) 318 could be in the form of HTTP requests, the dynamic content and services handler 314 could be Common Gateway Interfaces (CGI), and the content and services 320 could be web content such as (but not limited to HTML, images, movies, sound, or Java Script).

FIG. 3B is a block diagram that depicts an example of an implementation of the authoring system 302 in an embodiment of the invention.

The primary role of the authoring system 302 is to create and manage static content and services 334. The authoring system 302 is comprised of the following major components: data storage and retrieval 336, data entry & modification 338, content generator 340, content publisher 342, and update manager 356.

Data storage and retrieval 336 is responsible for reading third party content 344 and reading and writing the local content database 346. In the restaurant example, third party content 344 could include, but is not limited to, advertisements, news, maps, driving directions, and could include menus that the corporate office of a restaurant chain wants published in individual restaurants.

Data entry and modification 338 is responsible for providing the user interface enabling the operator to enter and modify data that will be later published by the authoring system 302. Data entry and modification 338 derives its user interface from the templates 322 upon which the operator chooses to base his content. Data entry and modification also allows the operator to enter and modify images files 350. Data entry and modification 338 utilizes data storage and retrieval 336 to save the data entry 348 made by the operator as well as any image files 350 that the operator added.

Content generator 340 utilizes data storage and retrieval 336 to read both third party content 344 and content database 346, and uses templates 322 to create static content & services 334.

Content publisher 342 is responsible for placing the static content & services 334 where it can be utilized by the outside world. For example, content publisher 342 moves the static content & services 334 into the proper file location in the file system such that the content server 300 can deliver the static content & services 334 to the mobile devices 104. In addition, content publisher 342 can read configuration manager settings 352 to move the static content & services 334 to an external web server 354.

Update manager 356 is utilized when the operator wishes to make a temporary change to the static content & services 334. When those changes are made, update manager 356 records them in update log 356, and then utilizes content generator 340 to generate the modified portions of the static content & services 334. Lastly, update manager 356 uses content publisher 342 to move the static content & services 334 into the proper file location in the file system such that the content server 300 can deliver the static content & services 334 to the mobile devices 104.

FIG. 3C is a block diagram that depicts an example of an implementation of the configuration manager 304 in an embodiment of the invention.

The configuration manager 304 sets and reads a variety of information about the operation of the invention. In the restaurant example above, that information includes (but is not limited to): backup and restore options, external communication settings, waiter names and numbers, wireless settings, schedule of automatic maintenance and upgrades, and viewing of site license info.

FIG. 3D is a block diagram that depicts an example of an implementation of the device manager 306 in an embodiment of the invention.

The primary role of the device manager 306 is to manage the relationship between the on-site server 102, the mobile devices 104, and other devices 316. In a process called “association” where the mobile devices 104 and on-site server 102 exchange information that allows them to communicate with each other. This prevents other mobile devices 104 from interfering with the operation of the invention. At any time the operator, using the device manager 306, may view which mobile devices 104 are associated with the on-site server 102, add or remove associated mobile devices 104 from the list, or associate pagers or other devices 316 with the on-site server 102 for special purposes.

In the restaurant example, special purpose mobile devices 104 could be configured as (but are not limited to) a restaurant manager, wait-staff, chef or hostess device. In an implementation of this, the home page includes a dynamic content handler that looks up the status of mobile devices 104 in data storage 312 and redirects them for that type of device.

FIG. 3E is a block diagram that depicts an example of an implementation of the report manager 308 in an embodiment of the invention.

The report manager 308 consolidates data from the content server log 326 and the data storage 312, and provides an assortment of reports 328. Some of the reports in the restaurant example above are (but are not limited to): number of views of a given page, survey results, wait-staff performance and response times, comparison of performance relative to other locations.

FIG. 3F is a block diagram that depicts an example of an implementation of the system manager 310 in an embodiment of the invention.

The system manager 310 has two primary tasks: the first is to manage the transfer of information between the on-site server 102 and the information center 100, and the second task is to provide operator access to the other applications and modules of the invention which reside on the on-site server 102.

FIG. 3G is a block diagram that depicts an example of an implementation of connection logging on the on-site server 102.

The system manager 310 handles communication between the on-site server 102 and the information center 100. Whenever such communication takes place, the system manager 310 logs the date and time of that connection in the connection log 360.

The connection log 360 is accessed by the on-site server startup application 362 to determine the difference between the startup time and the time of the last connection to the information center 100.

2.3 Mobile Device

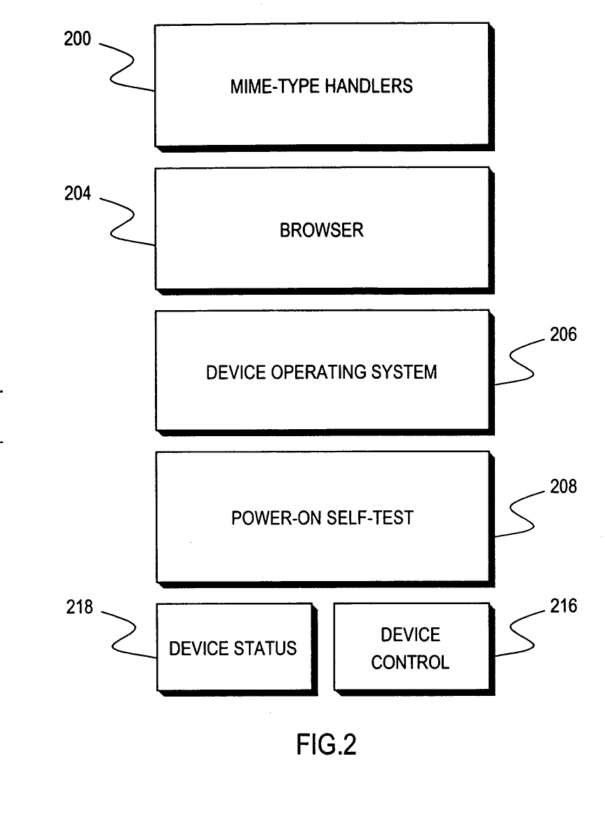

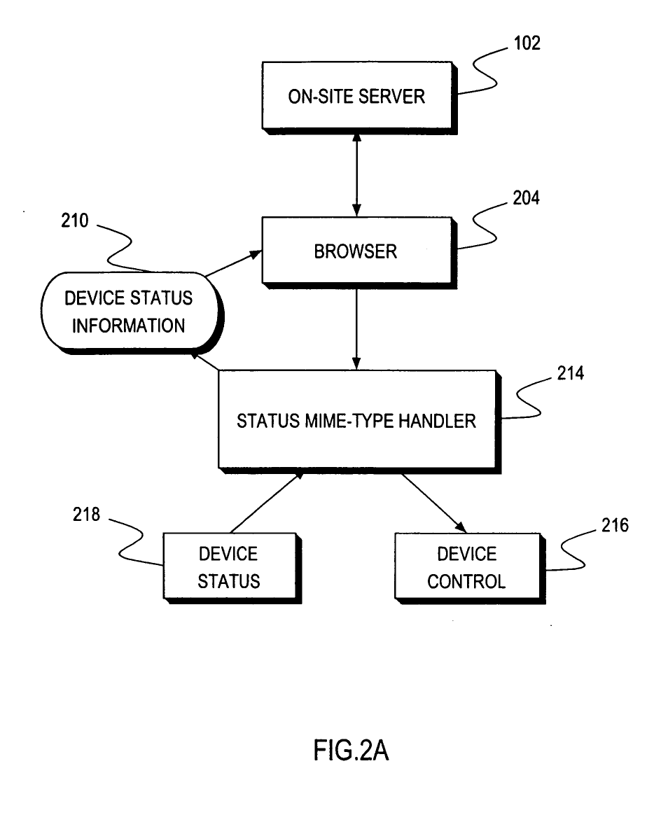

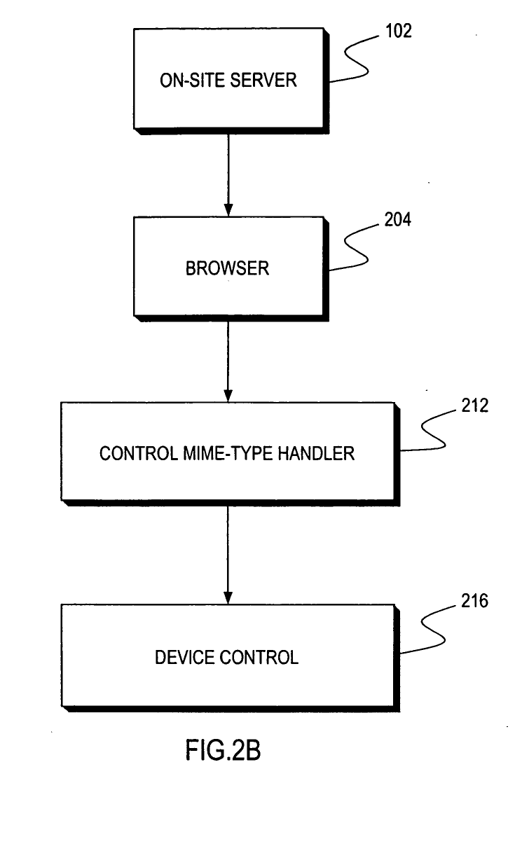

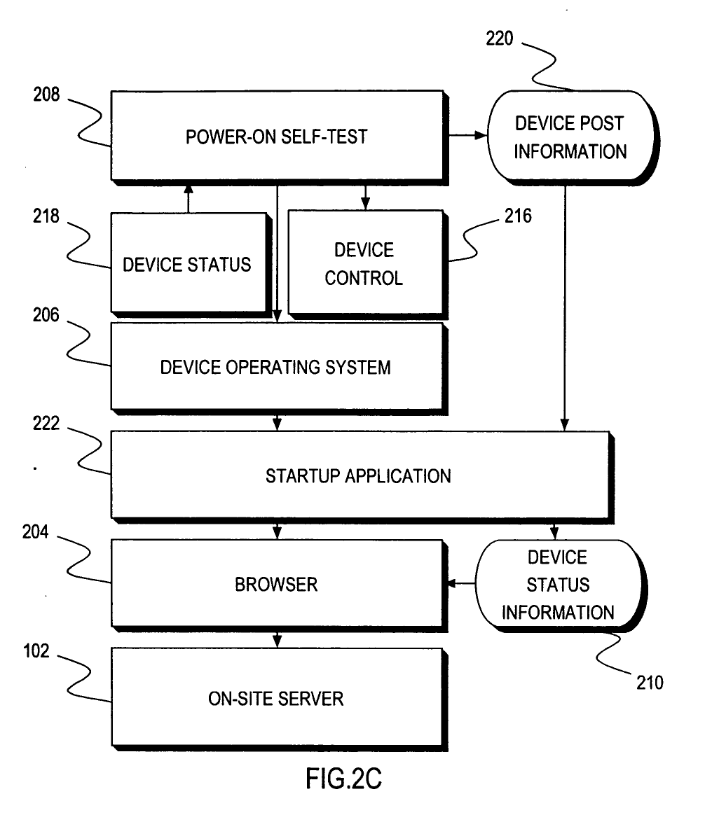

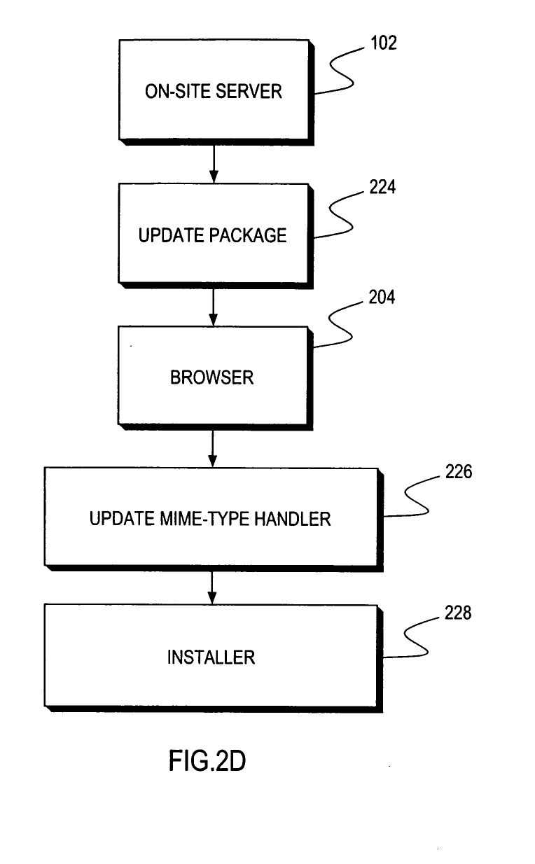

FIG. 2 is a block diagram of an embodiment of the mobile device 104.

FIG. 2A is a block diagram that depicts an example of periodic status checking of the mobile device 104 in an embodiment of the invention.

It is possible for the on-site server 102 to validate the hardware and software status of the mobile devices 104 at periodic intervals. An implementation of how this could be done by using an unseen frame in an HTML web page. The contents of that frame refresh at regular intervals and contain content of a specific file type. The browser 204 of the mobile device 104 would be configured such that the specific file type is handled by the status MIME-type handler 214. The status MIME-type handler 214 would perform diagnostic status checks on the mobile device 104 using the device status 218. The status MIME-type handler 214 would combine that information with the software configuration and version information and writes that to the device status information 210. The browser 204 then returns that information to the on-site server 102 where it is stored in the system status database 406.

If some catastrophic event has been detected during the device status 218 then the status MIME-type handler 214 uses device control 216 to display a message on the mobile device 104, shut the mobile device 104 down, or takes some other action.

FIG. 2B is a block diagram that depicts an example of on-site server 102 initiated control of the mobile device 104 in an embodiment of the invention.

It is possible for the on-site server 102 to control the mobile devices 104 at periodic intervals. An implementation of how this could be done is using an unseen frame in an HTML web page. The contents of that frame refresh at regular intervals and contain content of a specific file type. The browser 204 of the mobile device 104 would be configured such that the specific file type is handled by the control MIME-type handler 212. The control MIME-type handler 212 uses device control 216 to display a message on the mobile device 104, shut the mobile device 104 down or, takes some other action.

FIG. 2C is a block diagram that depicts an example of power-on self-test 208 in an embodiment of the invention.

When the mobile device 104 first powers on it executes a power-on self-test 208. The power-on self-test 208 performs diagnostic status checks on the mobile device 104 using device status 218 and by directly accessing the hardware. It writes the results to device POST information 220. If some catastrophic event has been detected during the power-on self-test 208, then device control 216 is used to display a message on the mobile device 104, shut the mobile device 104 down, or takes some other action. Otherwise, the power-on self-test 208 loads and starts the device operating system 206, which in turn loads and starts the startup application 222. The startup application 222 verifies the version numbers of all files on the mobile device 104 and combines it with the device POST information 220 to create the device status information 210 file. The startup application 222 then loads and starts the browser 204 that then sends the device status information 210 to the on-site server 102 that passes that information on to the information center 100 where it is stored in the system status database 406.

FIG. 2D is a block diagram that depicts an example of how the on-site server 102 updates software components of the mobile device 104 in an embodiment of the invention.

It is possible for the on-site server 102 to initiate an update of software components of the mobile devices 104 at periodic intervals. An implementation of how this could be done is using an unseen frame in an HTML web page. The contents of that frame refresh at regular intervals and contain an update package 224. The browser 204 of the mobile device 104 would be configured such that the update package 224 file type is handled by the update MIME-type handler 226. The update MIME-type handler 226 passes the contents of the update package 224 to the installer 228, which takes care of installing the components of the update package 224, possibly rebooting the mobile device 104 as necessary.

3. Features and Capabilities of the Present Invention

Various features and capabilities of embodiments of the present invention are described in this section. Some of the features and capabilities are described using the example of the restaurant. Implementation of these features will be apparent to persons skilled in the relevant arts, based on the following, and other teachings contained herein. Other features and capabilities of the invention are described in other sections of this application.

User Benefits

1.1) The user can make a service request via the mobile device 104. The user is notified via the mobile device 104 that the service request is being processed.

1.2) The user can view menu, place and view orders, and pay their bill from the table via the mobile device 104.

1.3) The invention enables the user to purchase goods and services at the table using the mobile device 104. These goods and services could be available at the restaurant or from a third party that may be off-site.

1.4) The user can make a future reservation using the mobile device 104.

1.5) The user can create their own, customized views of the menu, for example by sorting the menu items by price, or salt content, or to suppress items that contain allergic ingredients, or other dietary requirements. The menu is dynamic and always up to date (items sold out are grayed out in real time).

1.6) The user can view, via the mobile device 104, content, services and entertainment.

1.7) The user can be supplied user specific data and services (content) in a location based environment (i.e. Frequent diners account information): An embodiment of the invention provides that when the user supplies their name or other identification the invention can supply the user with user-specific content (in the restaurant example, frequent diners account information), in addition the invention can supply services based on that information, debiting the frequent diners account for merchandise or meals or crediting the account for goods purchased. It can also provide information such as but not limited to seating preferences, past meals, ratings of wine or food.

Management Benefits

2.1) The operator has constant (real-time) control of the menu, including daily specials, menu item availability, and pricing; they can also setup time-based (or other factors) control of content (morning menu, happy hour). The menu is dynamic and always up to date (items sold out are grayed out in real-time).

2.2) The system can signal employees: as described above, a number of actions the user can take via the mobile device 104 may result in the employees being signaled to take some action. This may include fetching a receipt, delivering good and services, or responding to some other action by the user. The system automatically signals the appropriate person on the staff who is best able to complete the task at hand.

2.3) The system supports call waiter with dynamic feedback and configurable destinations: the authoring system 302 allows the operator to create new types of service requests or choose from existing ones, and decide which of those are displayed on the mobile device 104. Each type of service request is assigned to a specific job classification. When the user makes a service request via the mobile device 104, the type of request is determined and one of the appropriate employees assigned to the table is alerted via their paging device 116. The user is notified via the mobile device 104 that the service request is being handled.

2.4) The operator can route outstanding tasks to the next employee after a re-assignment: if at the end of their shift an employee is re-assigned and has un-resolved service requests, then the newly assigned employee for that table is alerted with the outstanding requests on their paging device 116.

2.5) The operator can designate special purpose mobile devices (Waiter, Manager, Hostess, etc.): The device manger 306 allows the operator to assign the mobile devices 104 as special purpose devices to be used by the staff. Thereafter, when the mobile device 104 first communicates with the on-site server 102, it is directed to either user or special purpose content accordingly. The wait staff's device may also perform any of the actions that the user's mobile devices can do, allowing the wait staff to efficiently send requests on behalf of the users.

2.6) The system supports a consolidated affinity program and allows redemption of various affinity programs: an embodiment of the present invention allows for the combination of existing affinity programs, such as but not limited to, frequent flyer mileage, and various dining rewards programs, provides the user with a centralized service to view, redeem, and accumulate points across a variety of such programs. For the small restaurant owner, this “levels the playing field”, allowing any business to take full advantage of such programs, thus pulling in new and repeat customers.

2.7) The restaurant manager can be signaled by special events: an embodiment of the present invention would signal the restaurant manager when specific user-related events take place. These may include, but are not limited to: celebrity visits, frequent guests, high-spending guests, or bad survey results. In these cases, the manager is signaled via their paging device 116, and may greet the user, or otherwise address any issues the user may have.

2.8) The system provides training: An embodiment of the present invention would provide training materials to the employees, allowing them to increase their skills, become more familiar with the menu items, and decreasing the load on the restaurant manager for such tasks.

2.9) The system provides real-time feedback: The restaurant manager is able to access a wide variety of information in real-time on employees, survey results, and event response times.

2.10) The system encourages more survey results due to customer ease and fun factor, and automatically collates and provides the data in real-time: the restaurant manager receives significantly more survey results, giving them further insight into the operation of their business and efficiencies of their employees.

2.11) The system collects customer information based on customer menu viewing: The report manager 308 logs every user interaction with the mobile device 104. These logs can be analyzed and viewed by the operator and used to improve the operation of the business.

2.12) The restaurant manager can compare their menus and page views to other similar businesses or best practices: all user interactions with the mobile device 104 are consolidated in the usage database 408 on the information center 100 and this data can be used to compare similar businesses or compared against best practices in the industry. An embodiment of the invention that allowed user ordering could also compare the user interactions with the actual meal ordered.

2.13) The authoring system 302 allows real-time, easy to use configurability of menus that fit the decor of the restaurant. Allows easy customization and publishing to external websites. The authoring system 302 also provides the ability to remove optional content.

2.14) The system provides multi-level templates for controlling content generation: A hierarchy of templates is used to generate web content. This allows for easy customization of the content generated by the Authoring System 302.

2.15) The system provides a JavaScript verifier: Generally, when a page contains faulty JavaScript most browsers will silently fail. The provided JavaScript verifier ensures that any JavaScript contained in the web pages is syntactically correct, preventing problems before they can occur.

2.16) The system provides a new media venue with availability of layout targeted advertisments: the present invention provides for a new advertising venue.

2.17) The system allows contacting (or using information from) users based on time, date and frequent diner name & address. With the combination of the name of the guest and when and where they were in the restaurant, specific things could be done. Targeted advertisments (only those who usually lunch get sent a dinner coupon) or to aid in recovery of lost items.

2.18) The system includes a smart charging/display station 112, an attractive charging station that sits behind/near the hostess that displays advertisements or other content on the mobile device 104 until the mobile device 104 is needed. The power connector also contains a USB port that allows the charging station to communicate with and control the mobile device 104. The intelligence in the charging station allows batteries to be charged quicker and extends battery life.

2.19) The system provides the approximate location or seat orientation of a mobile device 104 by triangularization of the wireless devices 104. The invention allows for measuring the strength, phase and delay of the wireless signals to determine the approximate location of a mobile device 104 or its seat orientation.

Multi-Site Restaurant Benefits

3.1) Support for data movement for multi-site restaurants; the invention allows for a centralized site to download menu updates to any specific set of stores, raw or consolidated data is returned. This allows chains to update menus, perform market tests, introduce new items, or change prices according to market factors, etc, dynamically, with a minimum of effort and virtually no printing costs.

Other Benefits

4.1) The system provides snooping/verifying checksums of wireless mobile devices 104 (against viruses and hacking of mobile devices): The startup application 222 on the mobile device 104 performs a checksum, version numbers of all appropriate system files and sends those to on-site server 102, which compares those with the correct values and takes appropriate action if a discrepancy is discovered.

4.2) The system uses HTTP push via unseen frames. Normally HTTP is a request from client to server. This method gives the ability for the server to force the client to make an HTTP request. This is done with a periodic timer in a hidden HTML frame.

4.3) The system supports a learning mode (association of devices): Association provides a mechanism where mobile device 104 and on-site server 102 can exchange identification information (perhaps while directly connected via a USB or similar cable), without which neither the mobile device 104 nor the on-site server 102 will communicate with the other.

4.4) The system uses control and status MIME type handlers to get information from, and take control of, the mobile devices 104: Generally, MIME handlers are used to “play” content that the browser does not recognize. Generally a web server does not control a client (especially low level hardware). In this method the web server sends a specific file type that invokes either the control MIME-type handler 212 or status MIME-type handler 214. These can then control the mobile device 104 at a low level.

4.5) The system supports hardware drivers generating HTTP events. Generally, the HTTP events are generated by the user's interaction with the browser and not the hardware. The invention enables software that monitors the status of the mobile device 104 and if certain conditions are recognized they are reported back to the on-site server 102 in the form of an http request. The on-site server 102 may then use the control MIME-type handler 212 to display a message on the mobile device 104.

4.6) An embodiment of the invention can limit communication between information center 100 and on-site server 102 or between on-site server 102 and mobile device 104. This may occur if any or all of the following cases: No communication for a predetermined length of time, non-payment of bill, on-site server 102 or mobile device 104 are reported stolen, or a temporary shutdown has been requested. In some cases the devices may shutdown if no communication channel can be established.

4.7) The system provides a three-layer download and update (with real-time diagnostics) and a proactive tech support: Startup and diagnostics information is sent from the mobile device 104 to the on-site server 102 and from the on-site server 102 to the information center 100. At the information center 100 this data can be evaluated and any proactive steps necessary can be taken to rectify any problem situations. The invention supports sending new versions of software and patches from the information center 100 to the on-site server 102 where they are installed or as appropriate sent from the on-site server 102 to the mobile device 104. This ensures that the system remains robust, and hence operational, with a minimum of on-site administration.

4. Operation of the Present Invention

4.1 Setup and Installation

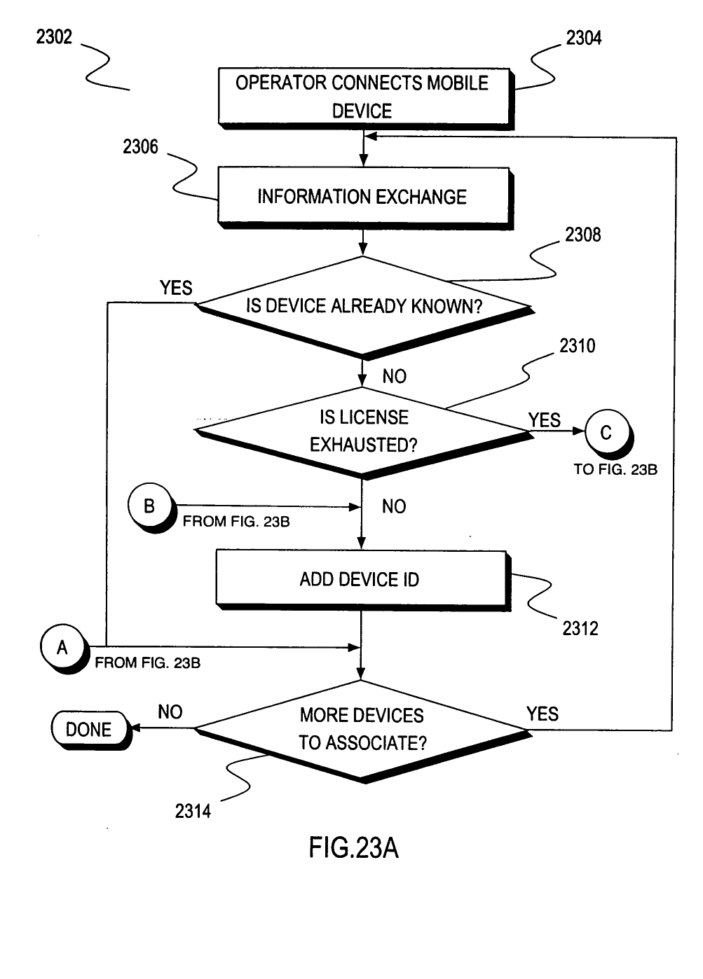

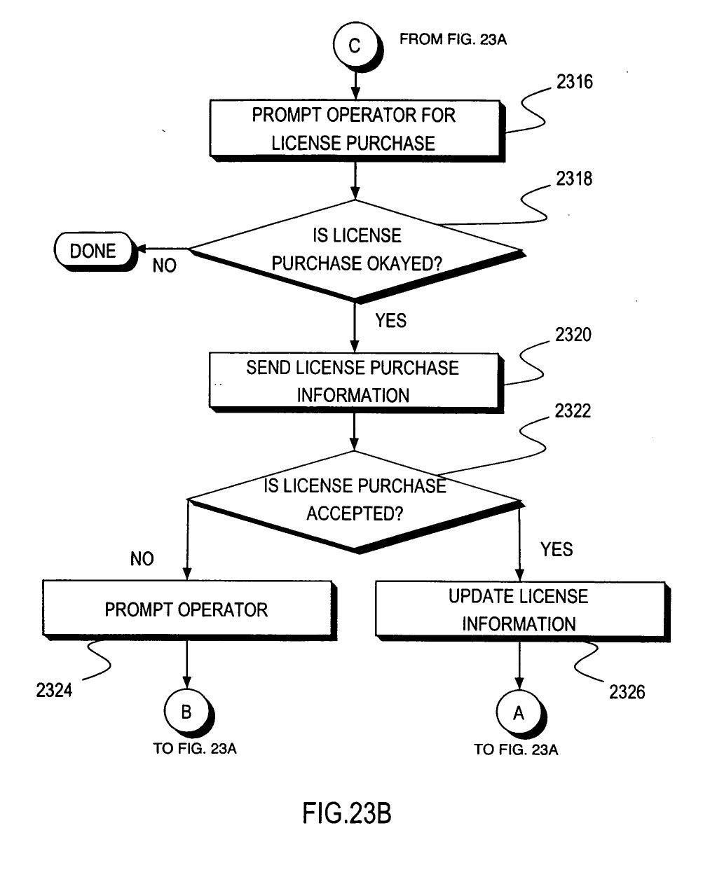

Flowchart 2302, depicted in FIG. 23A-23B, illustrates the manner in which mobile device 104 and on-site server 102 are configured to work with one another. This process, called “association”, ensures that each mobile device 104 only communicates with its associated on-site server 102, and the on-site server 102 only communicates with those mobile devices 104 with which it has been associated.

Referring to FIG. 23A in step 2304 the operator connects the mobile device 104 to the on-site server 102. This connection could be done in any number of ways, for example via a serial or USB (Universal Serial Bus) cable, or via other wired or wireless connections. Once connected, then in step 2306, the on-site server 102 and the mobile device 104 exchange their unique identification.

In step 2308 the on-site server 102, takes the information received from the mobile device 104 and looks in data storage 312 to see if the mobile device 104 is already known. If the device is not found in data storage 312, then in step 2310 the on-site server 102 determines if the license agreement is exhausted. If in step 2310 it is determined that the license is not exhausted, the mobile device 104 is added to the list of known devices (step 2312), and that information is recorded in data storage 312.

In step 2314, the operator determines if they have more mobile devices 104 to associate with the on-site server 102, and if there are, they return to step 2304.

If in step 2308 it is determined that the mobile device 104 is already associated with the on-site server 102, then in step 2314, the operator determines if they have more mobile devices 104 to associate with the on-site server, and if there are, they return to step 2304.

If in step 2310 it is determined that the license is exhausted, then referring to FIG. 23B, in step 2316 the operator is prompted that they need to purchase additional licenses to accommodate additional mobile devices 104. If in step 2318 the operator indicates that they do wish to purchase additional licenses, then in step 2320 the license purchase request is sent to the information center 100. In step 2322, it is determined if the operator's purchase of additional licenses is acceptable. If that purchase is not acceptable, then in step 2324 that information is displayed to the operator. Referring to FIG. 23A, in step 2314, the operator determines if they have more mobile devices 104 to associate with the on-site server 102, and if there are, they return to step 2304.

If in step 2322 it is determined that the purchase of additional licenses is acceptable, then in step 2326, the updated license information is stored on both the information center 100 and the on-site server 102. Referring to FIG. 23A, in step 2314, the operator determines if they have more mobile devices 104 to associate with the on-site server 102, and if there are, they return to step 2304.

4.2 Operator Operations

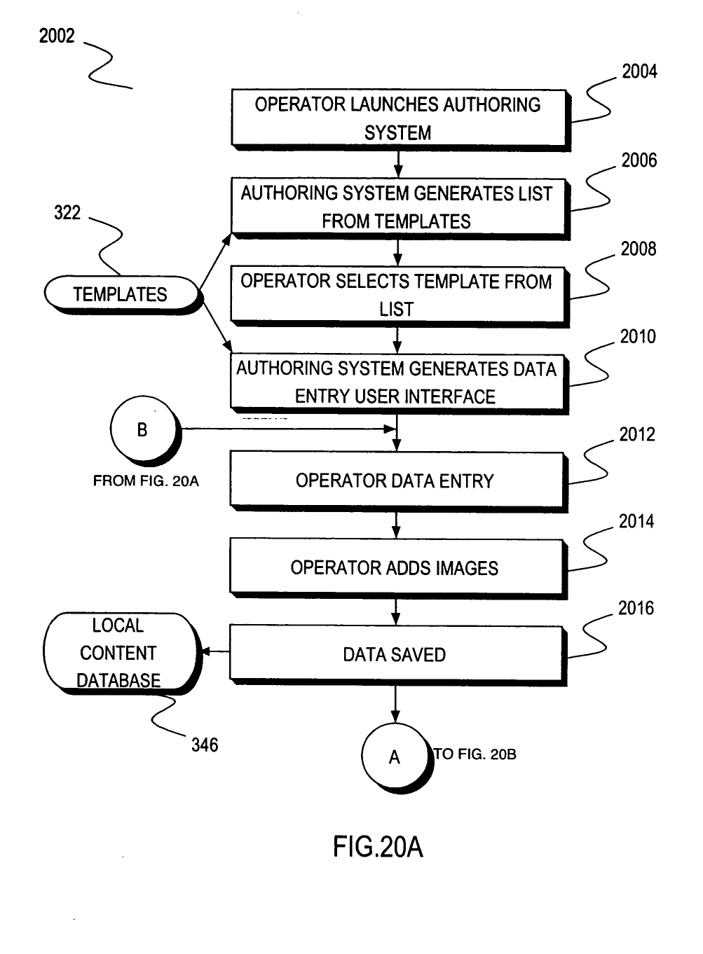

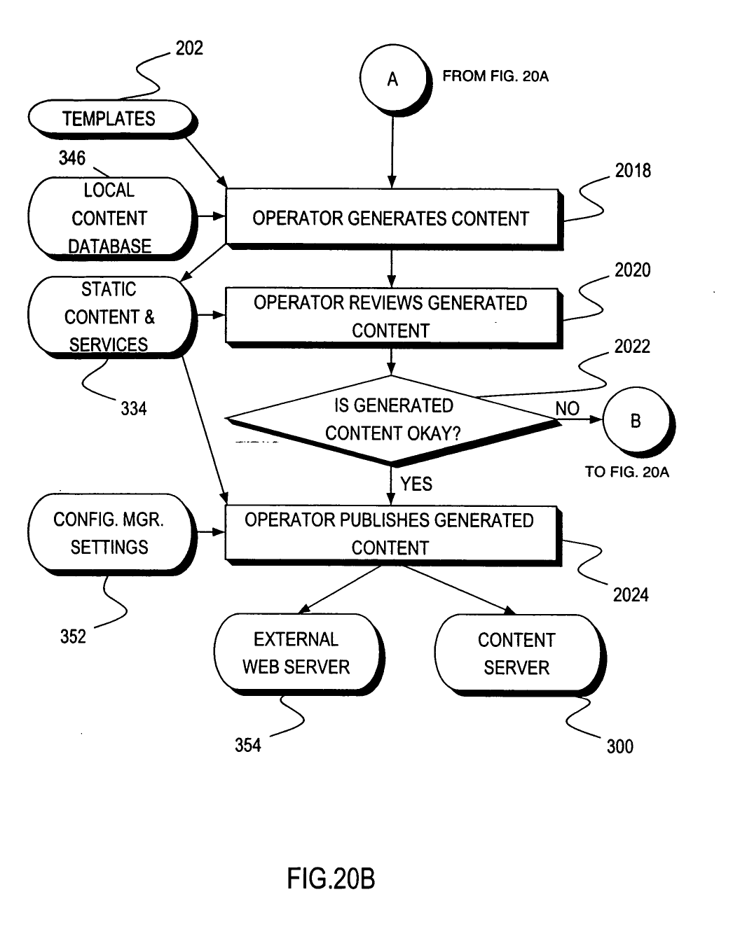

Flowchart 2002, depicted in FIGS. 20A-20B, illustrates the manner in which the operator can use the authoring system 302 to create static content and services 334.

Referring to FIG. 20A, in step 2004, the operator launches the authoring system 302, which in step 2006, searches for the templates 322, and displays a list of the templates 322 to the operator. In step 2008, the operator chooses one of the templates 322 from which the static content & services 334 will be generated.

Once the operator has chosen a template 322, the authoring system 302 uses data entry & modification 338 to create a user interface based upon the fields contained in the template 322, as shown in step 2010. The operator then, in step 2012 performs data entry 348 to create as many records as they wish. They may also, in step 2014, add image files 350 to the authoring system 302. In the case of the restaurant example, these may be images of the various dishes the restaurant serves, and the operator interacts with the authoring system 302 to associate these image files 350, as appropriate. In steps 2012 and 2014, the authoring system 302 utilizes data entry & modification 338 to accomplish these tasks.

Once the operator has completed data entry 348 and adding image files 350, the operator saves it as the local content database 346 in step 2016. At that time, the authoring system 302 uses data storage and retrieval 336 to save the content database 346. In subsequent uses of the authoring system 302, the operator may choose to have the authoring system 302 read the local content database 346 back in; at such time the authoring system 302 uses data storage & retrieval 336 to re-read the local content database 346.

Referring to FIG. 20B, in step 2018, the operator uses the authoring system 302 to generate static content and services 334. In doing so, the authoring system 302 uses data storage and retrieval 336 to read third party content 344 and local content database 346. The authoring system 302 then uses content generator 340, which creates the static content & services 334 according to the rules that are contained in the chosen template 322.

Once the static content & services 334 has been generated, the operator may view the results via a web browser in step 2020. If the operator determines in step 2022 that the contents need further work, then they return to step 2012, contained in FIG. 20A, where they can use the authoring system 302 to make any changes needed.

If in step 2022 the operator decides that the static content & services 334 are acceptable, then in step 2024 they have the authoring system 302 publish the static content & services 334. The authoring system 302 uses content publisher 342 to move the static content & services 334 such that it can be viewed by the outside world. Primarily, static content & services 334 is moved to the proper file location in the file system such that the content server 300 will provide that content to the mobile devices 104. In addition, content publisher 342 may read in configuration manager settings 352 that describe where the static content & services 334 can be moved to an external web server 354.

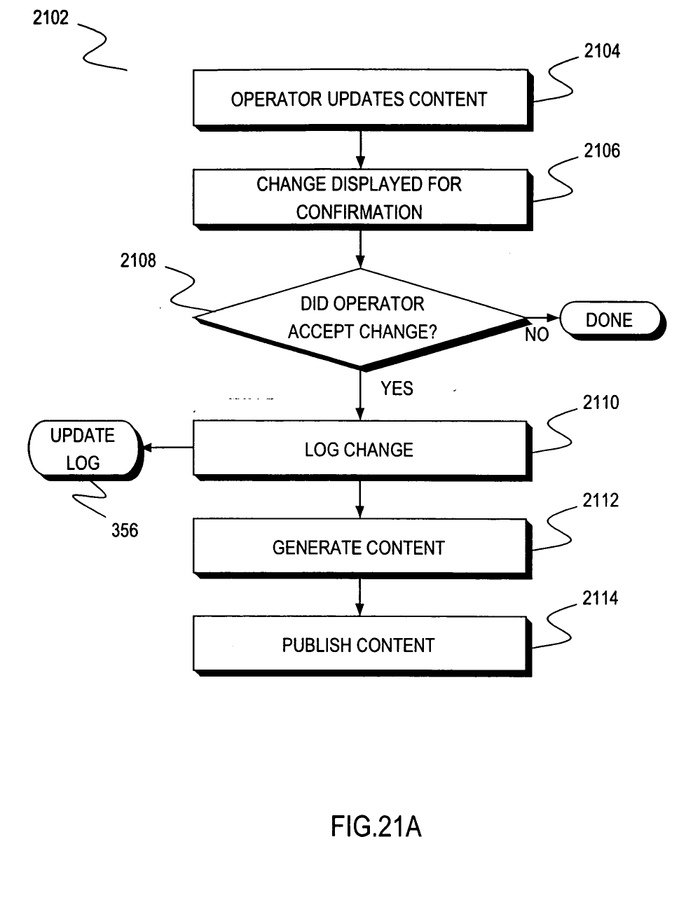

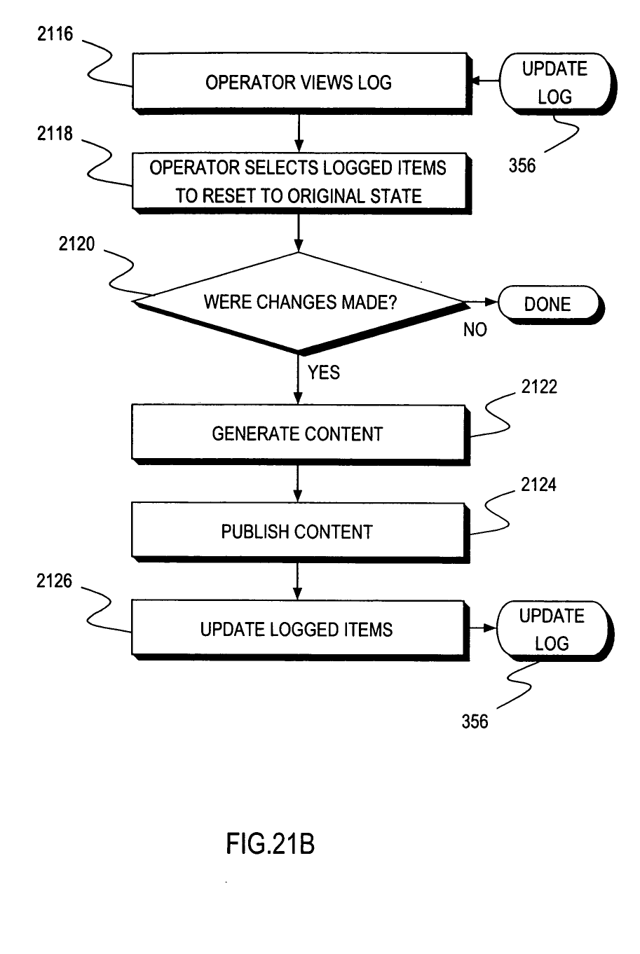

Flowchart 2102, depicted in FIGS. 21A-21B, illustrates the manner in which the operator can publish temporary changes to the static content and services 334, and return those changes to their original state at a later time.

Referring to FIG. 21A, in step 2104, the operator enters temporary updates to the content; this may be done via their mobile device 104, or from the authoring system 302 on the on-site server 102. In the restaurant example above, the operator may be the chef in the kitchen who wants to indicate that an item has been sold out; the operator could also be the restaurant manager, who wants to reduce a price in order to increase sales of a particular item.

Once the changes have been entered, then in step 2106 the operator is presented with a list of the changes made, and is asked to confirm those changes. If, in step 2108 the operator accepts these changes, then in step 2110 the changes are recorded by the authoring system 302, using update manager 356, in the update log 356.

In step 2112, the authoring system 302 uses content generator 340 to create the static content & services 334. In step 2114, the authoring system 302 uses content publisher 342 to move the static content & services 334 to the proper file location in the file system such that the content server 300 will provide that content to the mobile devices 104. In addition, content publisher 342 may read in configuration manager settings 352 that describe where the static content & services 324 can be moved to an external web server 354.

FIG. 21B depicts the steps whereby the operator may return the static content & services 334, to its original state. In step 2116, the operator views the update log 356 which shows the changes that have been made to the static content & services 334. In step 2118, the operator selects any or all of the logged items they want to reset to their original state. When they are done, then in step 2120, it is determined if any items are to be reset. If there are, then in step 2122, the authoring system 302 uses content generator 340 to create the static content & services 334. In step 2124, the authoring system 302 uses content publisher 342 to move the static content & services 334 to the proper file location in the file system such that the content server 300 will provide that content to the mobile devices 104. In addition, content publisher 342 may read in configuration manager settings 352 that describe where the static content & services 324 can be moved to an external web server 354.

In step 2126 the authoring system 302, using update manager 356, removes the items that were reset from the update log 356.

4.3 User Operations

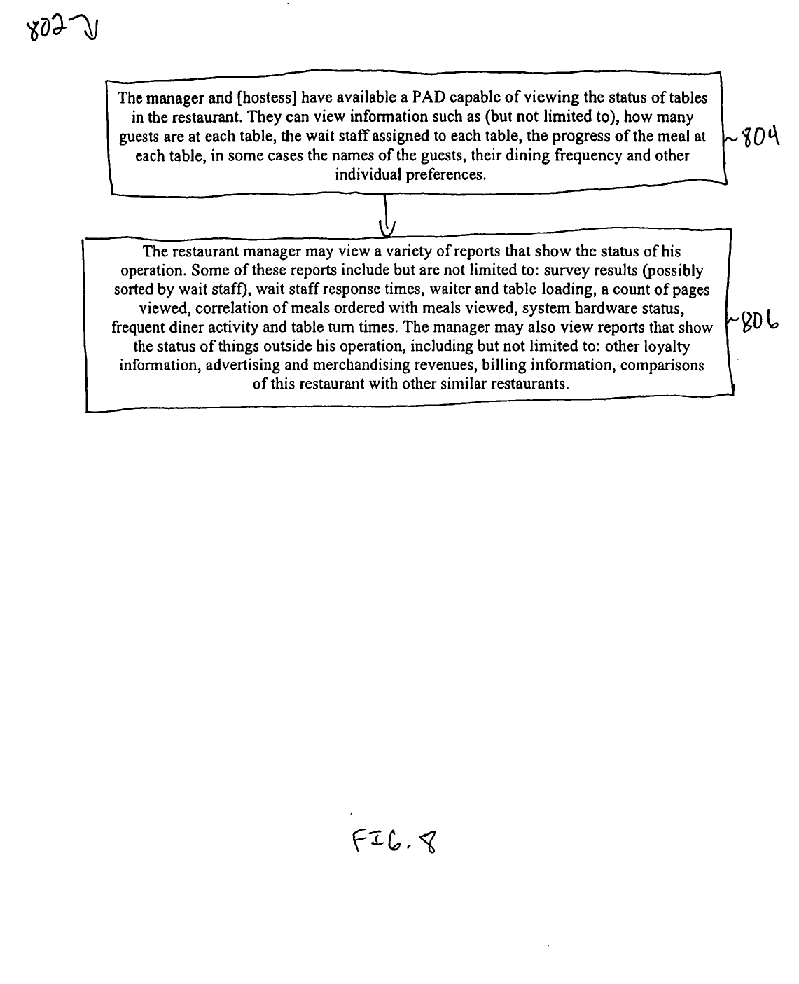

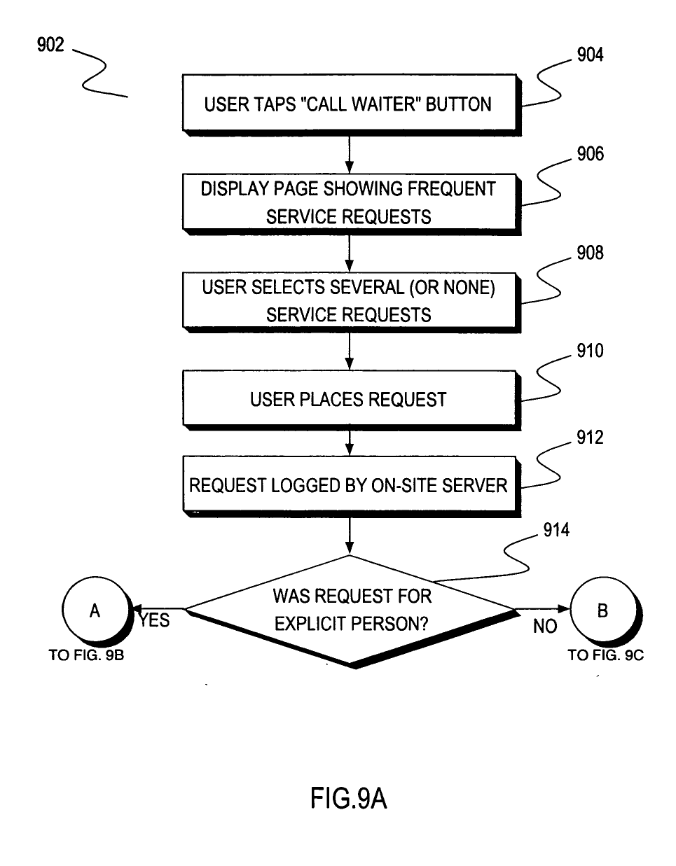

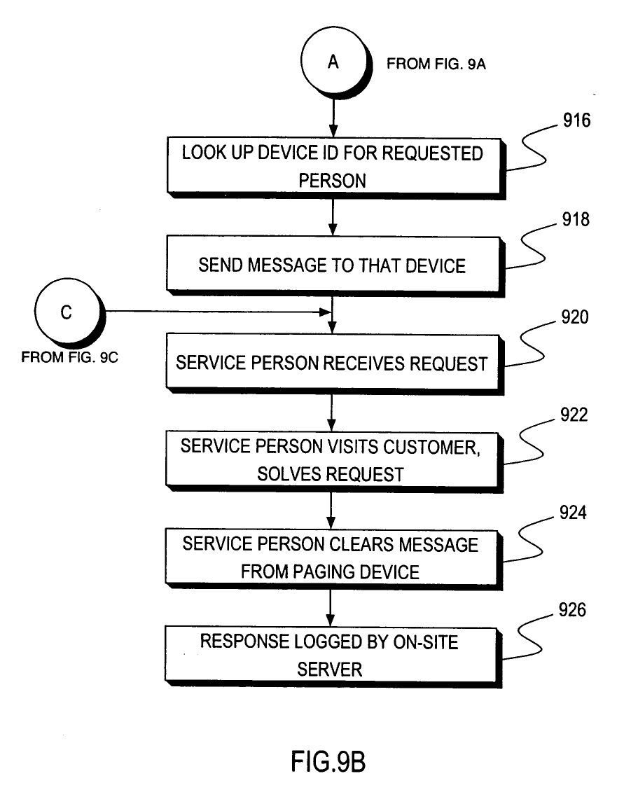

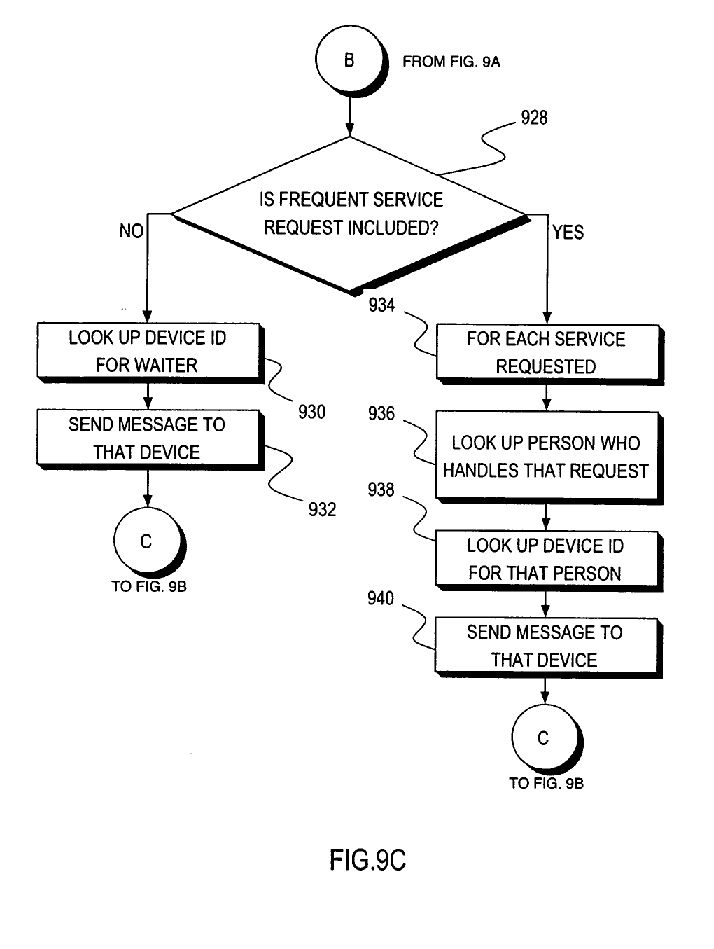

The invention shall be additionally described by the way the user operation in various scenarios, which are depicted in FIGS. 9-15. In particular, FIGS. 9-15 collectively illustrate the operation of the invention from a customer's point of view. The following is described in the context of a restaurant, where the customer (also called the user or guest in the following) is a diner in the restaurant. However, this restaurant application is provided for illustrative purposes only, and is not limiting. Note, also, that each of the FIGS. 9-15 illustrates a single thread of operation. These example threads are provided for illustrative purposes only, and are not limiting. The invention's functionality and user interface is powerful and varied and, as such, the operability of the invention is far greater than that shown in FIGS. 9-15. For example, the steps in the each of flowcharts shown in FIGS. 9-15 can be performed in substantially any order, and most if not all of the steps shown in FIGS. 9-15 are optional. The threads taken by different customers (or the same customer on different visits) will reflect the different dining experiences of the customers.

Turning first to flowchart 902, depicted in FIGS. 9A-9C, illustrates the manner in which a user may place a service request. The user presses the “Call Waiter” button (step 904) on the mobile device 104. This button may be a physical button or a logical button (an area on the touch sensitive display of the mobile device 104) whose appearance, location and presence are configurable by the operator using the authoring system 302 running on the on-site server 102.

As represented by step 906, after the “Call Waiter” button has been pressed a page is displayed on the mobile device 104 containing a number of logical buttons that each represent a common service request, in the restaurant example they could be “Bring the Bill” or “Coffee Refill”. The text, meaning, number of, and appearance of these buttons is configurable by the operator using the authoring system 302 running on the on-site server 102. Also on the page is a button to place the request and perhaps buttons to call specific people (for example the restaurant manager, the hostess, or the chef).

In step 908, the user may select as many or as few of the service request buttons as they desire. In step 910, the user places the request by pressing on the “Call Waiter” or calls a specific person by pressing on one of the other buttons described above.

The request is returned to the content server 300 on the on-site server 102, where it is passed on to a dynamic content and services handler 314. This handler logs the request in step 912. The information logged includes, but is not limited to, the nature of the request(s), the time the request(s) were placed and the table number to which the mobile device 104 has been assigned.

In step 914, if the dynamic content and services handler 314 determines that the request is for a specific service person then the handler looks up the paging device 116 assigned to that particular person (Referring to FIG. 9B, in step 916), and sends a message to that paging device 116, in step 918.

In step 920, the service person receives the request(s), and they perform the requested service and may visit the user at the table if needed (step 922). In step 924, the service person clears the request, which has been completed, from his paging device 116 which causes the dynamic content and services handler 314 to update the information logged, in step 926, to show the time it was completed and by whom.

If in step 914 the dynamic content and services handler 314 determines that the request is not for a specific person, then (referring to FIG. 9C in step 928) the handler determines if the request includes one of the frequent service requests and if so, in step 934, for each of the service requests selected, the handler looks up the service person responsible for each request (step 936) then looks up the device ID for that service person (step 938) and sends a message to that paging device 116 (step 940). The service person receives the request and handles it in the same fashion as in steps 920-926.

If in step 928 it is determined that the request does not include one of the frequent service requests then the handler looks up the device ID for the waitperson assigned to the table (step 930) and sends a message to that paging device 116 (step 932). The waitperson receives the request and handles it in the same fashion as in steps 920-926.

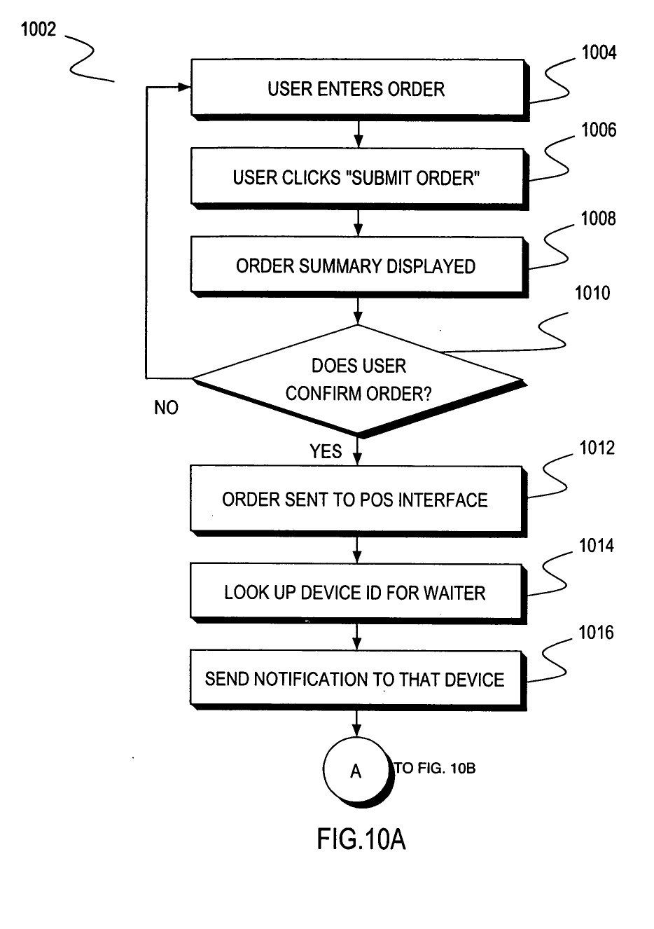

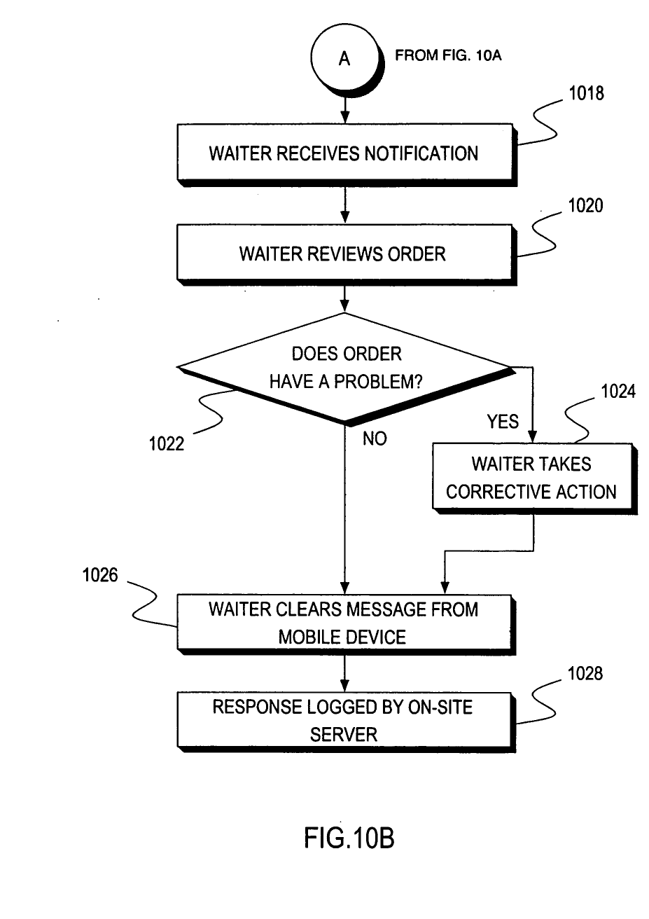

Flowchart 1002, depicted in FIGS. 10A-10B, illustrates the manner in which a user may place their order in the restaurant example above. Each user can select the items they wish to order in step 1004; if desired, one user in a multi-user table may choose to place all of the orders for that table. In an embodiment, as the user(s) selects items, a running total of calories or Weight Watcher points (or some other metric) is displayed. In some embodiments, the users can also at this time specify the order in which they wish dishes to be served. When the order is deemed to be complete and correct, the user presses the “Submit Order” button in step 1006. The content server 300 on the on-site server 102, receives the order information, and passes it on to a dynamic content and services handler 314. This handler (in step 1008) creates a summary page of the items ordered and their cost, and returns that to the content server 300 for display on the mobile device 104.

In step 1010, the user has an opportunity to review the order. If the user does not accept the order, then they are returned to step 1004 in which they may edit their order as necessary. If the user accepts the order in step 1010, then that confirmation is sent to the content server 300 on the on-site server 102, which passes it on to a dynamic content and services handler 314.

In step 1012, the dynamic content and services handler 314 enters the order into the POS system (one of the other devices 316). In an alternate implementation the order could be printed at a central location and either delivered to the kitchen or entered into the POS system manually. In step 1014, the handler looks up the device ID for the waitperson assigned to that table, and in step 1016 sends a message to that paging device 116 alerting the waitperson that an order has been placed. Referring to FIG. 10B, in step 1018, the waiter receives the order placed notification. In step 1022, the waitperson reviews the order, probably via the user interface of the POS system, and determines if there is a problem. Problems detected may include, but are not limited to, inappropriate quantities, or items ordered at inappropriate times).

If a problem has been detected, the waitperson takes appropriate steps to correct the problem, step 1024. These may include, but are not limited to, deleting the order from the POS system, modifying the order via the POS system, or visiting the table and talking with the users to determine their intentions.

In either case, once the order is deemed to be acceptable, then in step 1026, the waitperson clears the message from his paging device 116, causing, in step 1028, the dynamic content and services handler 314 to update the information logged to show the time it was completed and by whom.

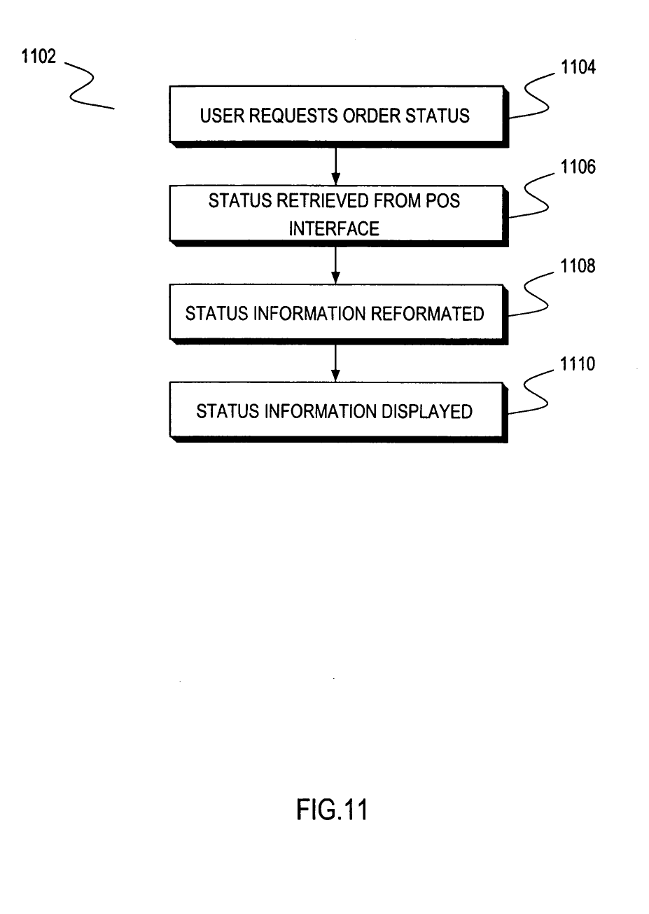

Flowchart 1102, depicted in FIG. 11, illustrates the manner in which a user may see the status of their food and/or drink order or their current bill in the restaurant example above. After the “Order Status” button has been pressed (step 1104) the content server 300 on the on-site server 102, passes a request on to a dynamic content and services handler 314. This handler (step 1106) retrieves the order status information for this table from the POS system (one of the other devices 316). In step 1108 the handler reformats the information it receives that is then passed to the content server 300 for display on the mobile device 104 (step 1110).

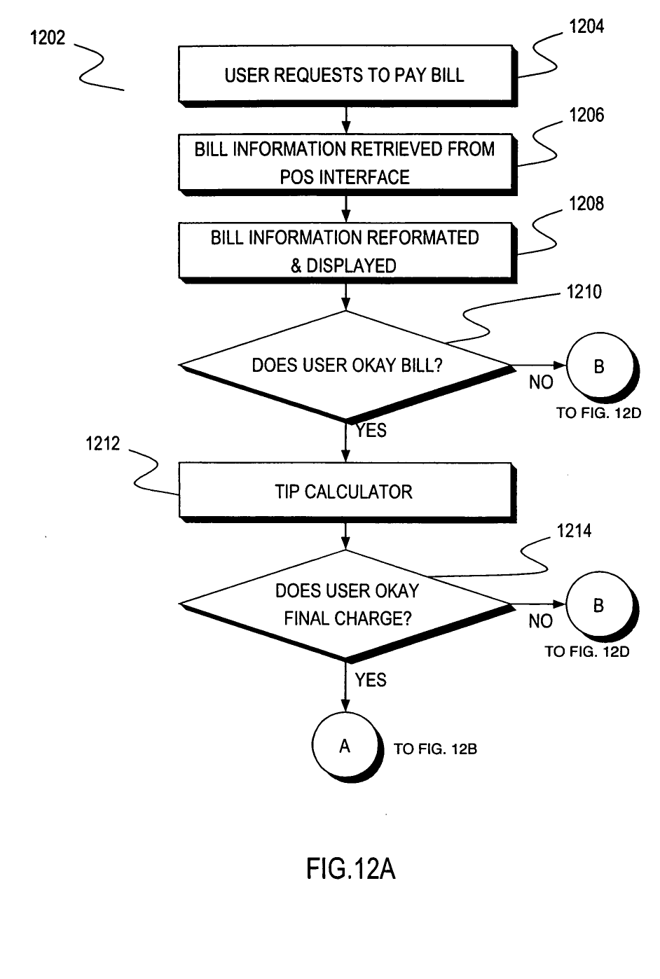

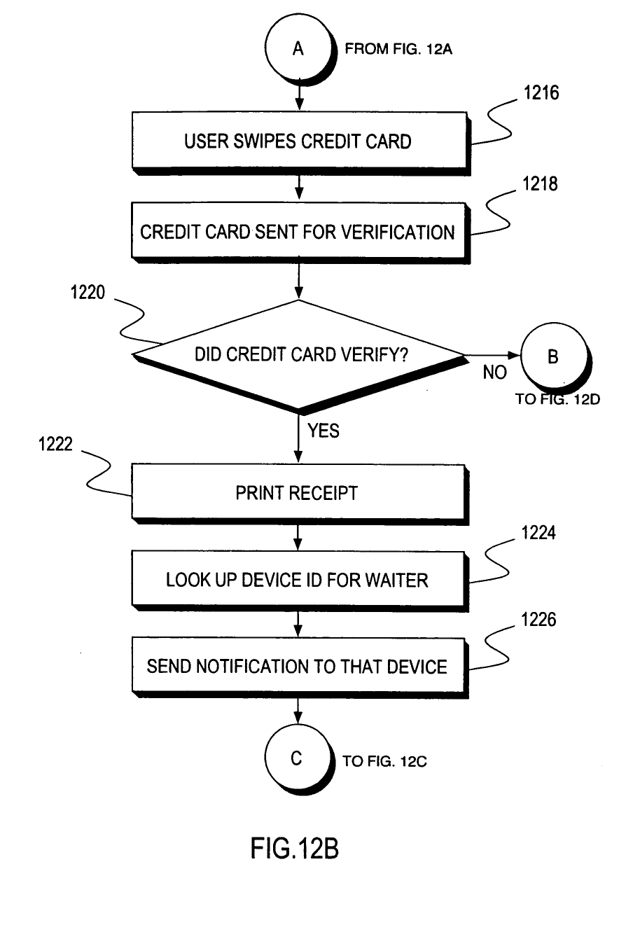

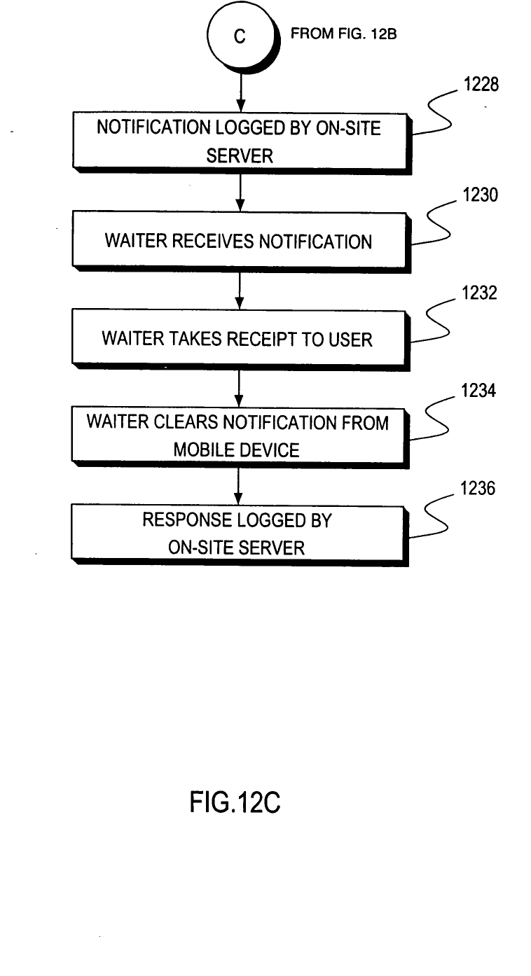

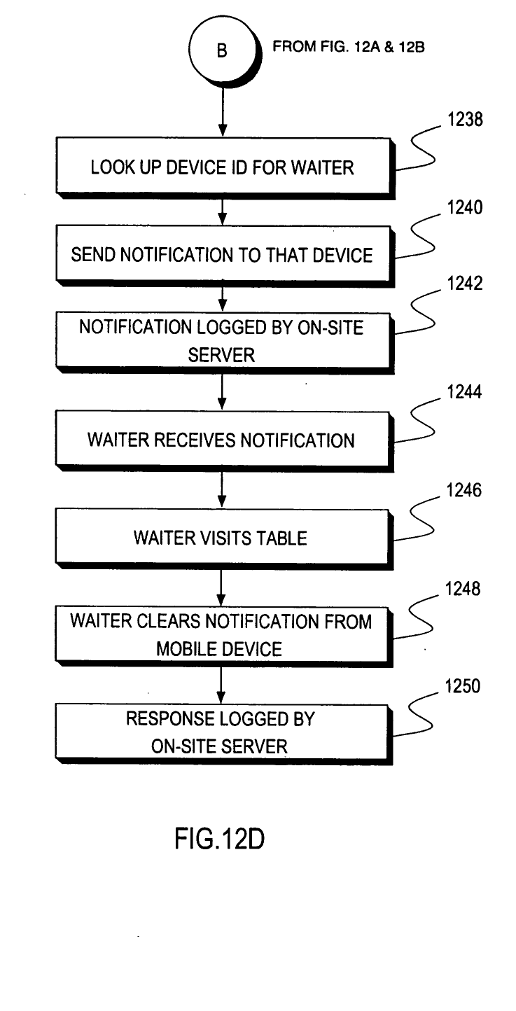

Flowchart 1202, depicted in FIGS. 12A-12D, illustrates the manner in which a user may pay their bill in the restaurant example above. After the “Pay Bill” button has been pressed (referring to FIG. 12A step 1204) the content server 300 on the on-site server 102, passes a request on to a dynamic content and services handler 314. This handler (step 1206) retrieves the billing information for this table from the POS system (one of the other devices 316).

In step 1208, the handler reformats the information it receives which is then passed to the content server 300 for display on the mobile device 104. In step 1210 the user has an opportunity to approve the bill. If the user accepts the bill then the tip calculator (step 1212) is displayed on the mobile device 104. The tip calculator allows the user to select a standardized tip amount based on their bill or to enter any other amount. In step 1214, the tip amount is added to the bill total and the user has a chance to confirm the total.

If the user accepts the bill then (referring to FIG. 12B in step 1216) they swipe their credit card through a magnetic strip reader on the mobile device 104. In step 1218 their credit card information is passed to the content server 300 on the on-site server 102, which passes that information on to a dynamic content and services handler 314. This handler sends the credit card information (such as but not limited to amount, date, time and merchant number) to a credit card clearing center to be paid. If in step 1220, the charge clears then in step 1222 a receipt is printed. Any and all receipts not yet printed for merchandise bought or services rendered are printed at this time. The handler looks up the device ID for the waitperson assigned to the table (step 1224) and sends a message to that device (step 1226).

Referring to FIG. 12C in step 1228, that receipt printed message is logged by the dynamic content and services handler 314. In step 1230, the waitperson receives the message and in step 1232 they bring the receipt to the user. In step 1234, the waitperson clears the message from his paging device 116 that causes the dynamic content and services handler 314 to update the information logged, in step 1236, to show the time it was completed and by whom.

Referring to FIG. 12A, if in step 1210 the user did not OK the bill or in step 1214 the user did not confirm the final charge, or if in step 1220 the credit card did not verify then (referring to FIG. 12D in step 1238), the handler looks up the device ID for the waitperson assigned to the table and sends a problem message to that device (step 1240). That message is logged by the dynamic content and services handler 314 (step 1242) and the waitperson receives the message and in step 1244. In step 1246, the waitperson visits the table to resolve the issue. In step 1248, the waitperson after resolving the problem clears the message from his paging device 116 which causes the dynamic content and services handler 314 to update the information logged, in step 1250, to show the time it was completed and by whom.

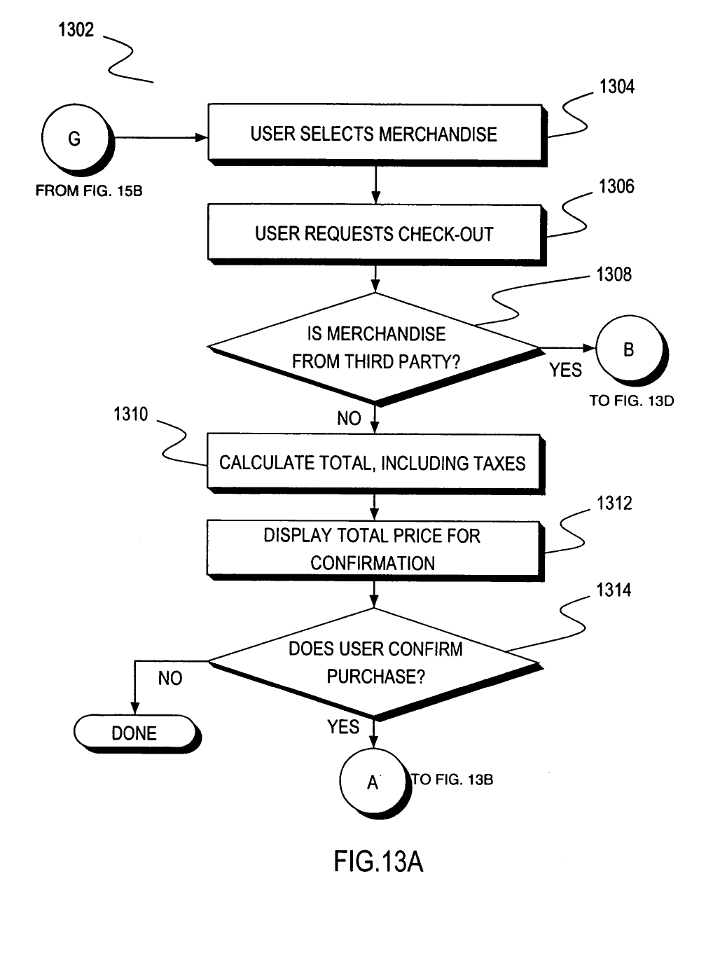

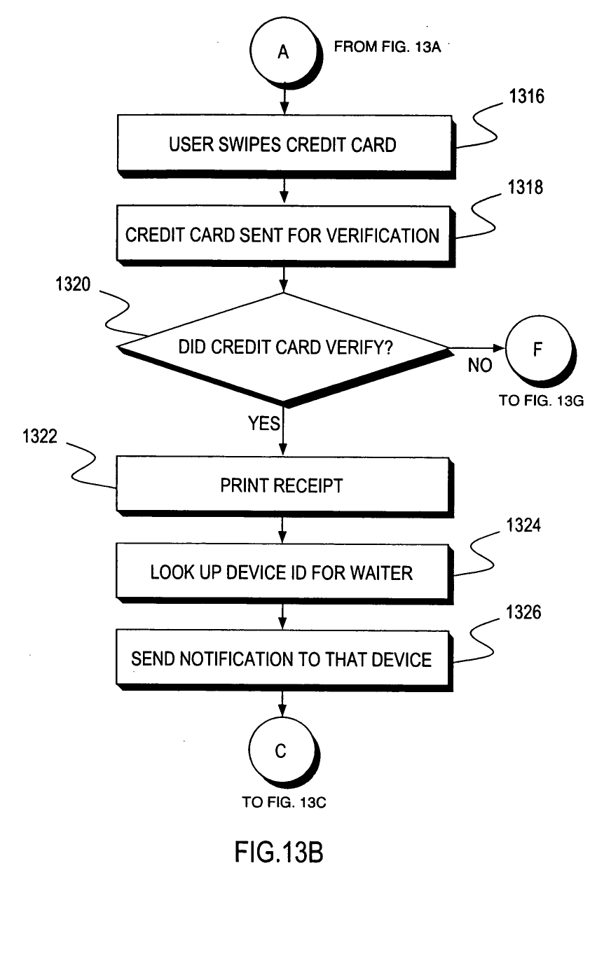

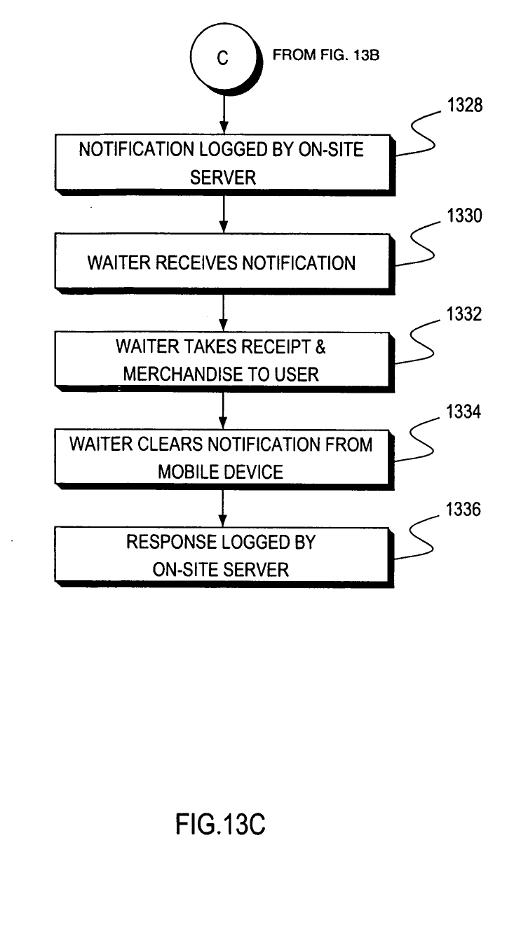

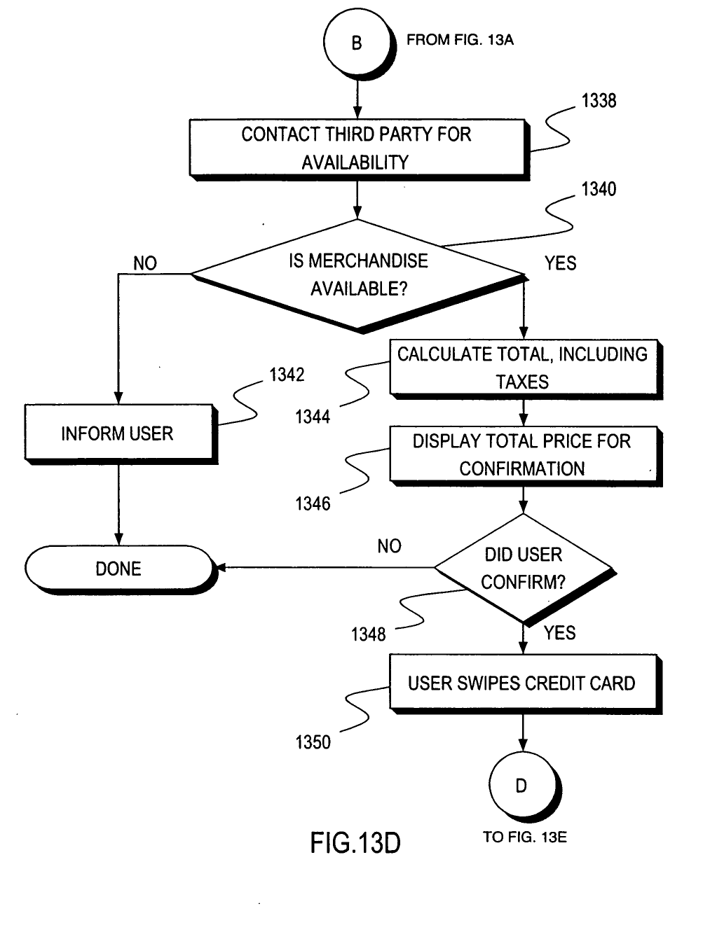

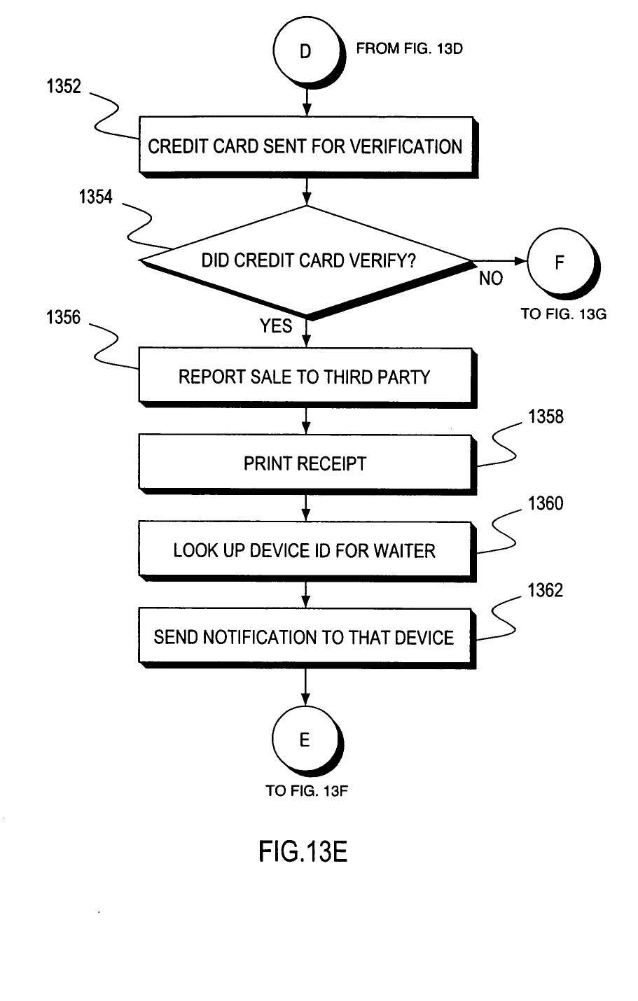

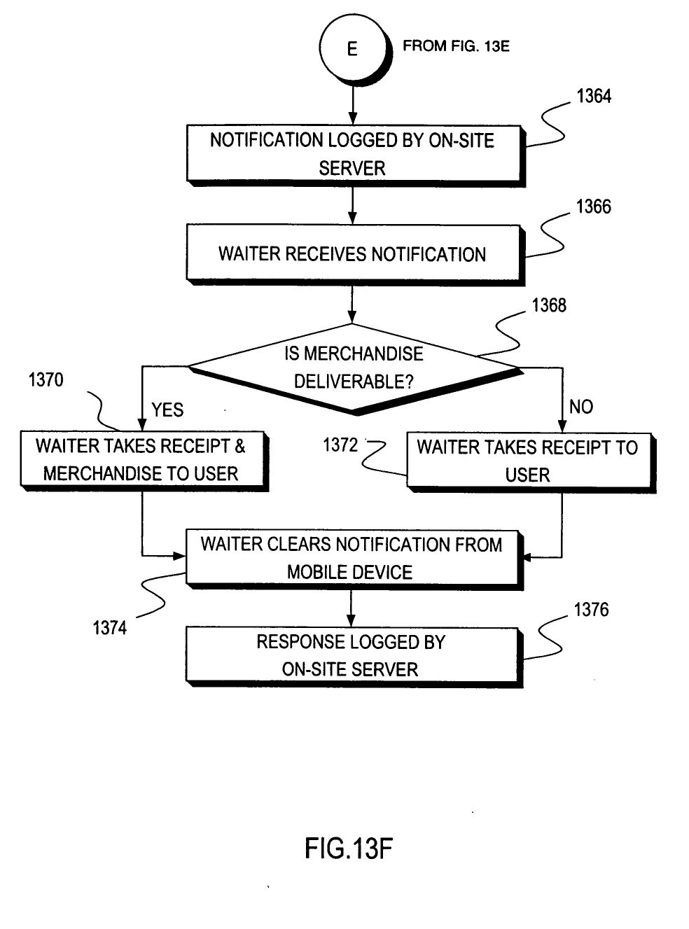

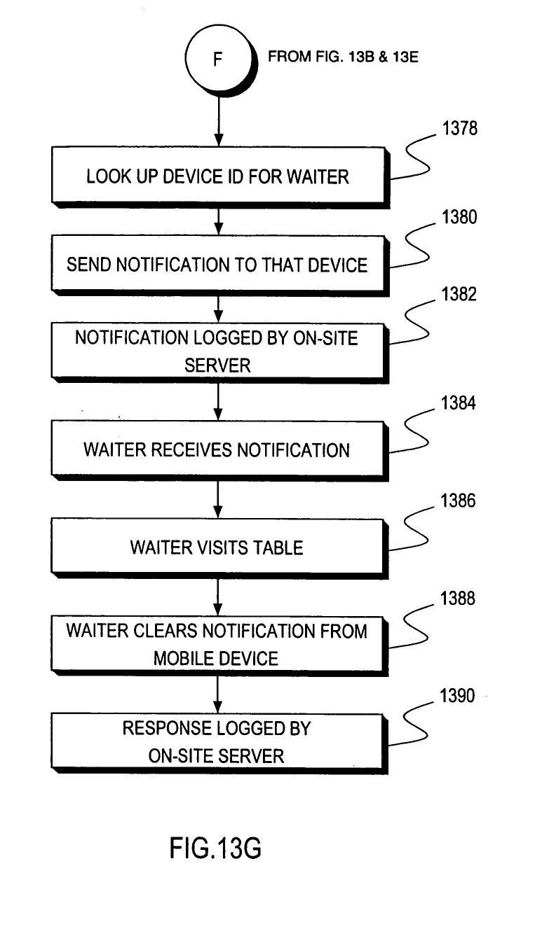

Flowchart 1302, depicted in FIGS. 13A-13G, illustrates the manner in which a user may purchase merchandise in the restaurant example above. Referring to FIG. 13A step 1304, after the user has selected their merchandise, indicating such information as, but not limited to, size, quantity, color of said merchandise; the user indicates that they are finished shopping by pressing the “Check-Out” button in step 1306. That request is received by the content server 300 on the on-site server 102, which passes the request on to a dynamic content and services handler 314. This handler determines if the merchandise is from a third party 404 as opposed to merchandise available at the restaurant itself in step 1308. If the merchandise is at the restaurant, then in step 1310 then a total is calculated including any applicable taxes, and in step 1312 this total is displayed on the mobile device 104 for confirmation.

If in step 1314 the user confirms the purchase then referring to FIG. 13B, in step 1316 the user swipes their credit card through a magnetic strip reader on the mobile device 104. In step 1318, the credit card information is passed to the content server 300 on the on-site server 102, which passes that information on to a dynamic content and services handler 314. This handler sends the credit card information (such as but not limited to amount, date, time and merchant number) to a credit card clearing center to be paid. If in step 1320 the charge clears, then in step 1322 a receipt is printed. The handler looks up the device ID for the waitperson assigned to the table (step 1324) and sends a message to that paging device 116 (step 1326).

Referring to FIG. 13C in step 1328, that receipt printed message is logged by the dynamic content and services handler 314. In step 1330, the waitperson receives the message and in step 1332 they bring the receipt and merchandise to the user. In step 1334, the waitperson clears the message from his paging device 116 that causes the dynamic content and services handler 314 to update the information logged, in step 1336, to show the time it was completed and by whom.

If in step 1308 the dynamic content and services handler 314 determines that the merchandise is from a third party 404 then in referring to FIG. 13D in step 1338, the handler contacts the third party 404 and verifies merchandise availability. If in step 1340 the merchandise is not available, then in step 1342 a page is displayed on the mobile device 104 informing the user that the requested merchandise is unavailable. If the merchandise is available, then in step 1344 then a total is calculated including any applicable taxes, and in step 1346 this total is displayed on the mobile device 104 for confirmation. If in step 1348 the user confirms the purchase then in step 1350 they swipe their credit card through a magnetic strip reader on the mobile device 104.

Referring to FIG. 13E in step 1352, their credit card information is passed to the content server 300 on the on-site server 102, which passes that information on to a dynamic content and services handler 314, which in turn sends the credit card information (such as but not limited to amount, date, time and merchant number) to a credit card clearing center to be paid. If in step 1354 the charge clears, then in step 1356 the third party 404 is notified of the sale, and in step 1358 a receipt is printed. The handler looks up the device ID for the waitperson assigned to the table in step 1360, and sends a message to that paging device 116 (step 1362).

Referring to FIG. 13F in step 1364, that receipt printed message is logged by the dynamic content and services handler 314. In step 1366, the waitperson receives the message. In step 1368, the waitperson determines if the merchandise is deliverable; non-deliverable merchandise may include, but is not limited to, merchandise that is shipped from the third party directly to the user, or is to be picked up by the user at some other location. If the merchandise is deliverable, then is step 1370 the waitperson delivers both the receipt and the merchandise to the user. If the merchandise is not deliverable, then in step 1372 the waitperson delivers the receipt to the user. In step 1374, the waitperson clears the message from his paging device 116 that causes the dynamic content and services handler 314 to update the information logged, in step 1376, to show the time it was completed and by whom.

If in step 1320 or in step 1354 the credit card did not verify then (referring to FIG. 13G in step 1378), the dynamic content and services handler 314 looks up the device ID for the waitperson assigned to the table and sends a problem message to that paging device 116 (step 1380). The dynamic content and services handler 314 logs the message (step 1382) and the waitperson receives the message in step 1384. In step 1386, the waitperson visits the table to resolve the issue. In step 1388, the waitperson after resolving the problem, clears the message from his paging device 116 which causes the dynamic content and services handler 314 to update the information logged, in step 1390, to show the time it was completed and by whom.

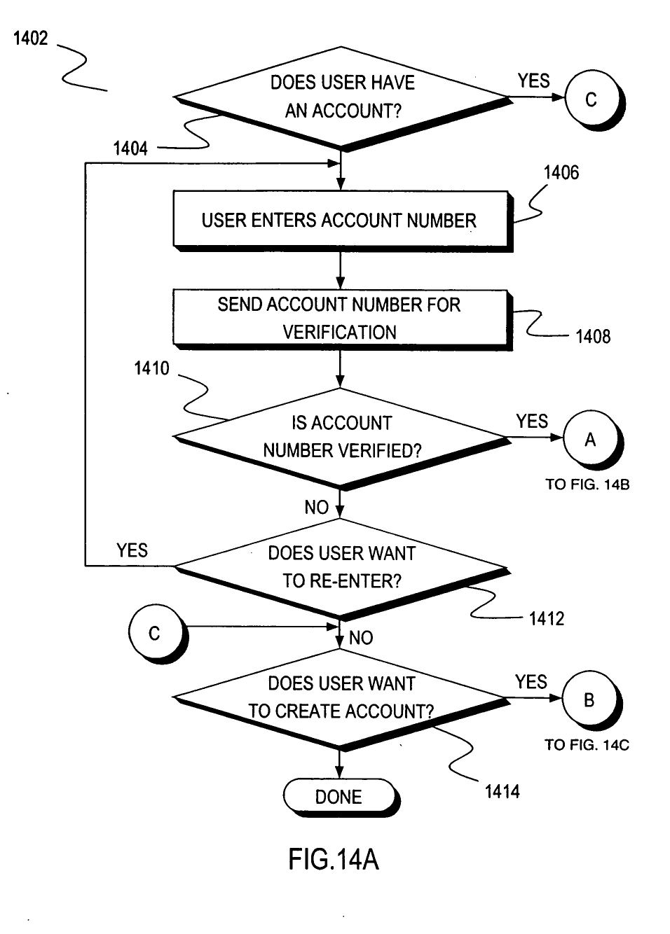

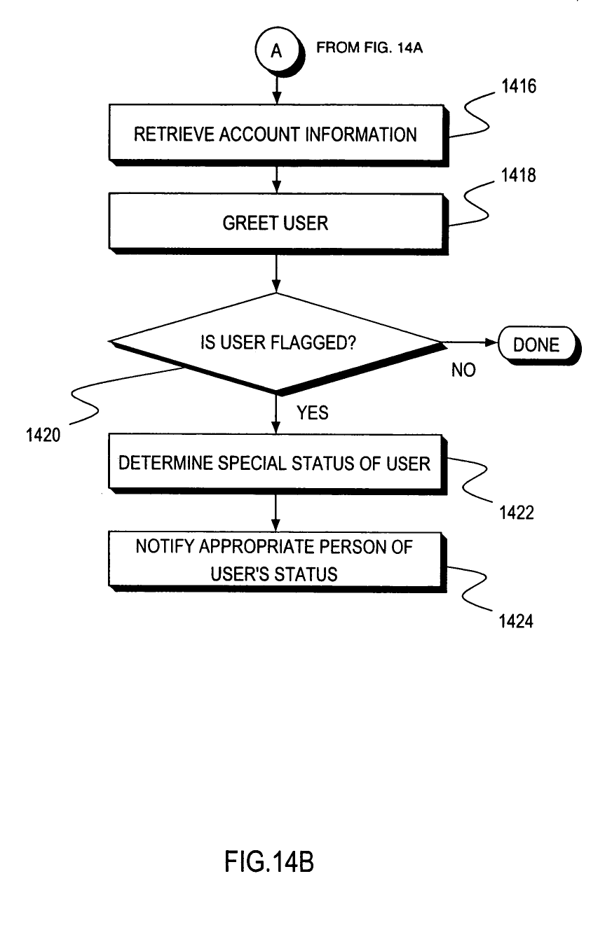

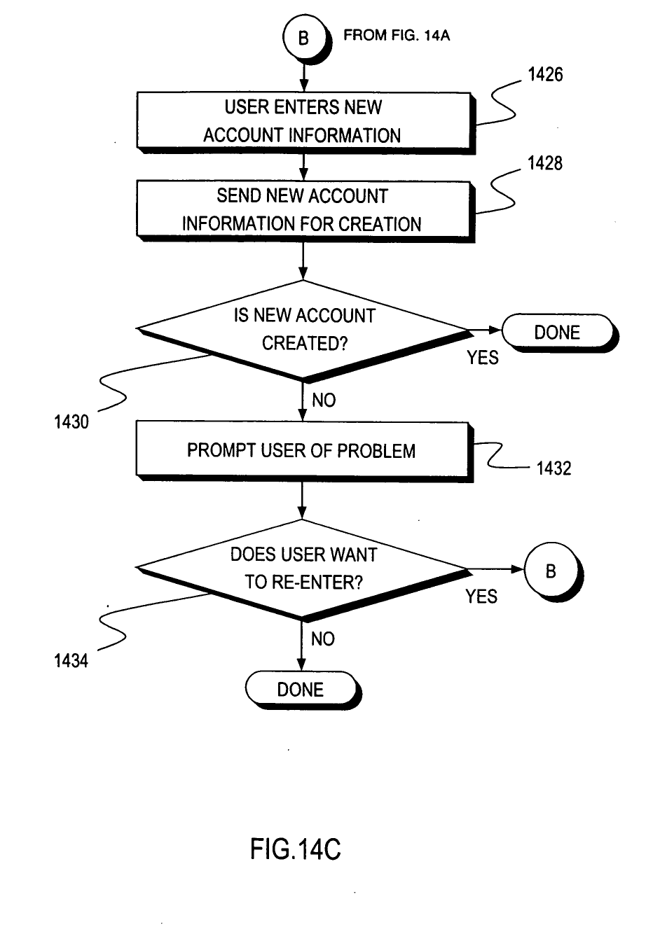

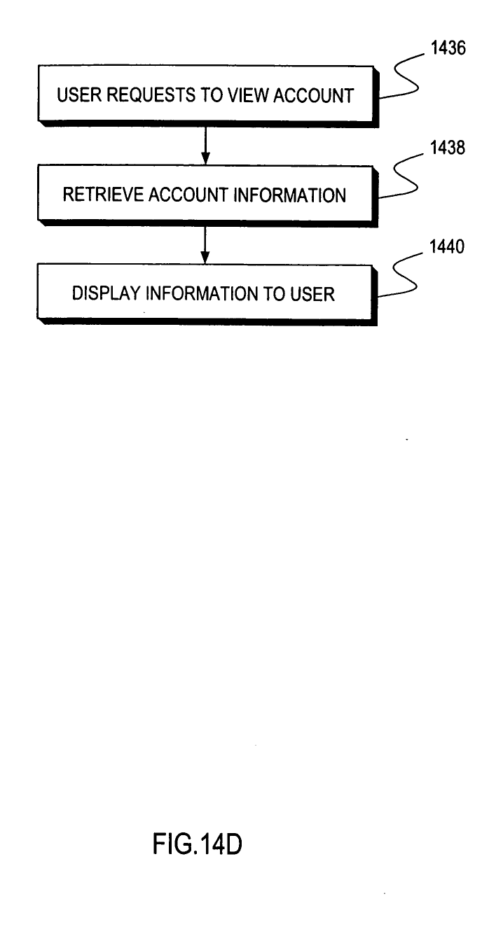

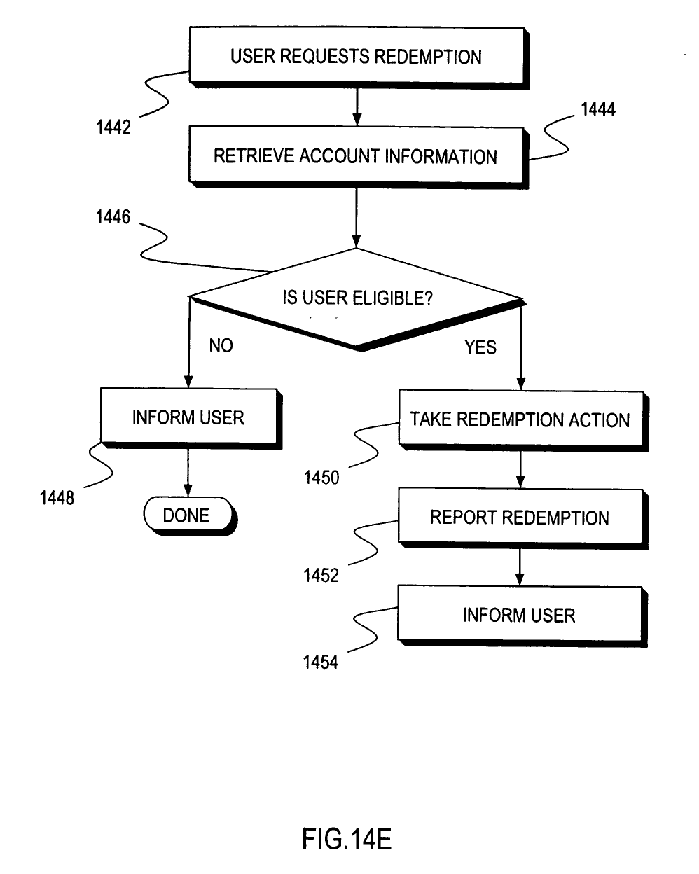

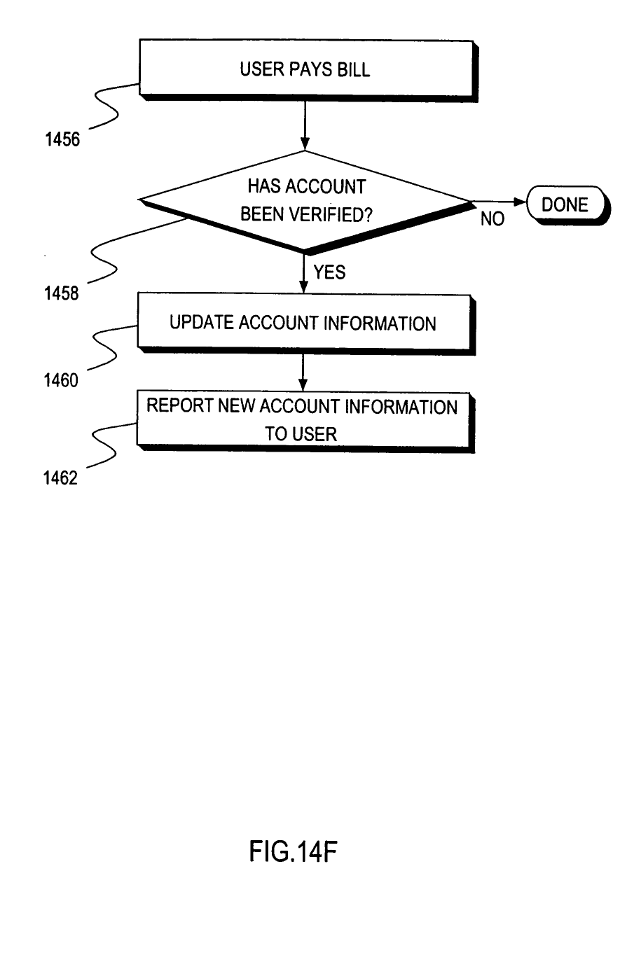

Flowchart 1402, depicted in FIGS. 14A-14F, illustrates the manner in which the user can take advantage of loyalty rewards programs. In the restaurant example above, this could mean a frequent dining program, in which points are earned through purchases, and redeemed in exchange for reductions to the bill, complimentary items, or merchandise. Note that the loyalty rewards program could also be frequent flyer miles, as well.

Referring to FIG. 14A, in step 1404, if the user already has an account, then in step 1406 the user enters their account identification, perhaps by swiping a magnetic card through a magnetic card reader in the mobile device 104, or perhaps through another device of some type. It is possible that the hostess may ask the user for their card when they enter the restaurant, and swipe it herself. It is also possible that instead of swiping a magnetic card, some form of keyboard, or other, input is utilized instead. Further, this act of identification may be delayed until the user is seated at their table, or at any time thereafter when they wish to identify themselves to the system. Note that if in step 1404 they do not have an account, they can create one by proceeding to step 1426 in FIG. 14C, as described below.

Regardless of how this identification process is achieved, or when, once it has occurred, then is step 1408, the account identification, including but not limited to an account number, is sent to the on-site server 102 for verification. It is possible that the account identification is sent by the on-site server 102 to the information center 100 for verification, and the information center 100 may in turn send the account identification on to a third party 404 for verification.

Regardless of where verification takes place, it is reported back to the on-site server 102. If the account cannot be verified in step 1410, the in step 1412 the user is notified and asked if they wish to re-enter their account identification. If the user chooses to re-enter the account identification, they are returned to step 1406.

If they do not want to re-enter their account identification, they can in step 1414 choose to create a new account. FIG. 14C depicts the steps whereby the user can create a new account. In step 1426 they enter the account information, which could include, but is not limited to, their name, address, phone number(s), email address, and any other information of interest. In step 1428, that account information is sent to the on-site server 102 to create a new account. It is possible that the account information is sent by the on-site server 102 to the information center 100 for verification, and the information center 100 may in turn send the account identification on to a third party 404 for verification.

Regardless of where account creation takes place, it is reported back to the on-site server 102. If the account cannot be created in step 1430, then in step 1432 the user is notified and asked if they wish to re-enter their account information. If the user chooses to re-enter the account information, they are returned to step 1426.

Referring to FIG. 14A if in step 1410 the user's existing account identification has been verified, then referring to FIG. 14B in step 1416 the account information is retrieved from the on-site server 102, the information center 100, or the third party 404, and in step 1418 a greeting is displayed on the mobile device 104 to the user. It is possible for a summary of account information, including but not limited to, points available for redemption, to be displayed as well, as is depicted in FIG. 24H.

In step 1420, it is determined if the user has been flagged in some way. This could include information such as, but not limited to, the user's seating preference, dietary restrictions, preferred meals and wines, or other information of interest. If the user has been flagged, then in step 1422, any special status of the user is determined, and in step 1424 the appropriate person is notified of the user's arrival and their status. In the restaurant example above, the person notified could be the hostess, alerted to the user's seating preferences; it could be the wait-staff, notified of the user's name and dietary restrictions, or preferred meals and wines; it could be the restaurant manager, alerted if the user is a very frequent or high-spending diner to be greeted personally; it could be user themselves, alerted via the mobile device 104 as to their past meal and wine selections, and referring to FIG. 24H if the user pressed on the item 2418 then the user can see ratings of previous meals and wines in FIG. 24I.

FIG. 14D depicts the steps whereby the user can review the status of their account. Note that until they have identified their account, or created a new one in FIGS. 14A-14C, then this option is not available to the user. In step 1436, the user requests to view their account information. In step 1438, the request goes to the on-site server 102, where it in turn may be passed on to the information center 100 or to a third party 404. Once the information is returned, it is displayed on the mobile device 104 in step 1440.

FIG. 14E depicts the steps whereby the user can redeem points from their account for goods or services. Note that until they have identified their account, or created a new one in FIGS. 14A-14C, then this option is not available to the user. In step 1442 the user requests to redeem some or all of their points. In step 1444, the request goes to the on-site server 102, where it in turn may be passed on to the information center 100 or to a third party 404. Once the information is returned, it is determined in step 1446 if the user has enough points or is eligible to redeem their points. If they are not eligible, then in step 1448 they are informed via the mobile device 104. If in step 1446 it is determined that they are eligible, then in step 1450 the redemption action takes place. In the restaurant example mentioned above, this could involve sending a message to the waitperson that a certain amount should be deducted from the user's bill, or that a free menu item or drink is to be delivered to the user; it could be reported to a third party if some other merchandise or service is being purchased; it could be reported to the restaurant manager if some other action should take place. Regardless of how the redemption action occurs, in step 1452 the redemption is reported to the on-site server 102, where it may in turn be reported to the information center 100 or third party 404. Regardless of where it is reported, it is likely that the account will be updated, reducing the number of points by the amount that has been redeemed. Finally, in step 1454, the user is informed, via the mobile device 104, of their updated account status.

FIG. 14F depicts the steps whereby the user's account is credited with additional points earned. In step 1456, the user pays their bill. This payment credits their account with points, and the payment may occur at the end of the meal, or during the meal for purchase of goods and services. In step 1458, it is determined if the user has entered a verified account identification (or created a new account). If they have, then in step 1460, the purchase information is reported to the on-site server 102, where it may in turn be reported to the information center 100 or third party 404. Regardless of where it is reported, it is likely that the account will be updated, increasing the number of points by the amount that has been spent. Finally, in step 1462, the user is informed, via the mobile device 104, of their updated account status.

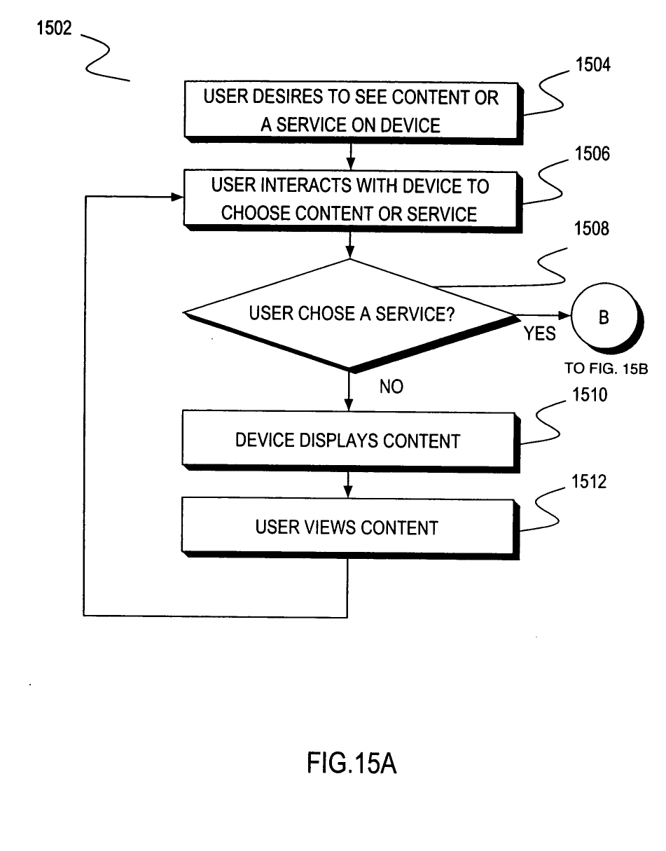

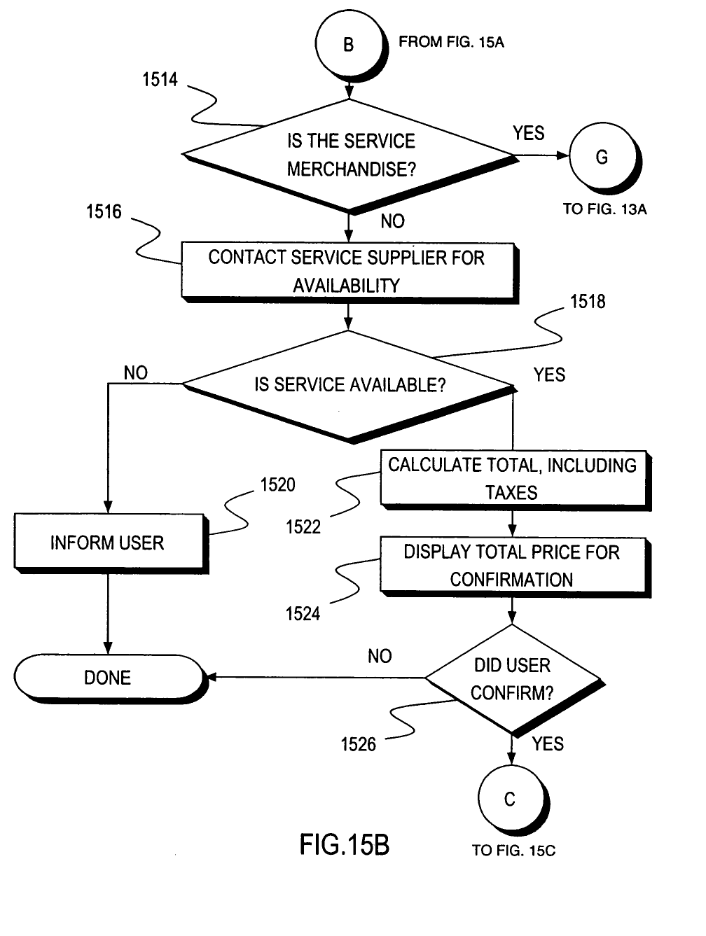

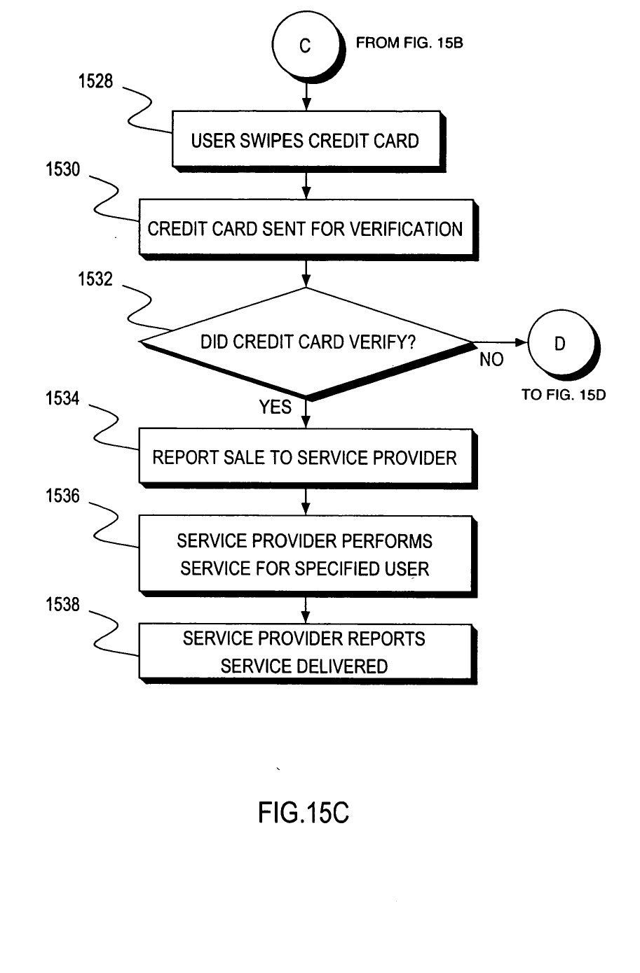

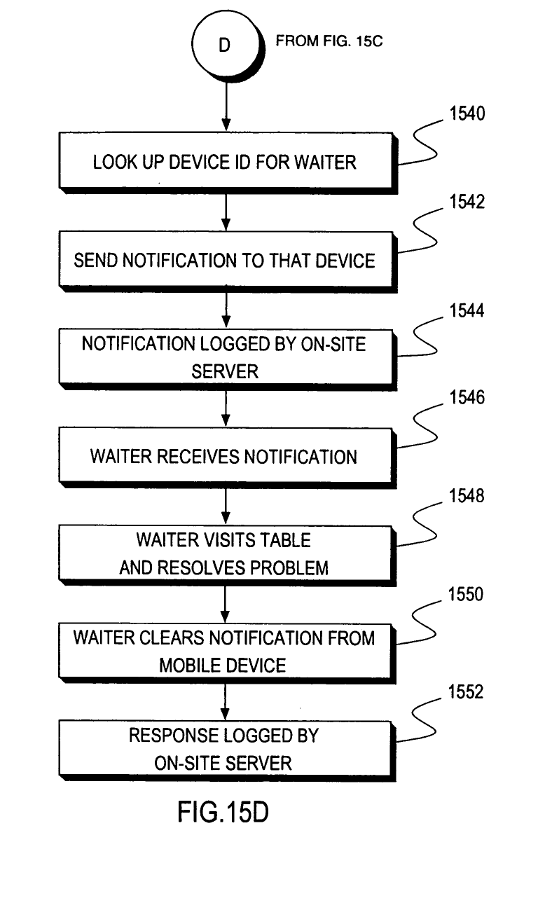

Flowchart 1502, depicted in FIGS. 15A-15D, illustrates the manner in which a user may view content and services in the restaurant example above. Referring to FIG. 15A step 1504, the user has determined that they would like to view content or request a service on the mobile device 104 at their table. The user interacts with the mobile device 104 by pressing the screen near text, which describes the content and services, in step 1506. For example, referring to FIG. 24A, if the user presses near the text “Call Waiter” 2402, then a service request is initiated. In step 1508, if the item the user pressed is not a service then in step 1510 the request is received by the content server 300 on the on-site server 102, which displays the requested content on the mobile device 104. The user then can view the desired content in step 1512. The user may view additional content or services by returning to step 1506.

If in step 1508 the user chose a service then referring to FIG. 15B, in step 1514 if the service is purchasing merchandise then these steps are described in FIGS. 13A-13G. If the service is not purchasing merchandise then the request is received by the content server 300 on the on-site server 102, which passes the request on to a dynamic content and services handler 314. In step 1516 this handler contacts the service supplier and verifies the availability of the service. In an example implementation of the invention this could be a third party 404 or other on-site service supplier.

If in step 1518 the service is not available, then in step 1520 a page is displayed on the mobile device 104 informing the user that the requested service is unavailable. If the service is available, then in step 1522 then a total is calculated including any applicable taxes, and in step 1524 this total is displayed on the mobile device 104 for confirmation. If in step 1526 the user does not confirms the purchase then the service request is canceled.

If in step 1526 the user confirms the purchase then referring to FIG. 15C in step 1528, they swipe their credit card through a magnetic strip reader on the mobile device 104.

In step 1530, the credit card information is passed to the content server 300 on the on-site server 102, which passes that information on to a dynamic content and services handler 314. This handler sends the credit card information (such as but not limited to amount, date, time and merchant number) to a credit card clearing center to be paid. If in step 1532 the charge clears, then in step 1534 the service sale is reported to the service provider. In an example of an implementation of the invention all information required for the service provider to provide the service is sent to them at this time.

In step 1536 the service provider performs the service for the specified user, then in step 1538 the service provider reports that the service has been performed or acknowledges that the service will be performed.

If in step 1532 the credit card did not verify then (referring to FIG. 15D in step 1540), the dynamic content and services handler 314 looks up the device ID for the waitperson assigned to the table and sends a problem message to that device (step 1542). The dynamic content and services handler 314 logs the message (step 1544) and the waitperson receives the message in step 1546. In step 1548, the waitperson visits the table to resolve the issue. In step 1550, the waitperson after resolving the problem, clears the message from his paging device 116 which causes the dynamic content and services handler 314 to update the information logged, in step 1552, to show the time it was completed and by whom.

4.4 Wait-Staff Operations

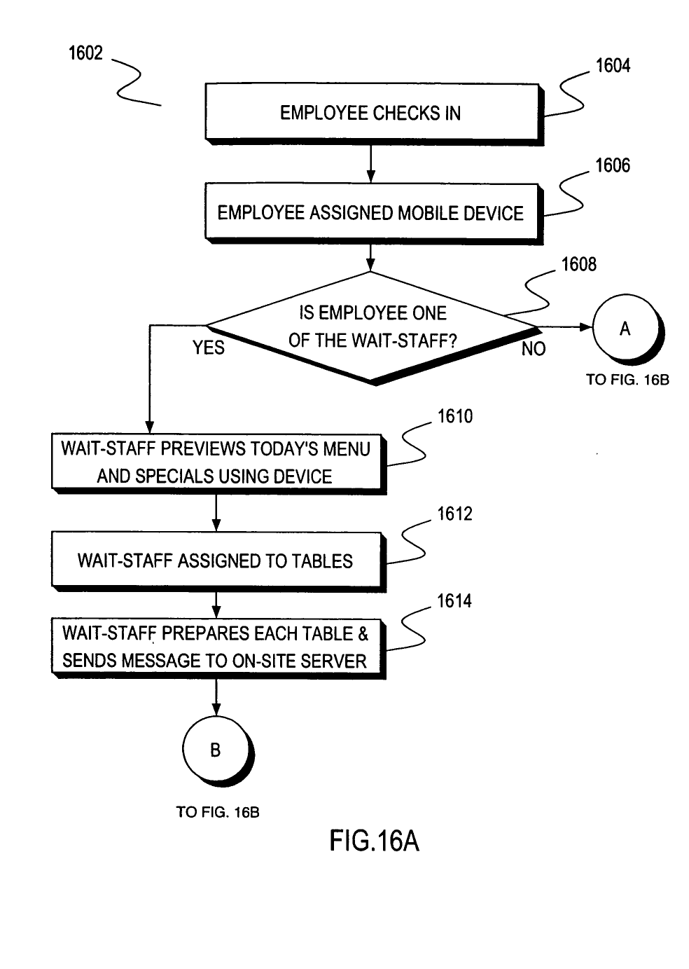

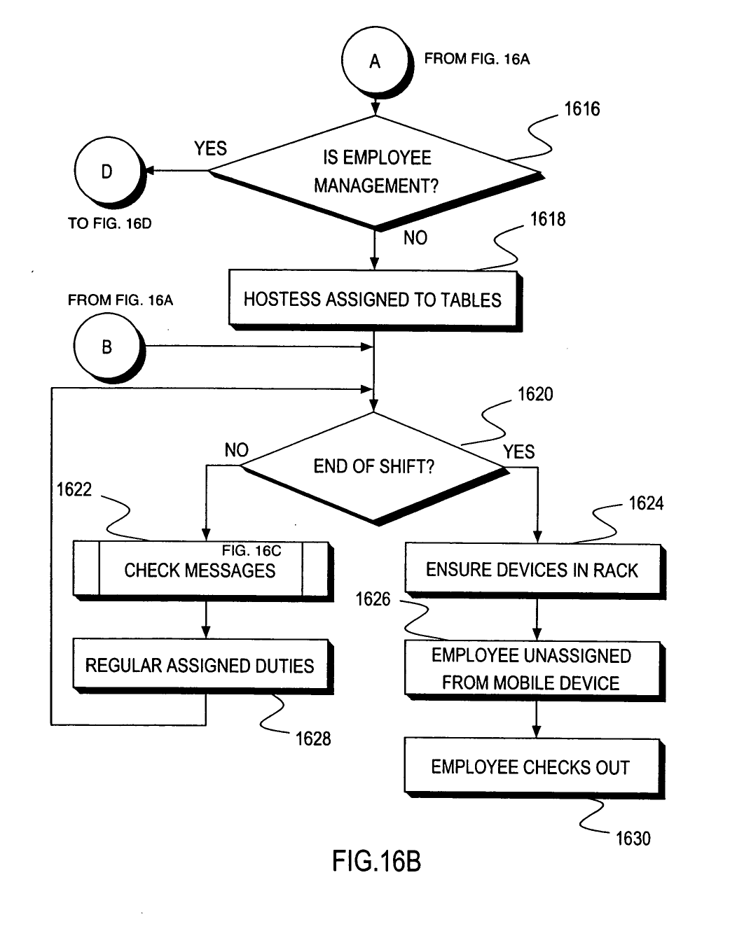

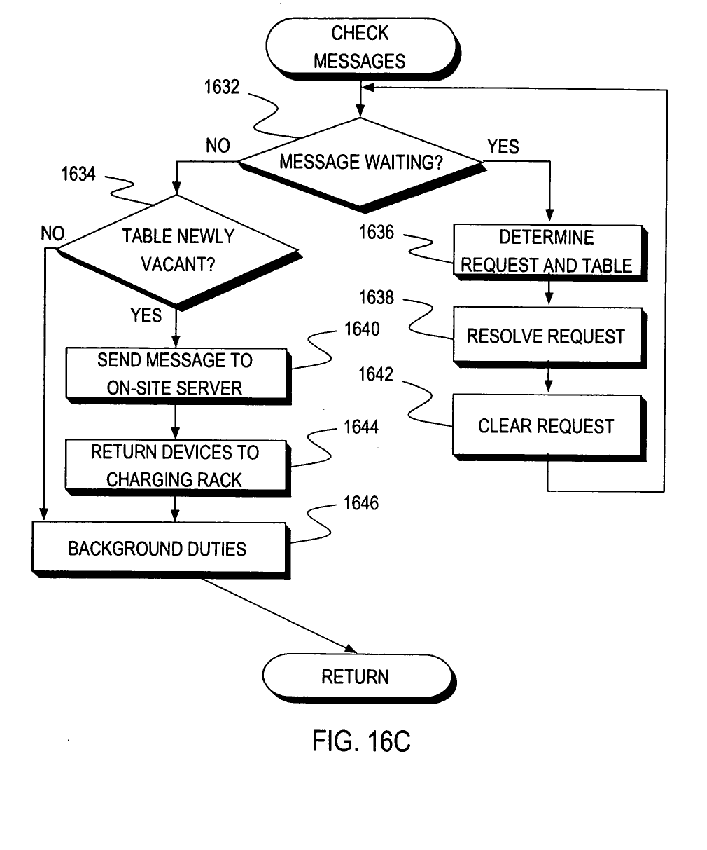

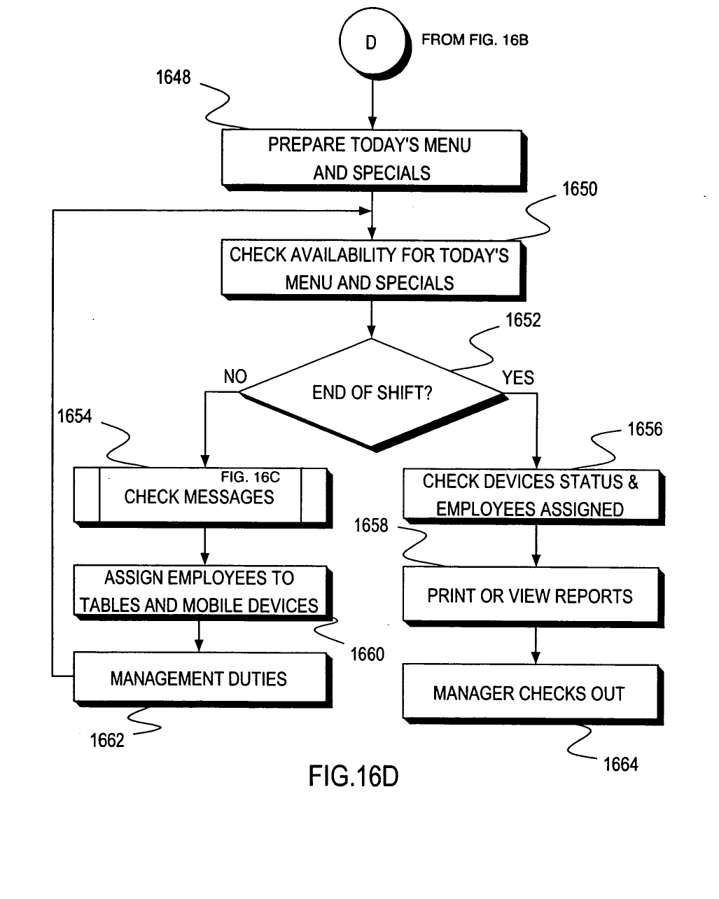

Flowchart 1602, depicted in FIGS. 16A-16D, illustrates the manner in which the employees can interact with an implementation of the invention. In the restaurant example above, the employees could include, but are not limited to, the waiters, busboys, hostesses, chef, sommelier, or restaurant manager.

Referring to FIG. 16A, in step 1604, the employee arrives for work and checks in using the normal procedure for the restaurant, and then in 1606 the employee is assigned and associated to a paging device 116 which may be a mobile device 104, or perhaps another device of some type (for example a 2-way alphanumeric pager with vibrate mode). The types of paging devices 116 given to each employee may or may not vary. If in step 1608 they are one of the wait-staff, they can preview today's menu and specials in step 1610 by temporarily using one of the standard guest mobile devices 104. In step 1616 in FIG. 16B, if they are not one of the wait-staff they would continue by proceeding to step 1648 in FIG. 16D, as described below. Any employee, at any time during the day, may use an available guest mobile device 104 to see the current availability of menu items, to answer a guest question, or for any other reason.

When the wait-staff's actual floor time starts their mobile device 104 is assigned a group of tables in step 1612. The act of assigning a particular employee's paging device 116 may cause another employee's paging device 116 to be unassigned. For example, if the restaurant manager has configured the invention to allow only one waiter per table, then assigning a new waiter at the beginning of his shift un-assigns the previous waiter from that table. All outstanding messages for the tables assigned to that employee are sent to that new employee's paging device 116, and the previous employee is no longer responsible for them. If in the process of assigning an employee to a table the maximum employees of that job classification is reached and that maximum is more than one, then the person assigning the new employee may choose which of the already assigned employees to un-assign.

The normal actions of the wait-staff will follow that if in step 1620 in FIG. 16B, their shift is not over then they continually perform, in step 1622, the check messages procedure and their regular assigned duties 1628.

The check messages 1622 procedure is elaborated in FIG. 16C. The employee checks to see if there is a message waiting in step 1632. If there is one, then in step 1636 the employee determines the type of request and the table (if any) associated with the request. Each employee job classification receives different types of requests. These requests are defined and associated to the particular job classification by the operator using the authoring system 302. For example, a busboy may receive “Bring Water” or “Clear Table” messages, a waitperson may receive “Bring Bill” or “Call Waiter” messages, and the hostess may receive “Table Vacant” or “Table Ready” messages. Each employee is trained how to respond and to resolve each request, which they resolve in step 1638. Note that an individual employee may be given more than one job classification (for example, both waiter and busboy). Once the message has been resolved, the employee sends a clear request in step 1642 to the on-site server 102. The employee then returns to step 1632 to check for additional messages.

If in step 1632 there are no messages waiting then the employee checks if any tables are newly vacant in step 1634. If not, then the employee performs in step 1646 their standard background duties for their assigned job, for example the busboy may fill the water in all glasses at all tables, or the waiter may visit their assigned tables.

If there is a newly vacant table then in step 1640 the employee sends a message indicating which table is vacant to the on-site server 102, for each newly vacant table. At this point, step 1644, the employee also checks for unused guest mobile devices 104 and returns them to the charging station 112. The employee then performs their background duties in step 1646 above.

After the background duties are complete the check messages 1622 procedure is complete. The employee then continues with step 1620 above. When the end of their shift occurs, in step 1624 they perform a last check that the unused mobile devices 104 are in the charging station 112. In step 1626, the employee is unassigned from their tables, either by assigning another employee to the tables or if no guests are present at the tables by merely un-assigning the tables. The employee may then in step 1630 complete their checkout using the normal procedure for the restaurant.

Referring to FIG. 16D the employee is a manager, in the restaurant example that may include, but not be limited to, the chef, sommelier or restaurant manager. The manager level positions have additional capabilities, such as indicating items not available, viewing and printing reports and assigning job classifications, or tables to employees.

In step 1648, one or more of the management create or prepare the menu and daily specials to be used in the restaurant. Throughout the day, someone from management is responsible, in step 1650, to ensure that the menu is current as far as availability of items on the menu. For example, this could be performed automatically by interfacing with existing inventory management systems, or manually by the chef or sommelier indicating that an menu item is no longer available when the last of that item is ordered or due to time constraints. In this step the chef or restaurant manager could also adjust prices or change the specials.

The normal actions of the management follow that if in step 1652, their shift is not over then they continually perform, in step 1654, the check messages procedure, elaborated in FIG. 16C above, managing the assignment of tables and employees in step 1660 and their regular management duties 1662.

When the end of their shift occurs, in step 1656 they perform a last check that the unused mobile devices 104 are in the charging station 112 and check that all the employees are unassigned from the tables. In step 1658, the manager may print or view reports. The manager may then in step 1664 complete their checkout using the normal procedure for the restaurant.

4.5 System Implementation

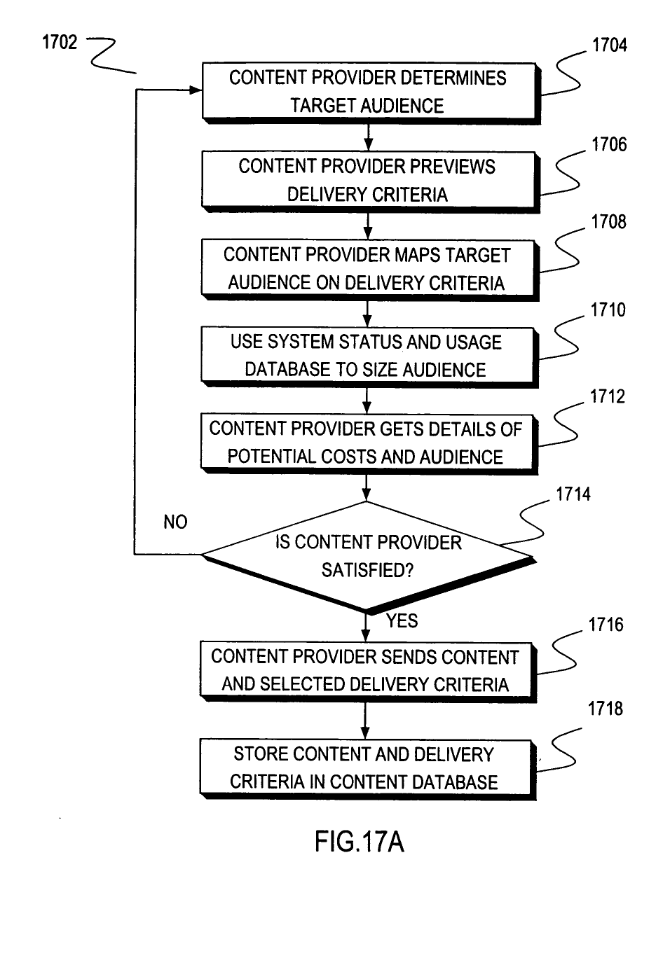

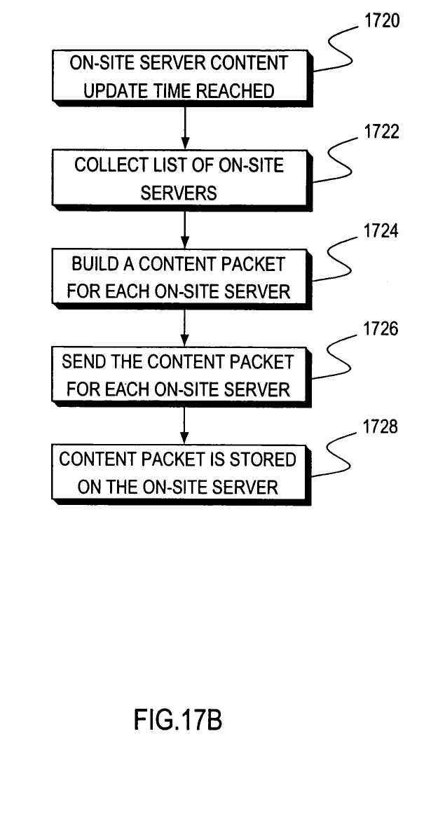

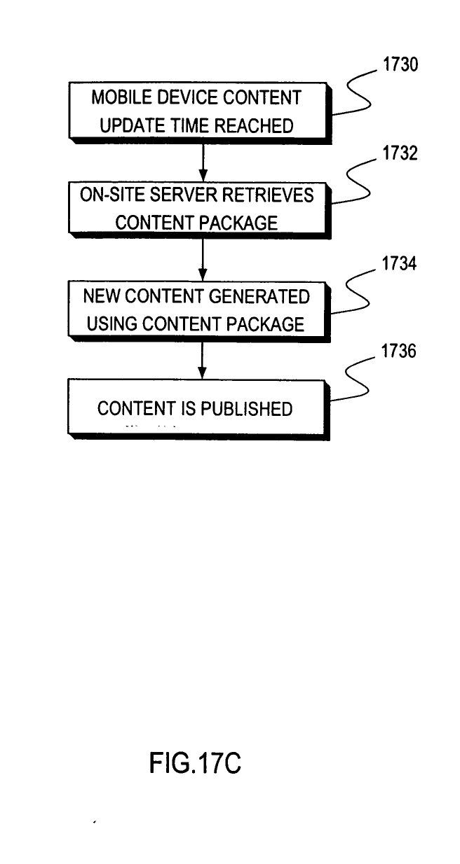

Flowchart 1702, depicted in FIGS. 17A-17C, illustrates the manner in which the third parties 404 and others can deliver content directed to users based on various criteria with an implementation of the invention. In the restaurant example above, the third parties 404 and could deliver content and advertising based on, but not limited to, the location of the restaurant (and any other demographics derived from the location), the type of business, the frequent diner information (and any other information derived from the frequent diner if permitted, i.e. age or gender), the average meal price in the restaurant, the time and duration of the content, or if the restaurant is part of a chain then the chain ID or restaurant ID within the chain.

Referring to FIG. 17A, in step 1704, the third party 404 content providers decide on the target audience they would like to provide content for, and then in 1706 they review the various criteria with which they can use to control the delivery of their content using the invention.

In step 1708 they map their target audience onto the available criteria using one the tools provide by the invention and/or their own in-house tools and in step 1710 they size the audience by using one the tools provide by the invention which accesses the content database 414 and usage database 408 contained in information center 100. In an embodiment of the invention the target delivery tools display the available delivery criteria to the third party 404 content providers for selection. The selectable criteria are based on the information contained in the content database 414 and usage database 408 and other demographic data available from third parties such as census data.

The third party 404 content providers in step 1712 receive feedback about the estimated costs and the size of the audience they have defined with their delivery criteria. As the criteria is being entered it is used to search the content database 414 and the usage database 408 to determine the estimate of the size of the target audience that is then displayed to the third party 404 content provider. If in step 1714 they are not satisfied with their results they may return to step 1704 to further refine their target audience or delivery criteria.

If in step 1714 they are satisfied with their results then in step 1716 the send the content they wish to deliver and the selected delivery criteria to the information center 100 for storage in the content database 414 in step 1718.

Referring to FIG. 17B the information center 100 periodically sends content to the on-site server 102. In step 1720, when the time to update the on-site servers 102 is reached, then in step 1722 the information center 100 uses the system status database 406 to build a list of on-site servers 102 which need to have content delivered. Then, in step 1724 a unique content packet it created for each on-site server in the list. In step 1726 the content packet destined for each on-site server 102 is sent. In an implementation of this invention this transmission is encrypted and fault tolerant. In step 1728 the content packet delivered is stored on each on-site server 102.

Referring to FIG. 17C the on-site server 102 periodically, at an operator configurable time, enables new content for display on the mobile devices 104. In step 1730, when the time to update the content for the mobile devices 104 is reached, then in step 1732 the authoring system 302 retrieves the content packet previously stored on the on-site server 102 in FIG. 17B step 1728 above.

In step 1734, the authoring system 302 uses the new content packet and content generator 340 to create the static content & services 334. Then, in step 1736, the authoring system 302 uses content publisher 342 to move the static content & services 334 to the proper file location in the file system such that the content server 300 provides that content to the mobile devices 104. In addition, content publisher 342 may read in configuration manager settings 352 that describe where the static content & services 334 can be moved to an external web server 354.

Dynamic display of any content is decided on by a combination of a dynamic content and services handler 314 (which could be a CGI) running on the on-site server 102 and embedded JavaScripts running on the mobile device 104.

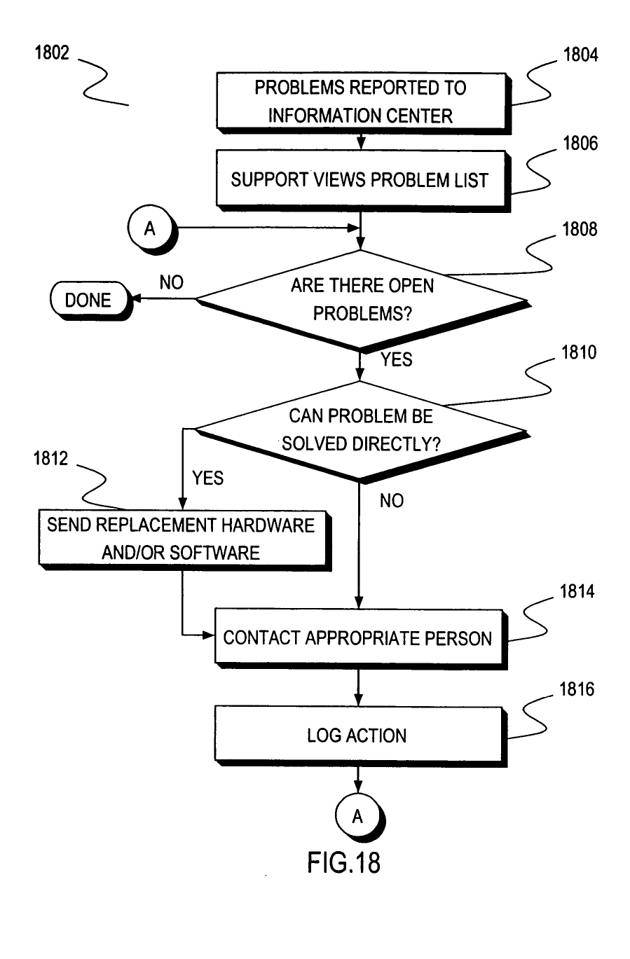

Flowchart 1802, depicted in FIG. 18, illustrates the manner in which support personnel at the information center 100 can handle hardware and software problems proactively. In FIGS. 2A and 2C it is shown how the mobile device 104 can perform self-tests to determine its hardware and software stability. Referring to FIG. 18, step 1804, the results of these tests are reported by the mobile device 104 to the on-site server 102, which in turns passes these results on the to the information center 100, where they are stored in the system status database 406.

In step 1806, support personnel would check the contents of the system status database 406, and determine in step 1808 if there are any open problems needing attention. If there are, then in step 1810, the support personnel determine if the problem can be solved by replacement of hardware and/or software components. If that is the case, then is step 1812 the support personnel takes the steps necessary to send the required hardware and/or software to the problem site. In step 1814, the support personnel contact the designated operator at the problem site and inform them of the problem, of the corrective action taken, and an expected date when the replacement hardware and/or software should arrive at the problem site. In step 1816, the corrective action is logged, updating the system status database 406. Once the corrective action has been, logged, support personnel return to step 1808 to determine if there are additional open problems.

If in step 1810, the support personnel determine that replacing software and/or hardware cannot solve the problem, then in step 1814 the support personnel contact the appropriate person. This could include, but is not limited to, the operator at the problem site, or internal support personnel, or to take some other action to rectify the problem. In step 1816, the corrective action is logged, updating the system status database 406. Once the corrective action has been, logged, support personnel return to step 1808 to determine if there are additional open problems.

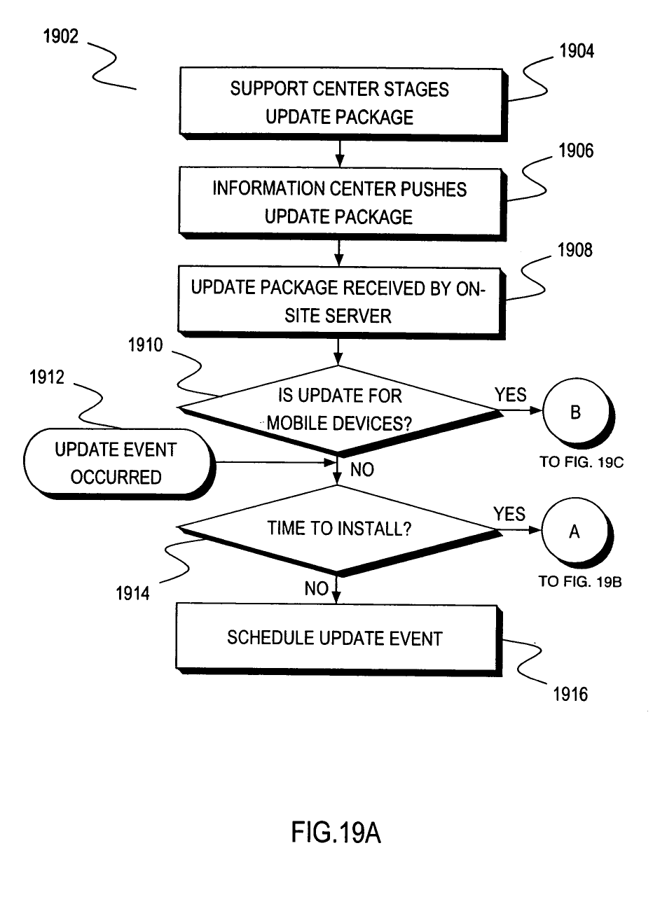

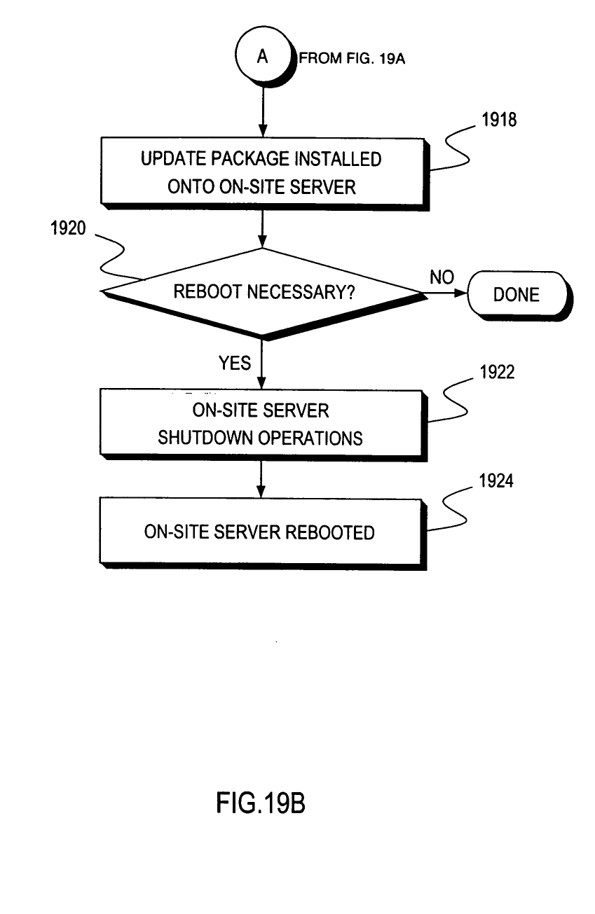

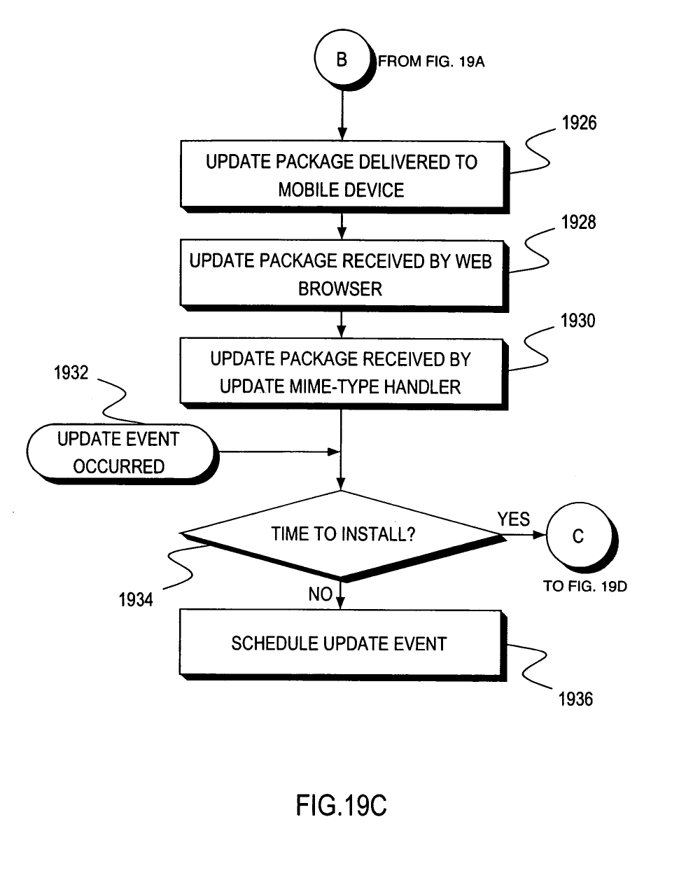

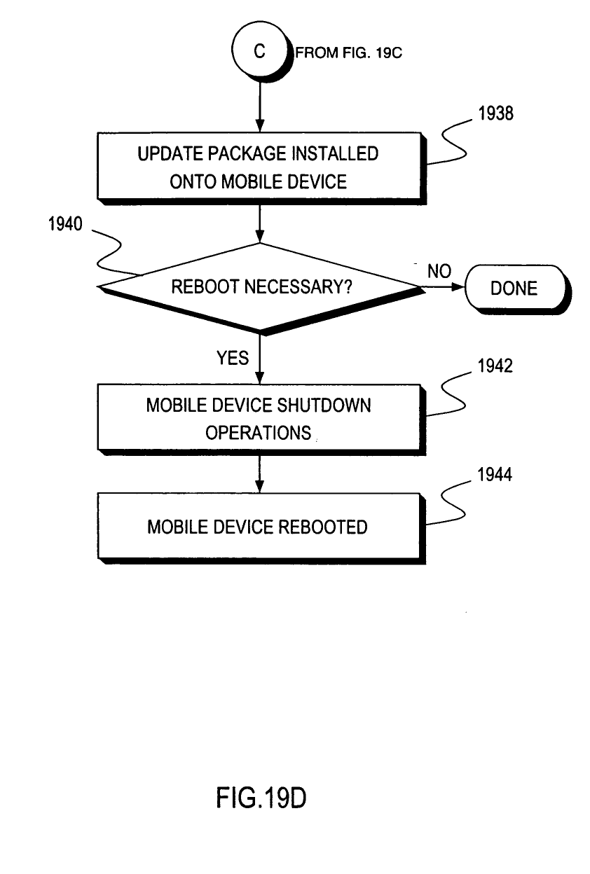

Flowchart 1902, depicted in FIGS. 19A-19D, illustrates the manner in which software updates can be deployed to the on-site server 102 and/or the mobile devices 104 by the information center 100. Software updates include, but are not limited to, software programs, software patches, content (such as, but not limited to, HTML, image, sound, and movies files), data files, and patches. Any and all of these types of files may be considered to make up the update package 224.

Referring to FIG. 19A, in step 1904, the update package 224 is prepared by the support center 402 and sent to the information center 100. In step 1906, at a predetermined time, the information center 100 delivers the update package 224 to as many on-site servers 102 as is appropriate. In some cases, all on-site servers 102 receive a given update package 224, but in other cases only a subset of the on-site servers 102 receive the update package 224. In step 1908, the on-site server 102 receives the update package 224.

The information center 102, in step 1910, determines if the update package 224 is intended to be installed on a mobile device 104. If it is not, then the on-site server 102 determines if the update package 224 can be installed at the current time. If it cannot, an update event is scheduled on the on-site server 102 in step 1916. This is a time-based event that triggers after a given duration. When that event triggers, in step 1912, then the on-site server 102 returns to step 1914 to see if the update package 224 can be installed at that time.

Once the on-site server 102 determines in step 1914 that the update package 224 can be installed, it does so referring to FIG. 19B in step 1918. Once the component(s) in the update package 224 have been installed, the on-site server 102 determines if it needs to be rebooted in step 1920. If a reboot is required, then any necessary shutdown steps occurs in step 1922, and the on-site server 102 is rebooted in step 1924. If a reboot is not required, then the update is complete.

If, in step 1910, the on-site server 102 determines that the update package 224 is intended for installation on the mobile devices 104, then referring to FIG. 19C in step 1926, the update package 224 is delivered to the mobile device 104. As in the case of delivery of the update package 224 by the information center 100 to the on-site servers 102, it is possible that the update package 224 is intended to be delivered to all, or a subset of, the mobile devices 104.

In step 1928, the browser 204 of the mobile device 104 receives the update package 224, and in step 1930, passes it on to the update MIME-type handler 226. In step 1934, the installer 228 determines if the update package 224 can be installed at the current time. If it cannot, an update event is scheduled on the mobile device 104 in step 1936. This is a time-based event that triggers after a given duration. When that event triggers, in step 1932, then the installer 228 on the mobile device 104 returns to step 1934 to see if the update package 224 can be installed at that time.

Once the installer 228 determines in step 1934 that the update package 224 can be installed, it does so referring to FIG. 19D in step 1938. Once the installer 228 has installed the component(s) from the update package 224, it determines if the mobile device 104 needs to be rebooted in step 1940. If a reboot is required, then any necessary shutdown steps occurs in step 1942, and the mobile device 104 is rebooted in step 1944.

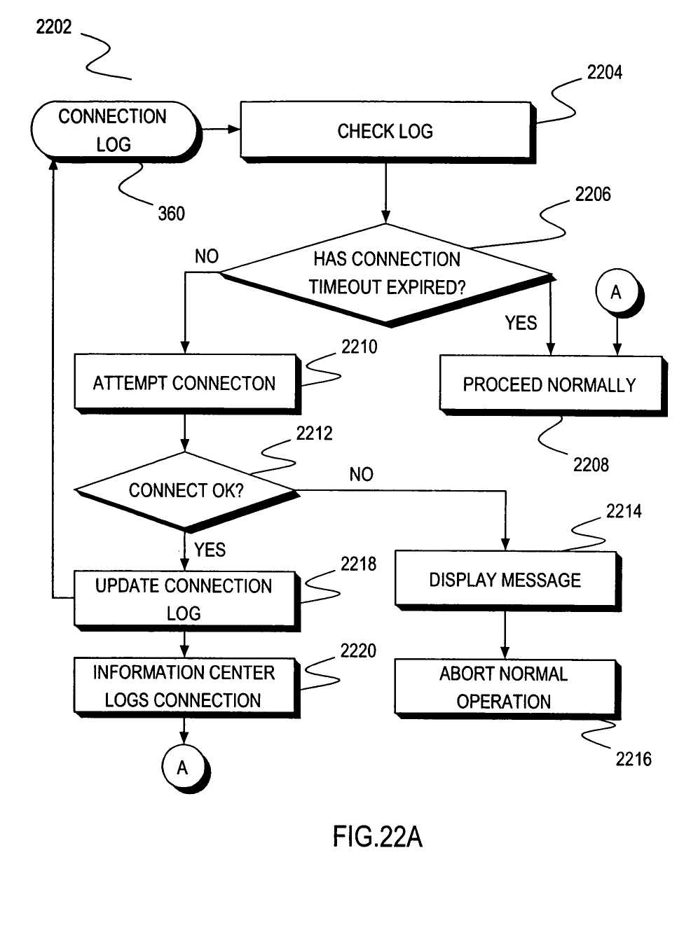

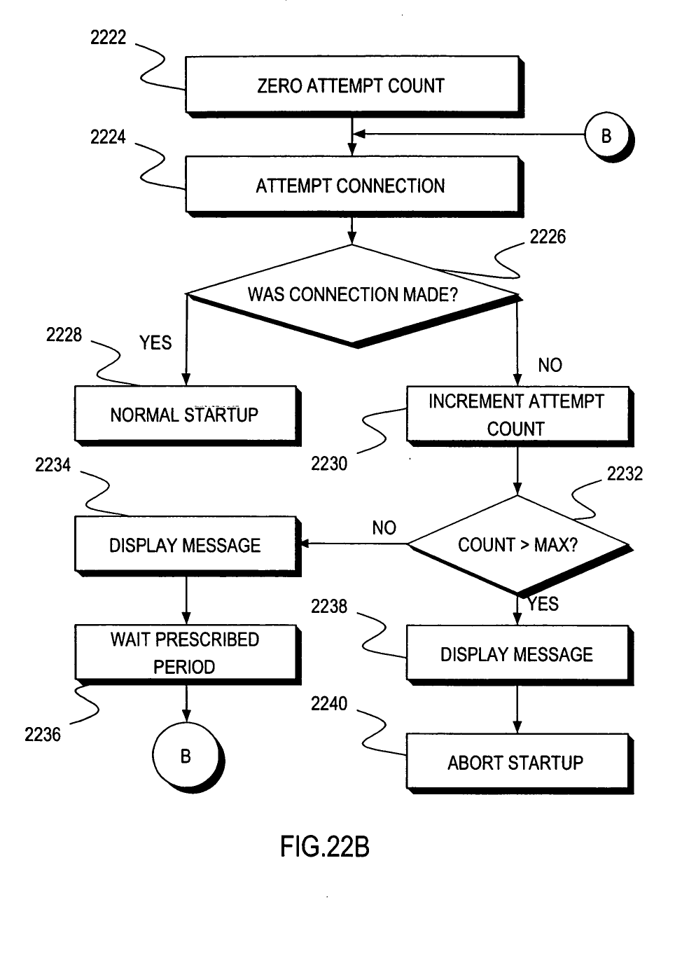

Flowchart 2202, depicted in FIG. 22A-22B, illustrates the manner in which the on-site server 102 and mobile device 104 ensure that they are connected to their respective hosts. In the case of on-site server 102, the host is the information center 100; for the mobile device 104, the host is the on-site server 102.

Referring to FIG. 22A depicts how the on-site server 102 ensures it is connected to the information center 100. Whenever the on-site server startup application 362 runs, in step 2204 it checks the connection log 360 to see if the date and time of the last successful connection to the information center 100 occurred. In step 2206, it is determined if the period between the current date and time and the date and time of the last connection exceeds a predetermined amount.

If that period of time does not exceed the predetermined amount, then in step 2208, startup proceeds normally.

If that period of time exceeds the predetermined amount, then in step 2210, the on-site server 102 attempts another connection to the information center 100. In step 2212, if that connection occurs, then in step 2218, the connection log 360 is updated, and in step 2220 the information center 100 logs this connection for usage by the support center 402. Lastly, in 2208, startup proceeds normally.

If in step 2212 it is determined that the connection attempt has failed, then in step 2214 a message is displayed on the on-site server 102, and in step 2216, startup is aborted.

Note that in step 2208, as part of normal startup, a periodic process is started on the on-site server 102 that performs the tasks shown in FIG. 22A at periodic intervals.

FIG. 22B depicts the steps whereby the mobile device 104 ensures that it has a connection to the on-site server 102. In step 2222, the startup application 222 sets a connection attempt count to zero. The startup application 222 is run every time the mobile device 104 boots up.

In step 2224 the startup application 222 attempts a connection to the on-site server 102. If in step 2226, it is determined that the connection to the on-site server 102 was made successfully, then in step 2228, the startup proceeds normally.

If in step 2226 it is determined that the connection to the on-site server 102 failed, then in step 2230, the connection attempt count is incremented. In step 2232, it is determined if the connect attempt count exceeds a predefined maximum. If it does not, then in step 2234 a “please wait” message is displayed on the mobile device 104 via device control 216, and a predefined period of time is allowed to pass in step 2236 before returning to step 2224 described above.

If in step 2232 it is determined that the maximum number of connection attempts has been exceeded, then in step 2238 a “return device to waiter” message is displayed on the mobile device 104 using device control 216, and in step 2240, startup is aborted.

Flowchart 2302, depicted in FIG. 23A-23B, illustrates the manner in which mobile device 104 and on-site server 102 are associated with one another. This process, called “association”, ensures that each mobile device 104 only communicates with its associated on-site server 102, and the on-site server 102 only communicates with those mobile devices 104 with which it has been associated.

Referring to FIG. 23A in step 2304 the operator connects the mobile device 104 to the on-site server 102. This connection could be done in any number of ways, for example via a serial or USB (Universal Serial Bus) cable. Once connected, then in step 2306, the on-site server 102 and the mobile device 104 exchange their unique identification.

In step 2308 the on-site server 102, takes the information received from the mobile device 104 and looks in data storage 312 to see if the mobile device 104 is already known. If the mobile device 104 is not found in data storage 312, then in step 2310 the on-site server determines if the license agreement is exhausted. If in step 2310 it is determined that the license is not exhausted, the mobile device 104 is added to the list of known devices, and that information is recorded in data storage 312.

In step 2314, the operator determines if they have more mobile devices 104 to associate with the on-site server 102, and if there are, they return to step 2304.

If in step 2308 it is determined that the mobile device 104 is already associated with the on-site server 102, then in step 2314, the operator determines if they have more mobile devices 104 to associate with the on-site server, and if there are, they return to step 2304.

If in step 2310 it is determined that the license is exhausted, then referring to FIG. 23B, in step 2316 the operator is prompted that they need to purchase additional licenses to accommodate additional mobile devices 104. If in step 2318 the operator indicates that they do wish to purchase additional licenses, then in step 2320 the license purchase request is sent to the information center 100. In step 2322, it is determined if the operator's purchase of additional licenses is acceptable. If that purchase is not acceptable, then in step 2324 the operator is prompted to that fact. Referring to FIG. 23A, in step 2314, the operator determines if they have more mobile devices 104 to associate with the on-site server, and if there are, they return to step 2304.

If in step 2322 it is determined that the purchase of additional licenses is acceptable, then in step 2326, the updated license information is stored on both the information center 100 and the on-site server 102. Referring to FIG. 23A, in step 2314, the operator determines if they have more mobile devices 104 to associate with the on-site server, and if there are, they return to step 2304.

5. Applications of the Present Invention

The example embodiment of the current invention is being described herein as it applies to restaurants. It is also possible to use the current invention in a variety of other applications where data is being displayed to and collected from users. Some of these applications include but are not limited to hotels, cruise ships, casinos, shopping malls, bars, amusement parks, auction houses, charity events, hospitals, museums, prisons, airports and airplanes, conventions, sporting events, schools and libraries, resorts, tour buses and boats, a variety of retail and service businesses, or any place where people gather. Implementation of the present invention in these applications will be apparent to persons skilled in the relevant art(s) based on the teachings contained herein.

1. A computer-based method of enhancing operation of a business, comprising:
(a) providing a personal assistance device (PAD) to a customer of said business, wherein said PAD wirelessly communicates with one or more servers;
(b) enabling said customer to display services and products offered by said business on said PAD; and
(c) enabling said customer to order from said business any of said services and products using said PAD.

2. The method of claim 1, wherein said business is a restaurant.

3. The method of claim 2, further comprising:
enabling said customer to store preference information relating to at least one of dietary needs, preferred seating arrangements, preferred loyalty rewards, preferred menu view, preferred waiter, past meals history, food ratings, and wine ratings.

4. The method of claim 3, further comprising:
providing an identification card to said customer after said customer registers; and
recalling said stored preference information after said customer is recognized using said identification card.

5. The method of claim 2, wherein step (b) comprises:
displaying on said PAD a menu of food and drink selections.

6. The method of claim 5, wherein said displaying step comprises:
enabling said customer to select from a plurality of menu views comprising at least one of:
a menu in a selected language;
a menu sorted by calories;
a menu of meals containing no ingredients specified by said customer;
a menu comprising nutritional information about each meal;
a menu listing wines recommended for each meal;
a menu listing included side dishes;
a menu displaying food preparation information; and
a menu listing meals appropriate for children.

7. The method of claim 5, wherein said displaying step comprises:
deleting from said menu selections of unavailable items.

8. The method of claim 5, wherein said displaying step comprises:
adjusting said menu according to time of day.

9. The method of claim 2, further comprising:
enabling said customer to view additional content on said PAD, including at least one of news headlines, sports scores, financial information, local shopping information, maps, driving directions, entertainment programming, and sports programming.

10. The method of claim 2, further comprising:
enabling said customer to purchase products and services using said PAD.

11. The method of claim 2, further comprising:
enabling said customer to make a future reservation using said PAD.

12. The method of claim 2, further comprising:
enabling said customer to page a waiter using said PAD.

13. The method of claim 2, further comprising:
enabling said customer to page a manager using said PAD.

14. The method of claim 2, further comprising:
enabling said customer to access restaurant promotional information using said PAD.

15. The method of claim 2, further comprising:
enabling said customer to respond to a survey using said PAD.

16. The method of claim 2, wherein said PAD includes a credit card reader, further comprising:
enabling said customer to pay the customer's bill by processing a credit card using said PAD.
